(19) United States
(12) Patent Application Publication
(10) Pub. No.: US 2014/0201084 A1
(43) Pub. Date: Jul. 17, 2014

(54) APPARATUS CONFIGURED TO FACILITATE SECURE FINANCIAL TRANSACTIONS

(71) Applicant: CALEDON COMPUTER SYSTEMS INC., Georgetown (CA)

(72) Inventors: Donald Roger DAGENAIS, Nassau (BS); Bradley HAZLEDINE, Freelton (CA); Margaret THIBODEAU, Shirley, AR (US); Marcus Donald Stephen DAGENAIS, Toronto (CA)

(73) Assignee: CALEDON COMPUTER SYSTEMS INC., Georgetown (CA)

(21) Appl. No.: 14/105,484

(22) Filed: Dec. 13, 2013

Related U.S. Application Data
(60) Provisional application No. 61/737,460, filed on Dec. 14, 2012.

(30) Foreign Application Priority Data
Dec. 14, 2012 (CA) 2799055

(51) Int. Cl. G06Q 20/20; G06Q 20/38

(52) U.S. Cl. CPC G06Q 20/20; G06Q 20/382
USPC 705/64

(57) ABSTRACT

An aspect provides an apparatus configured to facilitate secure financial transactions.

### REFERENCE TO CO-PENDING APPLICATIONS

The applicants claim priority benefit to U.S. Provisional application Ser. No. 61/737,460; filed on Dec. 14, 2012 and entitled APPARATUS CONFIGURED TO FACILITATE SECURE FINANCIAL TRANSACTIONS, and Canadian Patent application serial number 2,799,055, filed Dec. 14, 2012, and entitled APPARATUS CONFIGURED TO FACILITATE SECURE FINANCIAL TRANSACTIONS. The entire subject matter of both of these applications is incorporated by reference.

### TECHNICAL FIELD

Aspects generally relate to (and are not limited to) an apparatus configured to facilitate secure financial transactions.

### BACKGROUND

A financial transaction is an agreement, communication, or movement carried out between a buyer and a seller to exchange an asset for payment. It involves a change in the status of the finances of two or more businesses or individuals. The buyer and seller are separate entities or objects, often involving the exchange of items of value, such as information, goods, services, and money. It is still a transaction if you exchange the goods at one time, and the money at another. This is known as a two-part transaction: part one is giving the money, and part two is receiving the goods.

In ancient times, financial transactions were commonly conducted through a system of barter, in which goods and services were exchanged directly, without a financial medium. This had certain disadvantages, including the requirements that traders or their intermediaries meet face to face, and that transactions normally be completed in a single swap. With the introduction of precious metals such as gold and silver, indirect trades greatly separated in time and space became possible. As cities, states, and empires were established, coins and other compact forms of specie (money in the form of coins rather than notes) were minted or printed as fiat money with set values. This permitted the accumulation of assets that would not deteriorate over time as goods might and that had the relatively secure backing of a government which could adjust the value by producing more or less of the currency. As fixed currencies were gradually replaced by floating currencies during the 20th century, and as the recent development of computer networks made electronic money possible, financial transactions have rapidly increased in speed and complexity.

### SUMMARY

We, the inventors, have researched a problem associated with known apparatus that are configured to facilitate secure financial transactions. After much study, we believe we have arrived at an understanding of the problem and its solution, which are stated below.

Electronic commerce, commonly known as e-commerce, include buying and selling of product or service (commodity) using electronic systems connected by computer networks. Electronic commerce draws on such technologies as electronic funds transfer, supply-chain management, Internet marketing, online transaction processing, electronic data interchange (EDI), inventory management systems, and automated data collection systems. Electronic commerce may use the World Wide Web (the Internet) at least at one point in the transaction's life cycle, although it may encompass a wider range of technologies such as email, mobile devices, and telephones as well. Electronic commerce is considered to be a sales aspect of e-business. It also consists of the exchange of data to facilitate the financing and payment aspects of business transactions. E-commerce can be divided into: (A) e-tailing or virtual storefronts on Web sites with online catalogs, sometimes gathered into a virtual mall, (B) the gathering and use of demographic data through Web contacts and social media, (C) electronic Data Interchange (EDI), the business-to-business exchange of data, (D) email and fax and their use as media for reaching prospects and established customers (for example, with newsletters), (E) business-to-business buying and selling, and (F) the security of business transactions.

A consumer wishing to make a purchase can use an electronic-commerce apparatus (such as a web browser, point-of sale device) to select the desired merchandise, and then to offer payment for the merchandise.

Sometimes, paying for the merchandise presents problems. Payment can be made using a credit card, a debit card, or an electronic check, etc. Typically, when making payment with any of these methods, the consumer reveals the account number to the merchant so that the merchant can debit the account. The networks used to connect the servers of the electronic-commerce apparatus may not be secure. Some merchants have to securely store credit card numbers, etc., to a secured site, which may further complicate the operation of the merchant. In many cases, the merchant also stores the account number in a database. The database then becomes a target for attack, and if the database is not secure, can lead to compromise of the account number to an unscrupulous person. Consequently, many consumers are uncomfortable with revealing their account numbers to the electronic-commerce apparatus for fear of having their account number stolen and used illegally. The same problem exists to some degree at a point-of-sale (POS) terminal located (for example) at a cash register at the point of sale. The account number can be learned by the merchant and, if not adequately protected, compromised. The merchant may inadvertently accept the financial transaction as valid if a credit card number is not identified as being invalid (such as for the case when the financial transaction is executed in flight on an airplane). The account is identified as invalid if the account is known or suspected to have been compromised, perhaps by a report of a lost credit card. The merchant rarely checks the signature on receipts and checks against the signature on file for the account. This leaves the merchant open to fraud.

The merchant accepting electronic transactions has little assurance that the owner of the credit card (or other equivalent thereof) originated the transaction. If the consumer later denies making the transaction, it can be difficult for the merchant to prove otherwise.

What may be needed are improved methods and apparatus configured to facilitate secure electronic commerce.

In order to mitigate, at least in part, the above issues, in accordance with a general aspect of our work, we (the inventors) have developed and provided an apparatus configured to facilitate secure financial transactions using the technical features and/or servers as identified in the detailed description.

In accordance with other aspects of our work, we (the inventors) have developed and provided aspects of an apparatus as identified below in the summary, and/or as identified in the claims, and or as identified in the drawings, and/or as identified in the detailed description of the non-limiting embodiments. It will be appreciated that the apparatus may include any selected one of a point-of-sale server, a database server, a transaction-processing server, a settlement-and-reporting server, a blacklist server, a duplicate-check server, a database, a client portal, a token server, an enhanced data-processing server, an address-verification server, in any suitable permutation and/or combination thereof once these servers are suitably configured to interact to do just so.

In order to mitigate, at least in part, the above issues, in accordance with an aspect of our work, we (the inventors) have developed and provided an apparatus including a point-of-sale server. The point-of-sale server is configured to cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol. The point-of-sale server is also configured to decrypt the encrypted transaction record using the point-of-sale cryptographic protocol in such a way so as to extract a transaction content from the encrypted transaction record received from the point-of-sale device. The point-of-sale server is also configured to encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol. The point-of-sale server is also configured to output the re-encrypted transaction record in such a way so that the re-encrypted transaction record remains secure while waiting to be further processed.

In order to mitigate, at least in part, the above issues, in accordance with another aspect of our work, we (the inventors) have developed and provided an apparatus including a database server. The database server is configured to cooperatively communicate with a database and with a point-of-sale server in such a way so that the database server inputs a re-encrypted transaction record from the point-of-sale server, and outputs the re-encrypted transaction record to the database. The point-of-sale server is configured to: (A) cooperatively communicate with a point-of-sale device in such a way so as to input an encrypted transaction record from the point-of-sale device, the encrypted transaction record indicating a buyer agreeing to provide a payment in exchange for receiving a commodity (such as a product or a service, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed.

In order to mitigate, at least in part, the above issues, in accordance with yet another aspect of our work, we (the inventors) have developed and provided an apparatus including a database. The database is configured to cooperatively communicate with a database server in such a way so that the database server inputs a re-encrypted transaction record from a point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity (a product or a service), the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed.

In order to mitigate, at least in part, the above issues, in accordance with yet another aspect of our work, we (the inventors) have developed and provided an apparatus including a transaction-processing server. The transaction-processing server is configured to cooperatively communicate with a database server in such a way so as to input a re-encrypted transaction record from the database server, the database server being configured to cooperatively communicate with a database and with a point-of-sale server in such a way so that the database server inputs a re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed. The transaction-processing server is also configured to decrypt the re-encrypted transaction record by using the apparatus-cryptographic protocol in such a way so as to extract the transaction content from the re-encrypted transaction record. The transaction-processing server is also configured to encrypt the transaction content extracted from the re-encrypted transaction record using an authorization-provider cryptographic protocol so as to form an encrypted authorization request, the authorization-provider cryptographic protocol being associated with an authorization-provider server, and being different from the apparatus-cryptographic protocol. The transaction-processing server is also configured to cooperatively communicate with the authorization-provider server in such a way so as to: output the encrypted authorization request to the authorization-provider server, and input, from the authorization-provider server, an encrypted authorization report being formed by using the authorization-provider cryptographic protocol, the encrypted authorization report having an indication configured to indicate whether the transaction content is any one of authorized and non-authorized. The transaction-processing server is also configured to decrypt the encrypted authorization report in accordance with the authorization-provider cryptographic protocol in such a way so that authorization content is extracted from the encrypted authorization report. The transaction-processing server is also configured to encrypt the encrypted authorization report in accordance with the apparatus-cryptographic protocol in such a way so as to form any one of the encrypted authorization report and an encrypted un-authorization report. The transaction-processing server is also configured to cooperatively communicate with the database server in such a way so as to output any one of the encrypted authorization report and the encrypted un-authorization report to the database, any one of the encrypted authorization report and the encrypted un-authorization report remain secured while waiting to be further processed.

In order to mitigate, at least in part, the above issues, in accordance with yet another aspect of our work, we (the inventors) have developed and provided an apparatus including a settlement-and-reporting server. The settlement-and-reporting server is configured to cooperatively communicate with a database server in such a way so as to input an encrypted authorization report from the database server, the database server being configured to cooperatively communicate with a database and with a point-of-sale server in such a way so that the database server inputs a re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed. The settlement-and-reporting server is also configured to decrypt the encrypted authorization report in such a way so as to extract the transaction content from the encrypted authorization report. The settlement-and-reporting server is also configured to encrypt the transaction content extracted from the encrypted authorization report; so as to form an encrypted payment request; using an encryption technique that is different from the encryption technique associated with an acquirer server. The settlement-and-reporting server is also configured to cooperatively communicate with the acquirer server in such a way so as to: output the encrypted payment request having the transaction content extracted from the encrypted authorization report to the acquirer server, and input an encrypted acquirer report from the acquirer server having an indication configured to indicate whether the transaction content indicates are any one of a paid transactions and a not-paid transaction. The settlement-and-reporting server is also configured to decrypt the encrypted acquirer report using a decryption technique associated with the acquirer server. The settlement-and-reporting server is also configured to encrypt the encrypted acquirer report in such a way so as to form the encrypted acquirer report by using an encryption process being different from a process of encryption associated with the acquirer server. The settlement-and-reporting server is also configured to cooperatively communicate with the database server in such a way so as to output the encrypted acquirer report to the database in such a way that the encrypted acquirer report remains secured while waiting to be further processed.

In order to mitigate, at least in part, the above issues, in accordance with yet another aspect of our work, we (the inventors) have developed and provided an apparatus including an intermediate server. The intermediate server is configured to: input, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, (c) output, at least in part, the source-server encrypted record in such a way so that the source-server encrypted record remains secure while waiting to be further processed, (d) output, at least in part, the source-server encrypted record to the intermediate server. The intermediate server is also configured to decrypt, at least in part, the source-server encrypted record in accordance with the source-server cryptographic protocol in such a way so as to form the unencrypted record. The intermediate server is also configured to encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed. The intermediate server is also configured to decrypt, at least in part, the intermediate-server encrypted record in accordance with the intermediate-server cryptographic protocol in such a way so as to form the unencrypted record. The intermediate server is also configured to encrypt, at least in part, the unencrypted record in accordance with a sink-server cryptographic protocol being associated with a sink server in such a way so as to form a sink-server encrypted record, and the sink-server encrypted record remaining secure while waiting to be further processed. The intermediate server is also configured to output, at least in part, the sink-server encrypted record in such a way so that the sink-server encrypted record remains secure while waiting to be further processed. The intermediate server is also configured to output, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record.

In order to mitigate, at least in part, the above issues, in accordance with yet another aspect of our work, we (the inventors) have developed and provided an apparatus including a source server. The source server is configured to input, at least in part, an unencrypted record. The source server is also configured to encrypt, at least in part, the unencrypted record in accordance with a source-server cryptographic protocol being associated with the source server in such a way so as to form a source-server encrypted record. The source server is also configured to output, at least in part, the source-server encrypted record in such a way so that the source-server encrypted record remains secure while waiting to be further processed. The source server is also configured to output, at least in part, the source-server encrypted record to an intermediate server, the intermediate server being configured to: (A) input, at least in part, the source-server encrypted record being outputted, at least in part, from the source server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (E) encrypt, at least in part, the unencrypted record in accordance with a sink-server cryptographic protocol being associated with a sink server in such a way so as to form a sink-server encrypted record, and the sink-server encrypted record remaining secure while waiting to be further processed, (F) output, at least in part, the sink-server encrypted record in such a way so that the sink-server encrypted record remains secure while waiting to be further processed; and (G) output, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record.

In order to mitigate, at least in part, the above issues, in accordance with yet another aspect of our work, we (the inventors) have developed and provided an apparatus including a sink server. The sink server is configured to input, at least in part, a sink-server encrypted record being outputted from an intermediate server, the intermediate server being configured to: (A) input, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, and (c) output, at least in part, the source-server encrypted record in such a way so that the source-server encrypted record remains secure while waiting to be further processed, (d) output the source-server encrypted record to the intermediate server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (F) encrypt, at least in part, the unencrypted record in accordance with a sink-server cryptographic protocol being associated with the sink server in such a way so as to form the sink-server encrypted record, and the sink-server encrypted record remaining secure while waiting to be further processed, (G) output, at least in part, the sink-server encrypted record in such a way so that the sink-server encrypted record remains secure while waiting to be further processed; and (H) output, at least in part, the sink-server encrypted record to the sink server. The sink server is also configured to decrypt, at least in part, the sink-server encrypted record in accordance with the sink-server cryptographic protocol in such a way so as to form the unencrypted record. The sink server is also configured to process the unencrypted record.

In order to mitigate, at least in part, the above issues, in accordance with yet another aspect of our work, we (the inventors) have developed and provided an apparatus including a token server configured to: securely interface with a secured vault; store an identifier associated with a credit card in the secured vault; receive, from a merchant, a token representing the identifier associated with the credit card; receive, from the merchant, a financial transaction associated with the token; retrieve the credit card from the secured vault, the credit card number being associated with the token received from the merchant; and execute the financial transaction in response to receiving the financial transaction and retrieving the credit card from the secured vault.

Other aspects and features of the non-limiting embodiments may now become apparent to those skilled in the art upon review of the following detailed description of the non-limiting embodiments with the accompanying drawings.

In accordance with other aspects of our work, we (the inventors) have developed and provided other aspects as provided in the claims and/or the detailed description of the non-limiting embodiments.

### DETAILED DESCRIPTION OF DRAWINGS

The non-limiting embodiments may be more fully appreciated by reference to the following detailed description of the non-limiting embodiments when taken in conjunction with the accompanying drawings, in which:

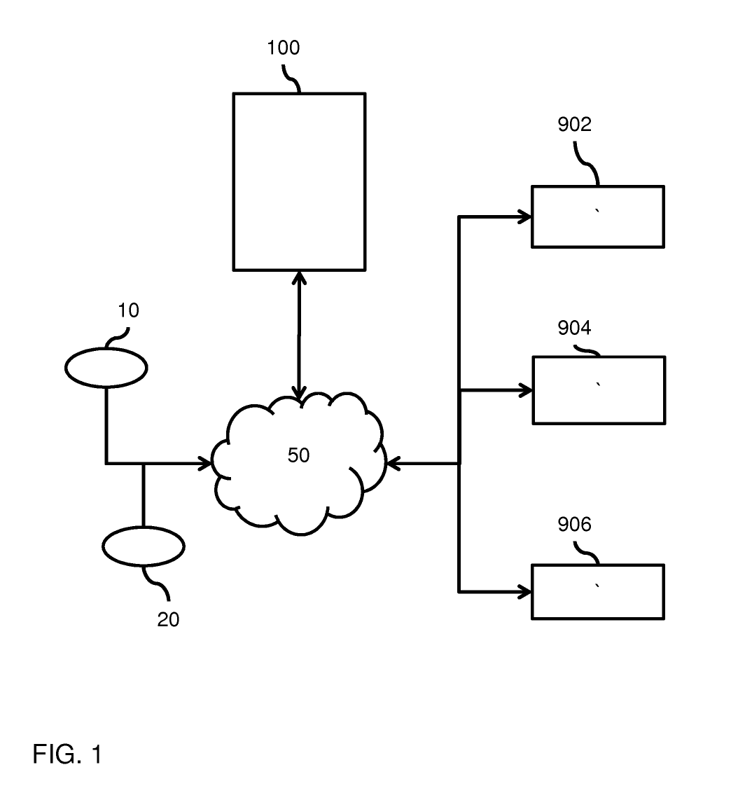

FIG. 1 depicts a schematic representation of an example of an apparatus;

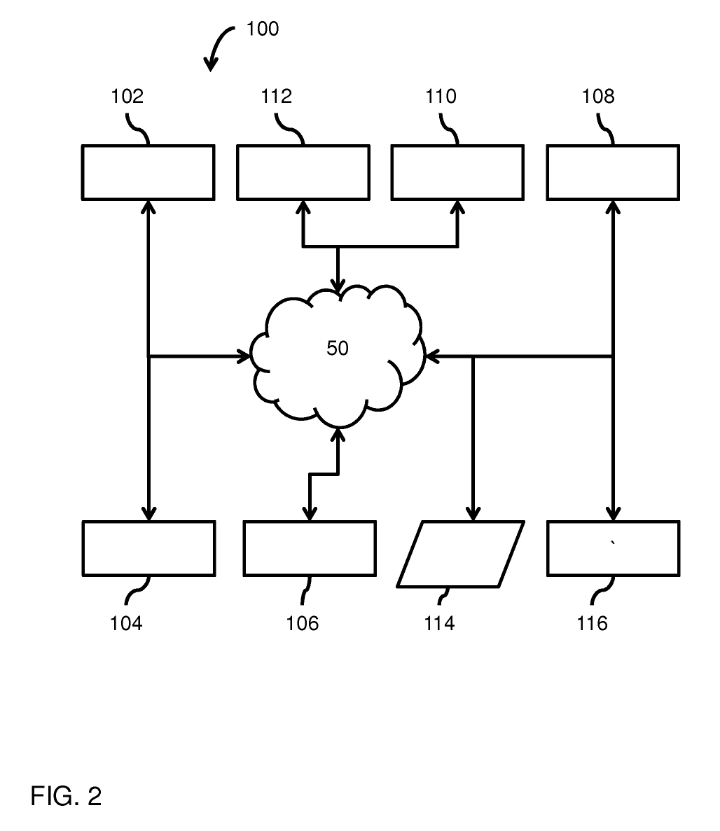

FIG. 2 depicts a schematic representation of an example of the servers of the apparatus of FIG. 1;

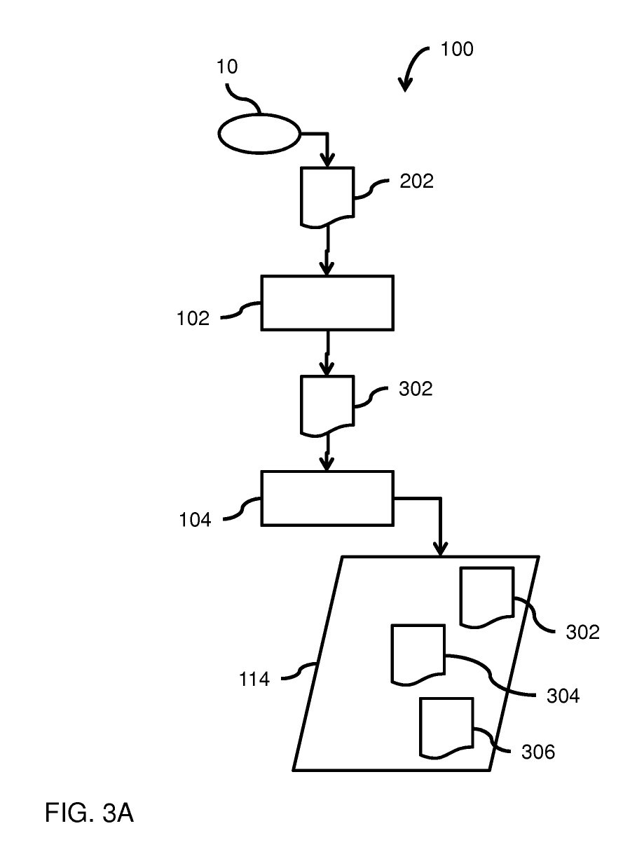

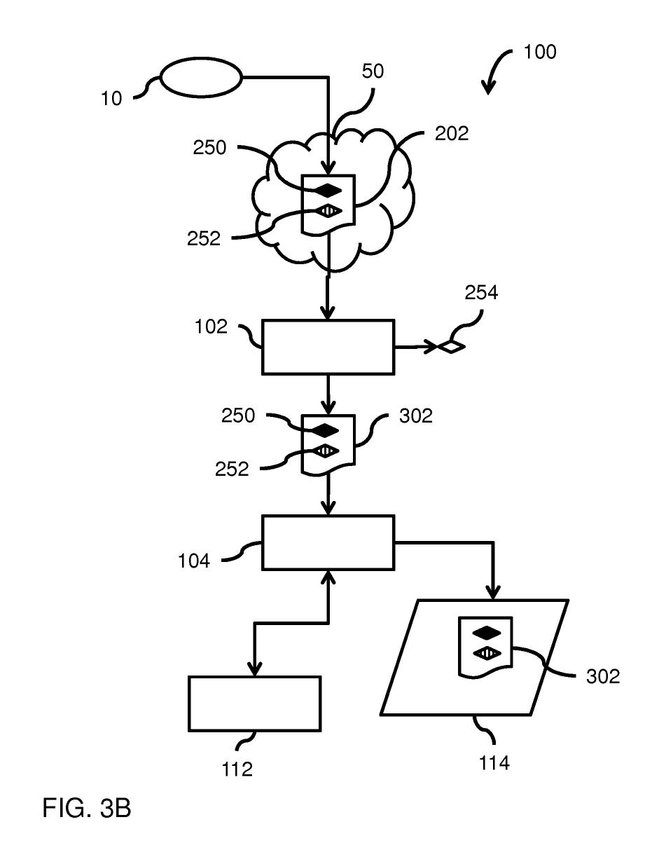

FIGS. 3A and 3B depict schematic representations of example of a point-of-sale server of the apparatus of FIG. 2;

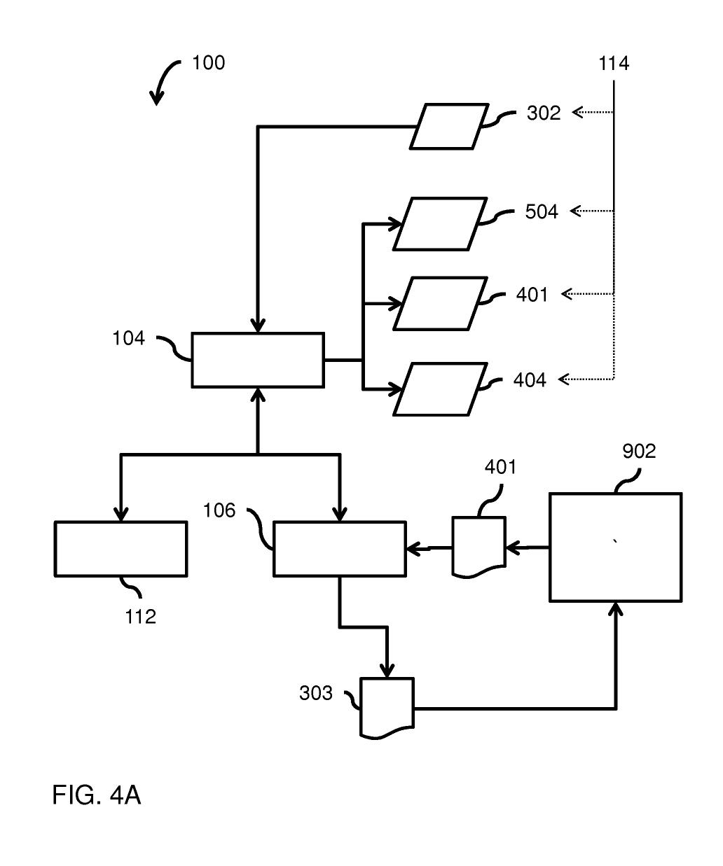

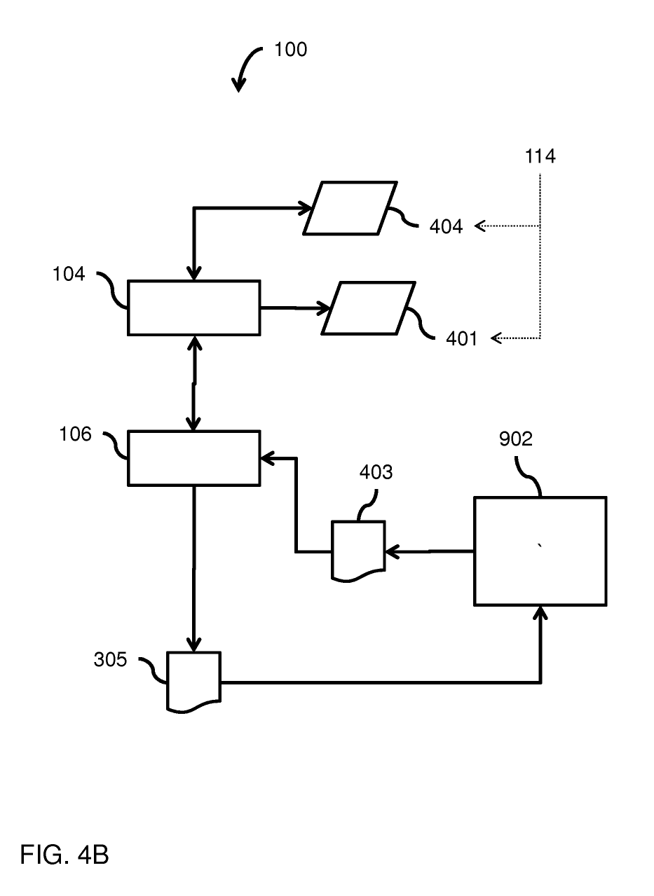

FIGS. 4A and 4B depict schematic representations of examples of a transaction-processing server of the apparatus of FIG. 2;

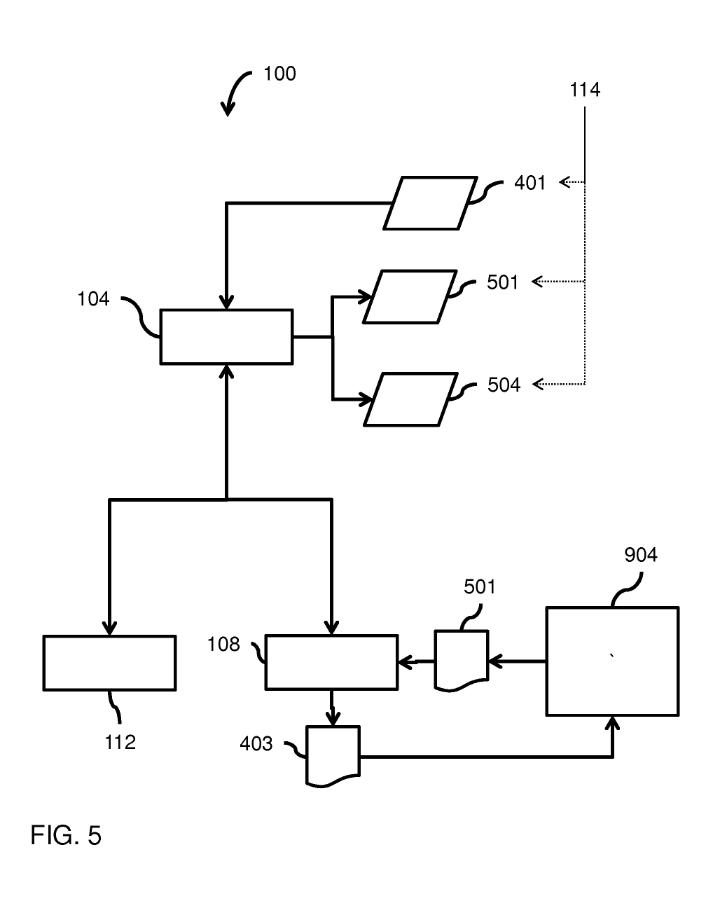

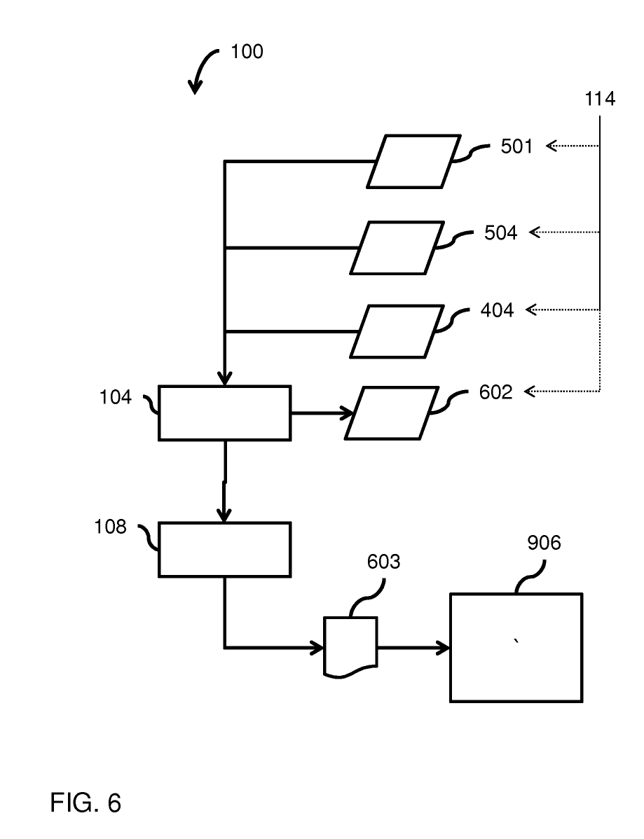

FIGS. 5 and 6 depict schematic representations of examples of a settlement-and-reporting server of the apparatus of FIG. 2;

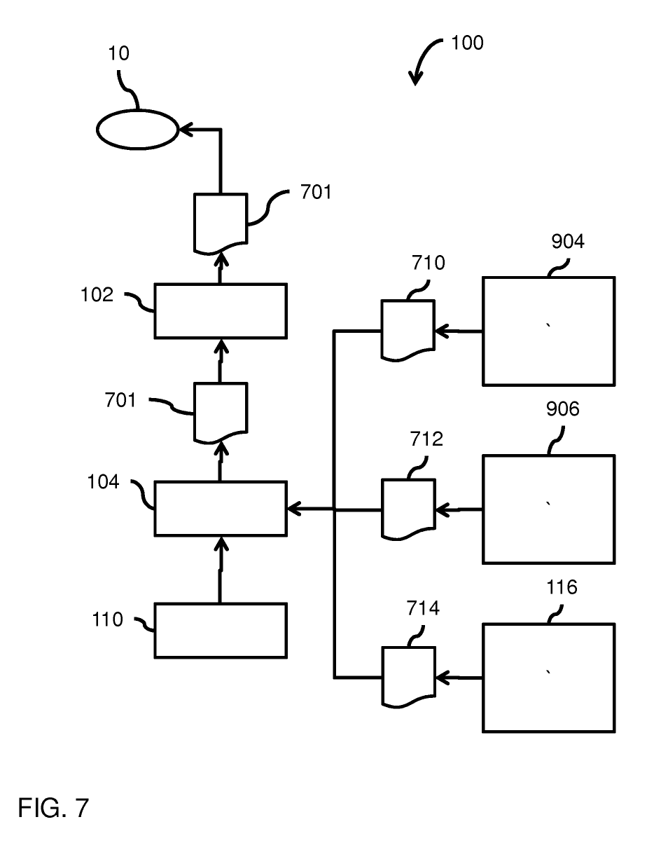

FIG. 7 depicts a schematic representation of an example of a blacklist server of the apparatus of FIG. 2;

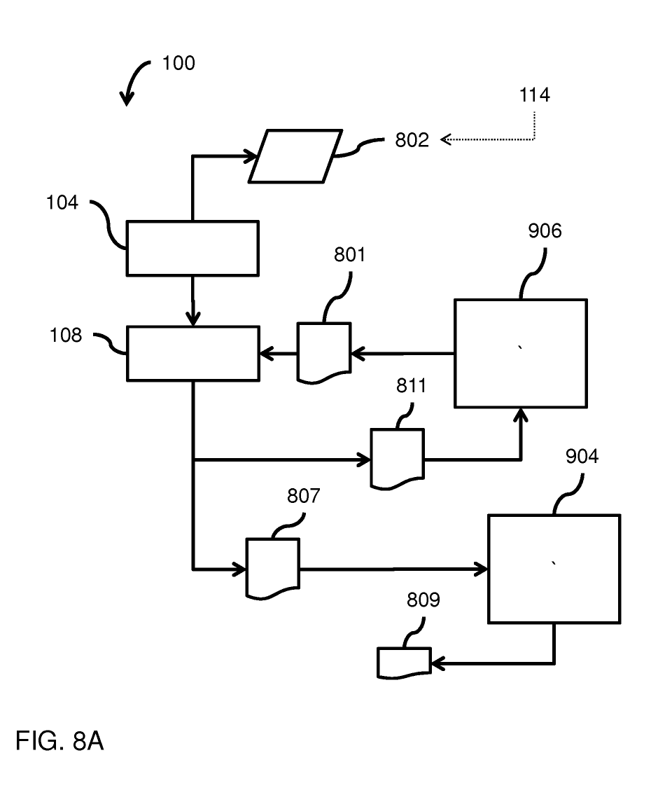

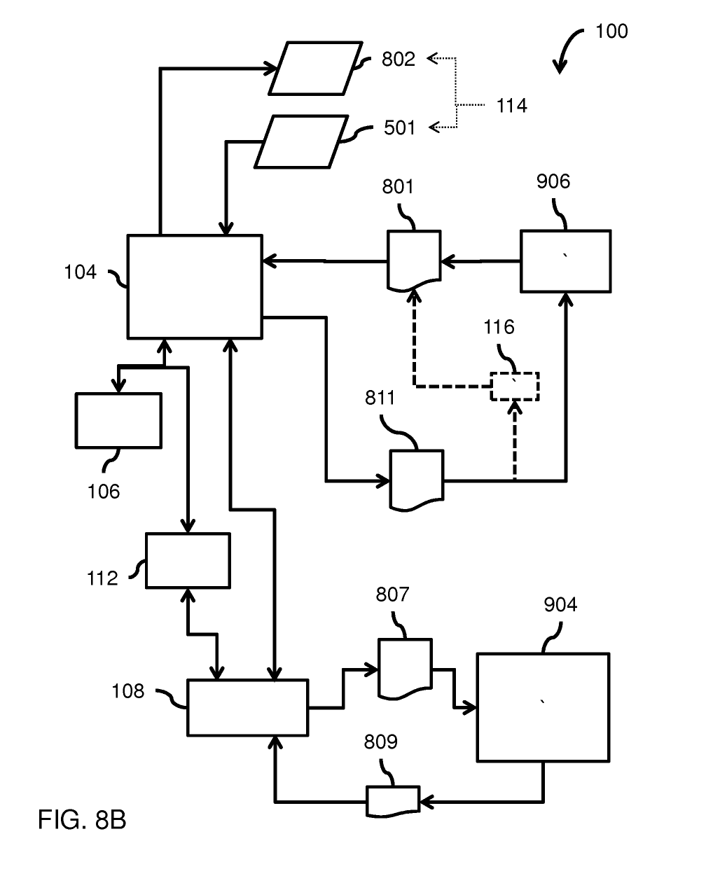

FIGS. 8A and 8B depict schematic representations of examples of a settlement-and-reporting server of the apparatus of FIG. 2 in accordance with variations;

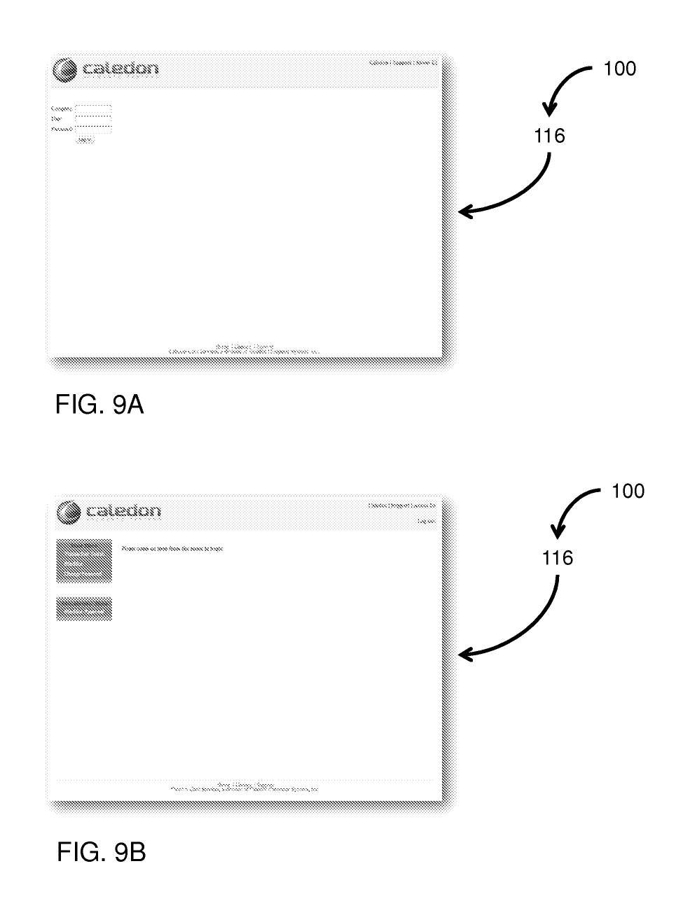

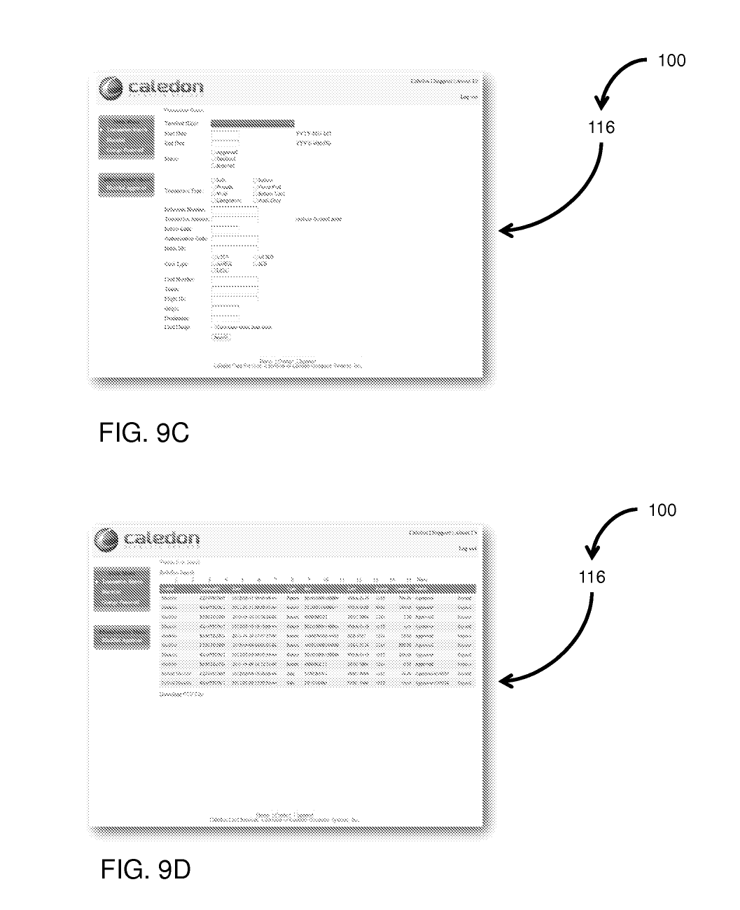

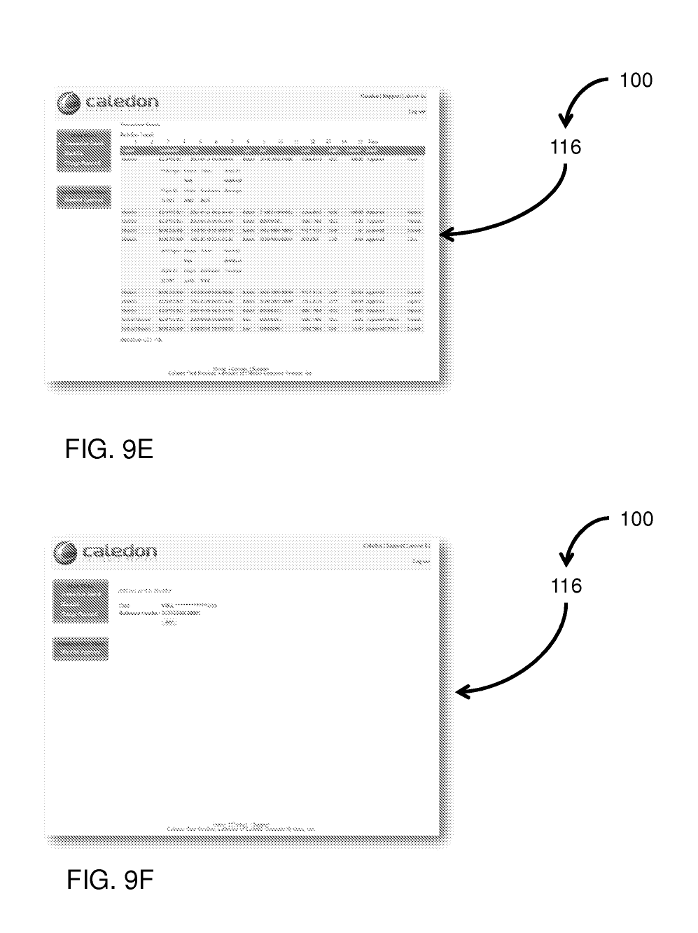

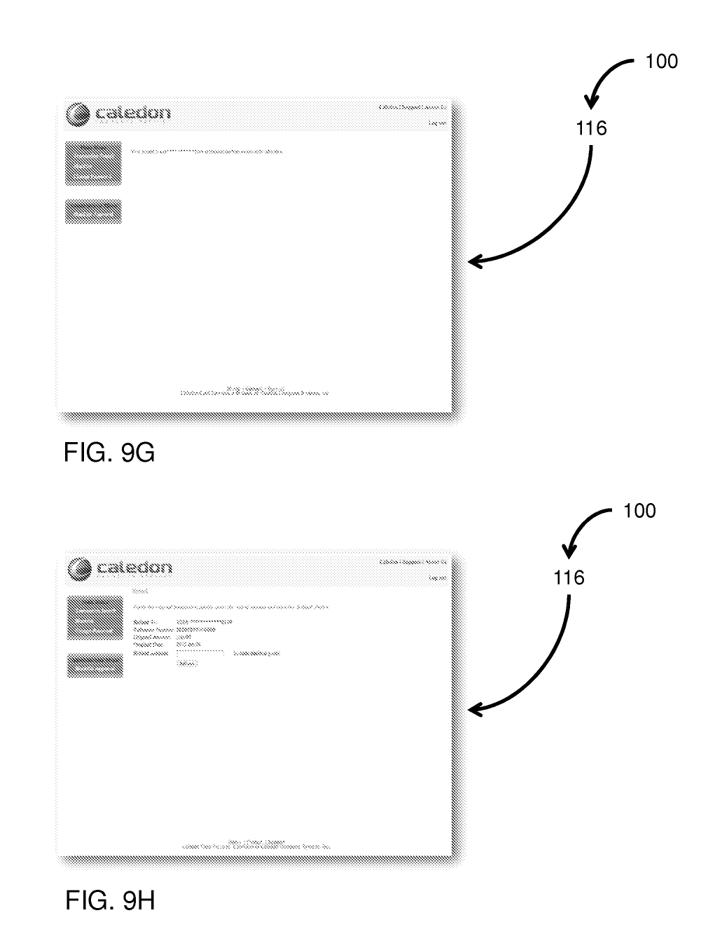

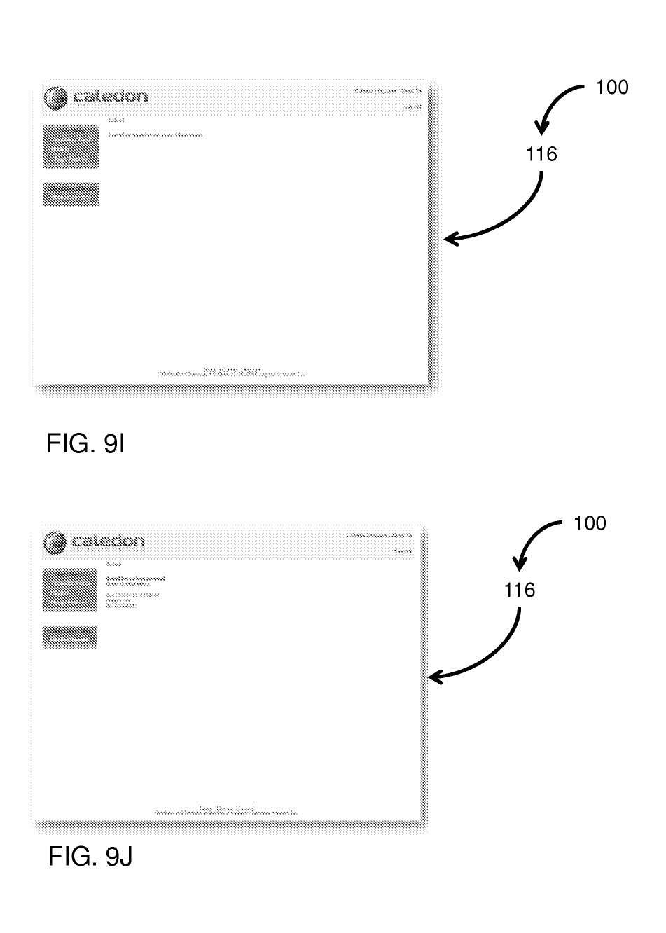

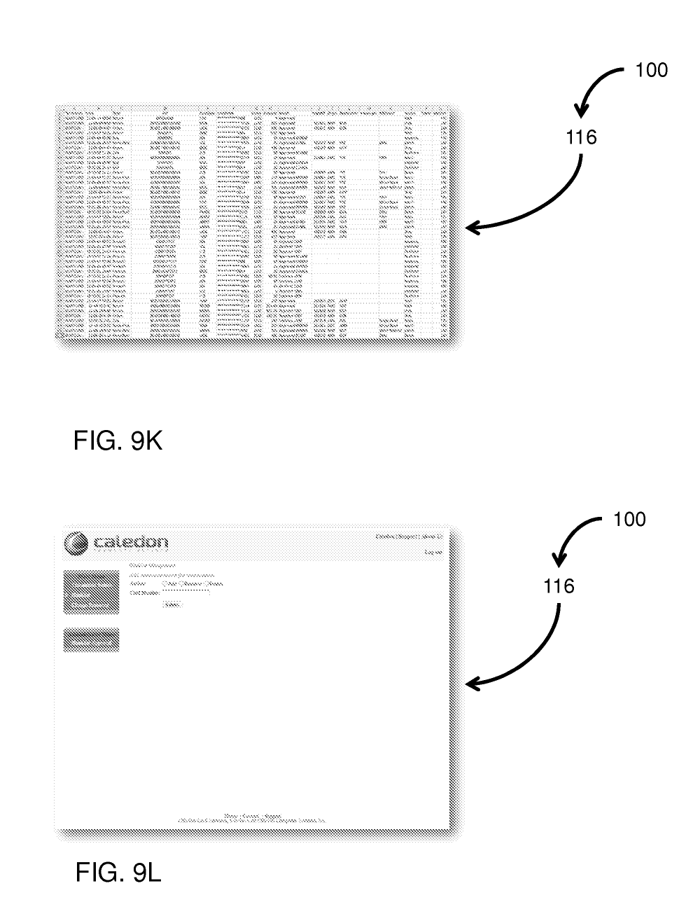

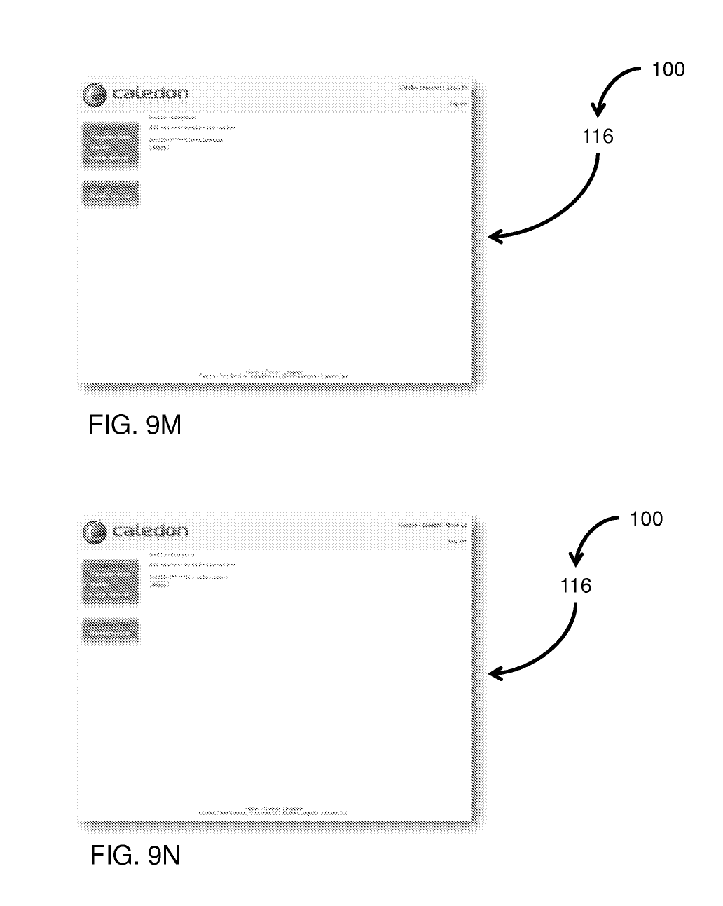

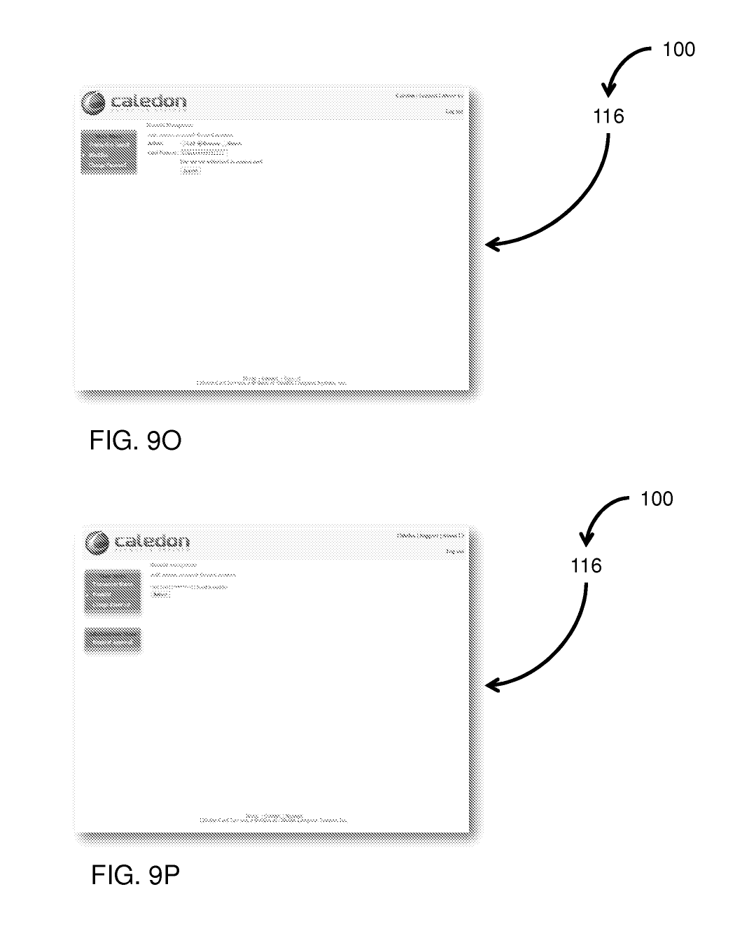

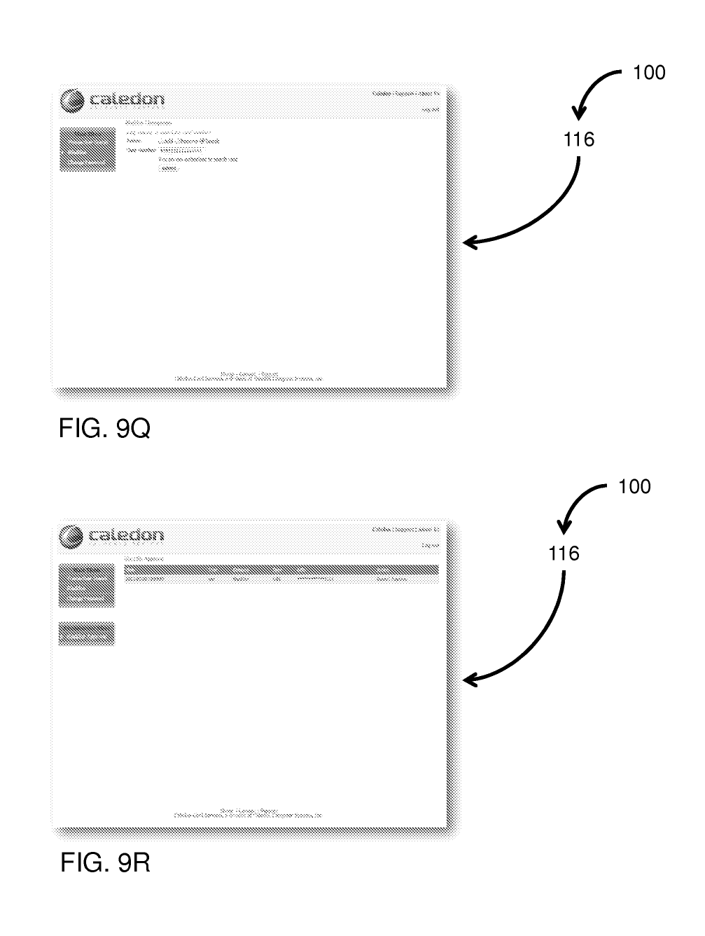

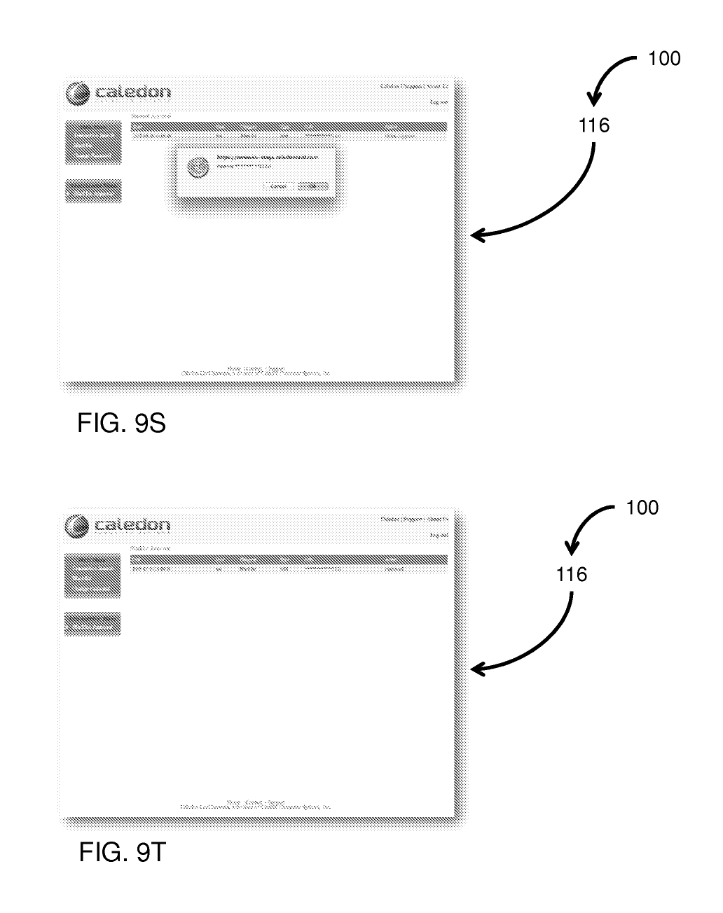

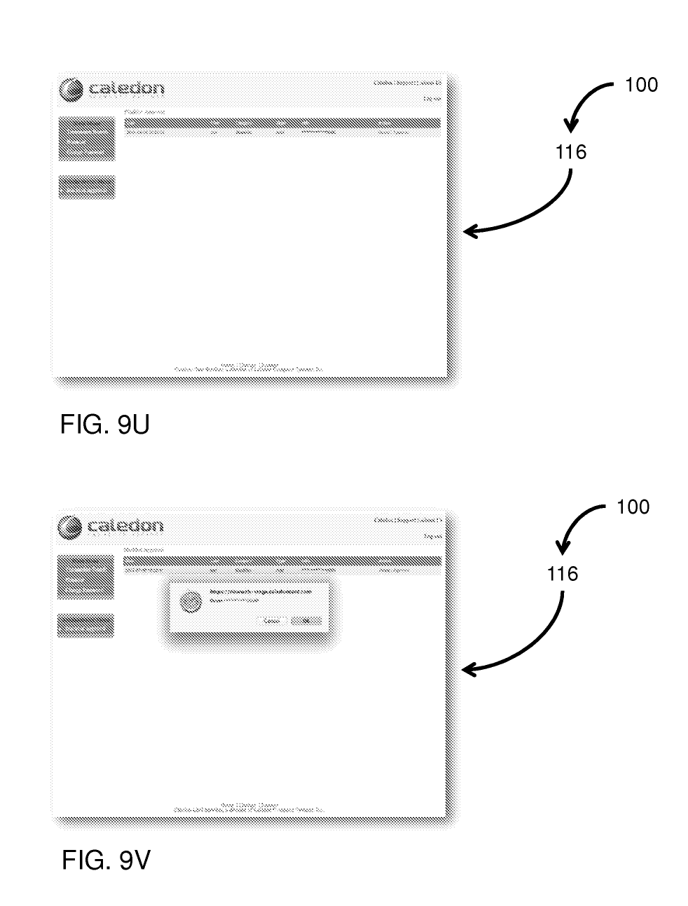

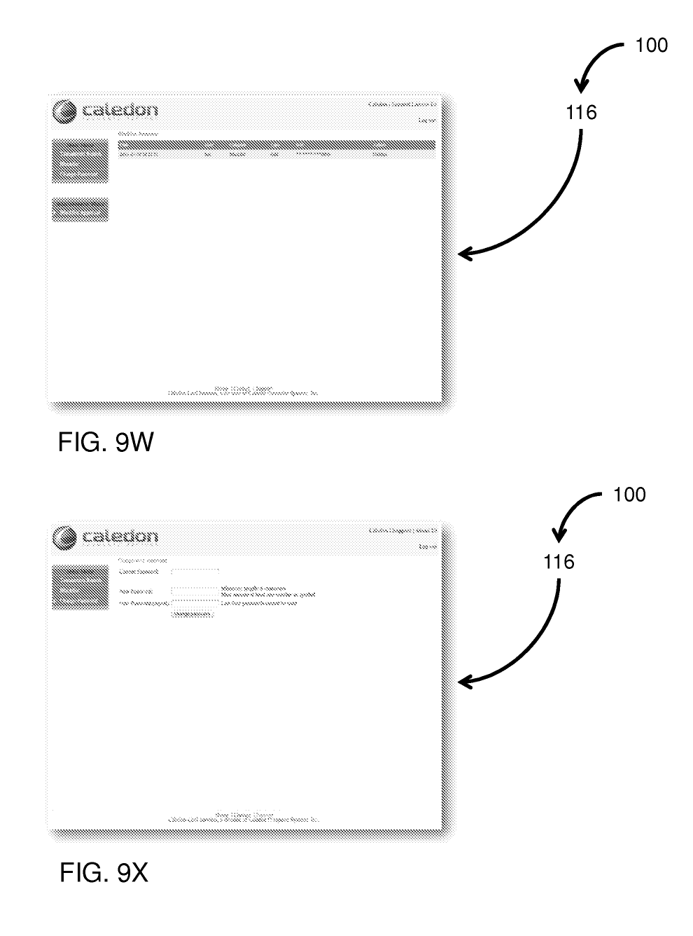

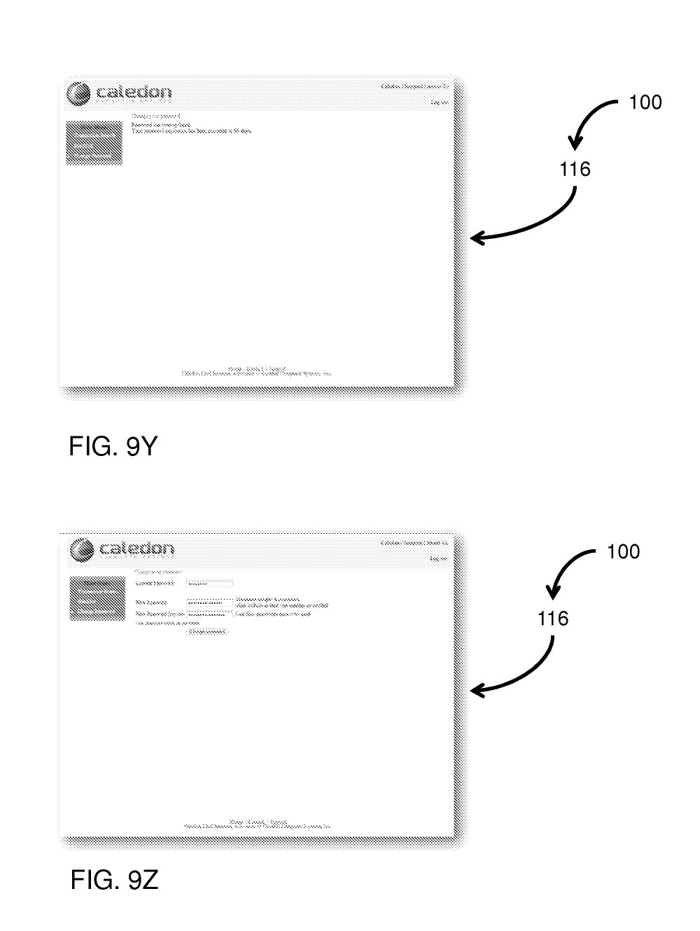

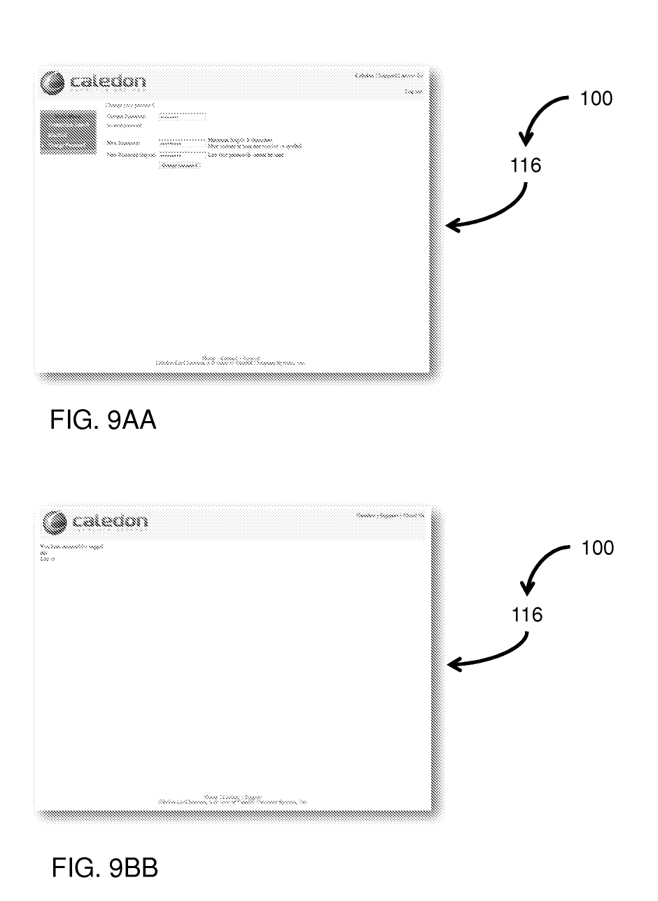

FIGS. 9A to 9BB depict examples of user-screen displays of a client portal of the apparatus of FIG. 2;

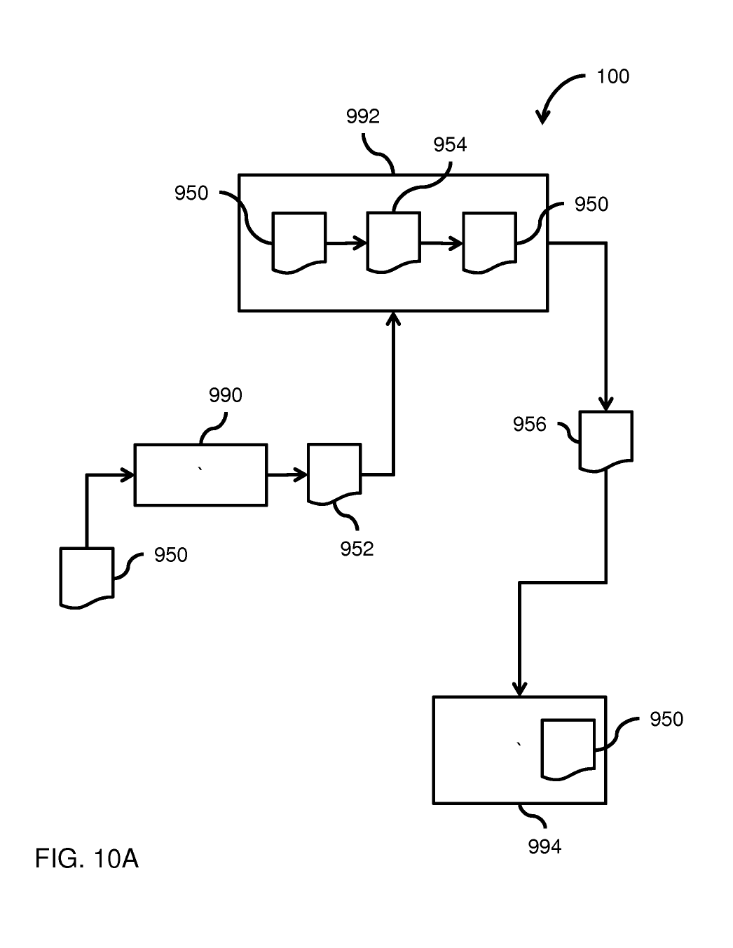

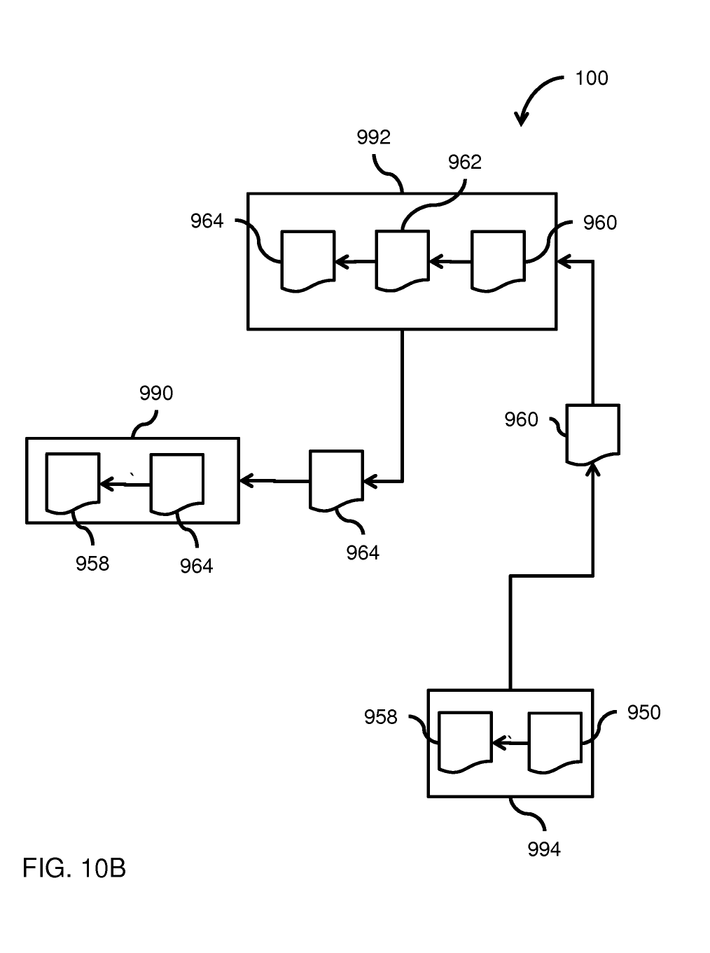

FIGS. 10A and 10B depict schematic representations of other embodiments of the apparatus of FIG. 1; and

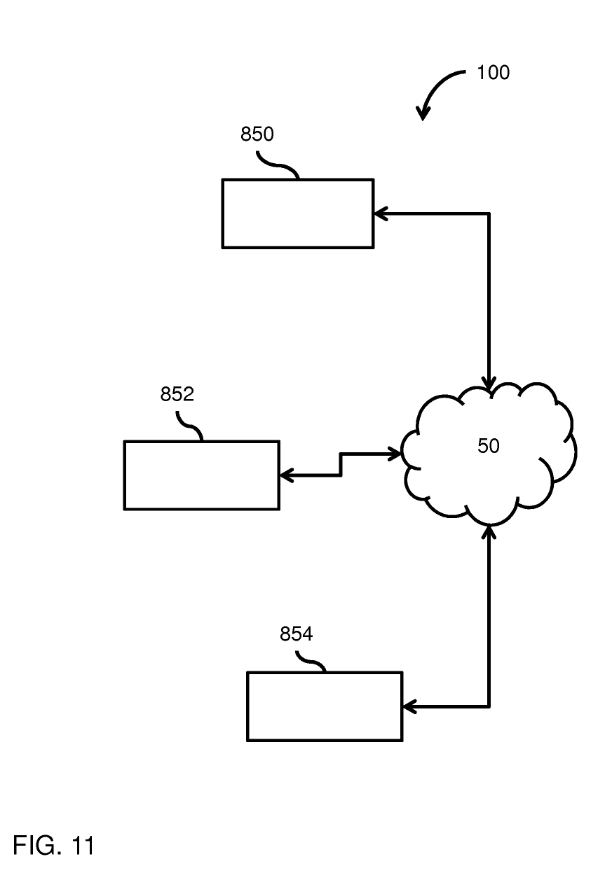

FIG. 11 depicts schematic representations of examples of a token server, an enhanced data-processing server, and an address verification server of the apparatus of FIG. 1.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### LISTING OF REFERENCE NUMERALS USED IN THE DRAWINGS

10 point-of-sale device
20 second point-of-sale device
50 network
100 apparatus
102 point-of-sale server
104 database server
106 transaction-processing server
108 settlement-and-reporting server
110 blacklist server
112 duplicate-check server
114 database
116 client portal
202 encrypted transaction record
250 encrypted component
252 unencrypted component
254 confidential content
302 re-encrypted transaction record
303 encrypted authorization request
304 re-encrypted transaction record
305 authorization request
306 re-encrypted transaction record
401 encrypted authorization report
403 encrypted payment request
404 encrypted un-authorization report
501 encrypted acquirer report
504 encrypted-duplicate report
602 client-report database
603 encrypted client report
701 blacklist report
702 encrypted list
710 acquirer-blacklist report
712 client-blacklist report
714 portal blacklist report
801 encrypted refund-request report
802 encrypted refund record
807 encrypted refund request
809 encrypted refund response
811 encrypted refund report
850 token server
852 enhanced data-processing server
854 address-verification server
902 authorization-provider server
904 acquirer server
906 client server
950 unencrypted record
952 source-server encrypted record
954 intermediate-server encrypted record
956 sink-server encrypted record
958 unencrypted processed record
960 sink-server encrypted processed record
962 intermediate-server encrypted processed record
964 source-server encrypted processed record
990 source server
992 intermediate server
994 sink server

### DETAILED DESCRIPTION OF THE NON-LIMITING EMBODIMENT(S)

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise.

Cryptographic Protocol

A cryptographic protocol (security protocol or encryption protocol) is a protocol that performs a security-related function and applies cryptographic methods. The cryptographic protocol provides encryption algorithms to computer records or files. The cryptographic protocol may include details about data structures and representations, at which point the cryptographic protocol may be used to implement multiple, interoperable versions of a computer program and/or computer records. Cryptographic protocols are widely used for secure application-level data transport. A cryptographic protocol may incorporate at least some of the following aspects: (a) key agreement or establishment, (b) entity authentication, (c) symmetric encryption, and message-authentication material construction, (d) secured application-level data transport, (e) non-repudiation methods. For example, Transport Layer Security (TLS) is a cryptographic protocol that is used to secure web (HTTP) connections. It has an entity authentication mechanism, based on the X.509 system; a key setup phase, where a symmetric encryption key is formed by employing public-key cryptography; and an application-level data transport function. These three aspects have important interconnections. Standard TLS does not have non-repudiation support. There are other types of cryptographic protocols as well, and even the term itself has various readings; Cryptographic application protocols often use one or more underlying key agreement methods, which are also sometimes referred to as “cryptographic protocols.” In cryptography, encryption is the process of encoding messages (or information) in such a way that eavesdroppers or hackers cannot read it, but that authorized parties can. In an encryption scheme, the message or information (referred to as plaintext) is encrypted using an encryption algorithm, turning it into an unreadable cipher text. This is usually done with the use of an encryption key, which specifies how the message is to be encoded. Any adversary that can see the cipher text should not be able to determine anything about the original message. An authorized party, however, is able to decode the cipher text using a decryption algorithm that usually requires a secret decryption key that adversaries do not have access thereto. For technical reasons, an encryption scheme usually needs a key-generation algorithm, to randomly produce keys.

Servers

A server may be a physical computer (a computer hardware system) dedicated to run one or more services (as a host), to serve the needs of the users of other computers on a network. A server may also be a virtual machine (VM). The virtual machine is a simulation of a computer system (abstract or real) that is usually different from the target computer system (where it is being simulated on). Virtual machines may be based on the specifications of a hypothetical computer or emulate the architecture and functioning of a real-world computer. The virtual machine is a software implementation of the physical computer system that executes programs like a physical machine. Virtual machines are separated into two major categories, based on their use and degree of correspondence to any real machine. A system virtual machine provides a complete system platform, which supports the execution of a complete operating system (OS). These usually emulate an existing architecture, and are built with either the purpose of providing a platform to run programs where the real hardware is not available for use (for example, executing software on otherwise obsolete platforms), or of having multiple instances of virtual machines lead to more efficient use of computing resources, both in terms of energy consumption and cost effectiveness (known as hardware virtualization, the key to a cloud computing environment), or both. In contrast, a process virtual machine (also, language virtual machine) is designed to run a single program, which means that it supports a single process. Such virtual machines are usually closely suited to one or more programming languages and built with the purpose of providing program portability and flexibility (amongst other things). An essential characteristic of a virtual machine is that the software running inside is limited to the resources and abstractions provided by the virtual machine—it cannot break out of its virtual environment. Depending on the computing service that it offers it could be a database server, file server, mail server, print server, web server, gaming server, or some other kind of server. In the context of client-server architecture, a server is a computer program running to serve the requests of other programs, the clients. Thus, the server performs some computational task on behalf of clients. The clients either run on the same computer or connect through the network. In the context of Internet Protocol (IP) networking, a server is a program that operates as a socket listener. Servers often provide essential services across a network, either to private users inside a large organization or to public users via the Internet.

According to one option, the servers include computer-executable instructions configured to operate the servers in accordance with the description provided above. The servers may use computer software, or just software, which is a collection of computer programs (server-executable instructions) and related data that provide the instructions for instructing the servers what to do and how to do it. In other words, software is a conceptual entity that is a set of computer programs, procedures, and associated documentation concerned with the operation of a controller assembly, also called a data-processing system. Software refers to one or more computer programs and data held in a storage assembly (a memory module) of the controller assembly for some purposes. In other words, software is a set of programs, procedures, algorithms and its documentation. Program software performs the function of the program it implements, either by directly providing instructions to computer hardware or by serving as input to another piece of software. In computing, an executable file (executable instructions) causes the servers to perform indicated tasks according to encoded instructions, as opposed to a data file that must be parsed by a program to be meaningful. These instructions are machine-code instructions for a physical central processing unit. However, in a more general sense, a file containing instructions (such as byte-code) for a software interpreter may also be considered executable; even a scripting language source file may therefore be considered executable in this sense. While an executable file can be hand-coded in machine language, it is far more usual to develop software as source code in a high-level language understood by humans, or in some cases, an assembly language more complex for humans but more closely associated with machine code instructions. The high-level language is compiled into either an executable machine code file or a non-executable machine-code object file; the equivalent process on assembly language source code is called assembly. Several object files are linked to create the executable. The same source code can be compiled to run under different operating systems, usually with minor operating-system-dependent features inserted in the source code to modify compilation according to the target. Conversion of existing source code for a different platform is called porting. Assembly-language source code and executable programs are not transportable in this way. An executable comprises machine code for a particular processor or family of processors. Machine-code instructions for different processors are completely different and executables may be incompatible. Some dependence on the particular hardware, such as a particular graphics card may be coded into the executable. It is usual as far as possible to remove such dependencies from executable programs designed to run on a variety of different hardware, instead installing hardware-dependent device drivers on the servers, which the program interacts with in a standardized way. Some operating systems designate executable files by filename extension (such as, *.exe) or noted alongside the file in its metadata (such as by marking an execute permission in Unix-like operating systems). Most also check that the file has a valid executable file format to safeguard against random bit sequences inadvertently being run as instructions. Modern operating systems retain control over the resources of the servers, requiring that individual programs make system calls to access privileged resources. Since each operating system features its own system call architecture, executable files are generally tied to specific operating systems, or families of operating systems. There are many tools available that make executable files made for one operating system work on another one by implementing a similar or compatible application binary interface. When the binary interface of the hardware the executable was compiled for differs from the binary interface on which the executable is run, the program that does this translation is called an emulator. Different files that can execute but do not necessarily conform to a specific hardware binary interface, or instruction set, can be represented either in byte-code for Just-in-time compilation, or in source code for use in a scripting language.

According to another option, the servers may include application-specific integrated circuits configured to operate the servers in accordance with the description provided above. According to another option, the servers may include a combination of the application-specific integrated circuits and the software. It may be appreciated that an alternative to using software (controller-executable instructions) in the server is to use an application-specific integrated circuit (ASIC), which is an integrated circuit (IC) customized for a particular use, rather than intended for general-purpose use. For example, a chip designed solely to run a cell phone is an ASIC. Some ASICs include entire 32-bit processors, memory blocks including ROM, RAM, EEPROM, Flash and other large building blocks. Such an ASIC is often termed a SoC (system-on-chip). Designers of digital ASICs use a hardware description language (HDL) to describe the functionality of ASICs. Field-programmable gate arrays (FPGA) are used for building a breadboard or prototype from standard parts; programmable logic blocks and programmable interconnects allow the same FPGA to be used in many different applications. For smaller designs and/or lower production volumes, FPGAs may be more cost effective than an ASIC design. A field-programmable gate array (FPGA) is an integrated circuit designed to be configured by the customer or designer after manufacturing—hence field-programmable. The FPGA configuration is generally specified using a hardware description language (HDL), similar to that used for an application-specific integrated circuit (ASIC) (circuit diagrams were previously used to specify the configuration, as they were for ASICs, but this is increasingly rare). FPGAs can be used to implement any logical function that an ASIC could perform. The ability to update the functionality after shipping, partial re-configuration of the portion of the design and the low non-recurring engineering costs relative to an ASIC design offer advantages for many applications. FPGAs contain programmable logic components called logic blocks, and a hierarchy of reconfigurable interconnects that allow the blocks to be wired together—somewhat like many (changeable) logic gates that can be inter-wired in (many) different configurations. Logic blocks can be configured to perform complex combinational functions, or merely simple logic gates like AND and XOR. In most FPGAs, the logic blocks may include memory elements, which may be simple flip-flops, or more complete blocks of memory. In addition to digital functions, some FPGAs have analog features. The most common analog feature is programmable slew rate and drive strength on each output pin, allowing the engineer to set slow rates on lightly loaded pins that would otherwise ring unacceptably, and to set stronger, faster rates on heavily loaded pins on high-speed channels that would otherwise run too slow. Another relatively common analog feature is differential comparators on input pins designed to be connected to differential signaling channels. A few “mixed signal FPGAs” have integrated peripheral Analog-to-Digital Converters (ADCs) and Digital-to-Analog Converters (DACs) with analog signal conditioning blocks allowing them to operate as a system-on-a-chip. Such devices blur the line between an FPGA, which carries digital ones and zeros on its internal programmable interconnect fabric, and field-programmable analog array (FPAA), which carries analog values on its internal programmable interconnect fabric.

Computer Programming Language

A computer programming language is an artificial language designed to communicate instructions to a machine, particularly (or such as) a computer system. Programming languages can be used to create programs that control the behavior of a machine and/or to express algorithms precisely. The earliest programming languages predate the computer system, and were used to direct the behavior of machines such as Jacquard looms and player pianos. Thousands of different programming languages have been created, mainly in the computer field, with many being created every year. Most programming languages describe computation in an imperative style, i.e., as a sequence of commands, although some languages, such as those that support functional programming or logic programming, use alternative forms of description. The description of a programming language is usually split into the two components of syntax (form) and semantics (meaning). Some languages are defined by a specification document (for example, the C programming language is specified by an ISO Standard), while other languages, such as PERL, have a dominant implementation that is used as a reference. PERL may be used, but other computer programming languages may be employed or used (if so desired).

PERL

PERL is a high-level, general-purpose, interpreted, dynamic programming language. Though PERL is not officially an acronym, there are various acronyms in use, such as: Practical Extraction and Reporting Language. PERL was developed as a general-purpose UNIX scripting language to make report processing easier. PERL borrows features from other programming languages including C, shell scripting (sh), etc. The PERL language provides text-processing facilities without the arbitrary data length limits of many contemporary UNIX tools, facilitating easier manipulation of text files. PERL gained use as a CGI (Common Gateway Interface) scripting language, in part due to its parsing abilities. In addition to CGI, PERL is used for graphics programming, system administration, network programming, finance, bio-informatics, and other applications. PERL is nicknamed “the Swiss Army chainsaw of scripting languages” because of its flexibility and power. PERL is also referred to as the “duct tape that holds the Internet together.”

Executable Code (Instructions)

In computing, an executable code (file) causes a computer “to perform indicated tasks according to encoded instructions,” as opposed to a data file that must be parsed by a program to be meaningful. Executable code (instructions) is formed based on instructions made from a computer programming language. These instructions are traditionally machine code instructions for a physical CPU. However, in a more general sense, a file containing instructions (such as byte-code) for a software interpreter may also be considered executable; even a scripting language source file may therefore be considered executable in this sense. The exact interpretation depends upon the use; while the term often refers only to machine code files, in the context of protection against computer virus that may corrupt files, which cause potentially hazardous instruction execution, including scripts, are conveniently lumped together. While an executable file can be hand-coded in machine language, it is far more usual to develop software as source code in a high-level language easily understood by humans or in some cases an assembly language more complex for humans but more closely associated with machine code instructions. The high-level language is compiled into either an executable machine code file or a non-executable machine-code object file of some sort; the equivalent process on assembly language source code is called assembly. Several object files are linked to create the executable. The same source code can be compiled to run under different operating systems, usually with minor operating-system-dependent features inserted in the source code to modify compilation according to the target. Conversion of existing source code for a different platform is called porting. Assembly-language source code, and executable programs, is not transportable in this way. An executable comprises machine code for a particular processor or family of processors. Machine-code instructions for different processors are completely different and executables may be incompatible. Some dependence on the particular hardware, such as a particular graphics card may be coded into the executable. It is usual to remove such dependencies from executable programs designed to run on a variety of different hardware, instead installing hardware-dependent device drivers on the computer, which the program interacts with in a standardized way.

The Internet

The Internet is a global system of interconnected computer networks that use the standard Internet protocol suite (often called TCP/IP, although not all applications use TCP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents used in the World Wide Web (WWW) and the infrastructure to support email. Most traditional communications media including telephone, music, film, and television are being reshaped or redefined by the Internet, giving birth to new services such as Voice over Internet Protocol (VoIP) and Internet Protocol Television (IPTV). The internet is an example of a network.

Network

A computer network, or simply a network, is a collection of computers and other hardware interconnected by communication channels that allow sharing of resources and information. Where at least one process in one device is able to send/receive data to/from at least one process residing in a remote device, then the two devices are said to be in a network. A network is a group of devices connected to each other. Networks may be classified into a wide variety of characteristics, such as the medium used to transport the data, a communications protocol used, scale, topology, benefit, and organizational scope. Communications protocols define the rules and data formats for exchanging information in a computer network, and provide the basis for network programming. A known communications protocol include an Ethernet standard, a hardware, and link layer standard that is ubiquitous in local-area networks, and the Internet protocol suite, which defines a set of protocols for internet-working, i.e. for data communication between multiple networks, as well as host-to-host data transfer, and application-specific data transmission formats. Computer networking is sometimes considered a sub-discipline of electrical engineering, telecommunications, computer science, information technology, or computer engineering, since it relies upon the application of these disciplines.

Client-Server Architecture

A client/server model is a computing model that acts as a distributed application that partition tasks or workloads between the providers of a resource or service, called servers, and service requesters, called clients. Often clients and servers communicate over a computer network on separate hardware, but both client and server may reside in the same system. A server machine is a host that is running one or more server programs, which share their resources with clients. A client does not share any of its resources, but requests a server's content or service function. Clients, therefore, initiate communication sessions with servers, which await incoming requests. The client/server characteristic describes the relationship of cooperating programs in an application. The server component provides a function or service to one or many clients, which initiate requests for such services. A notable example of this is the way OpenGL treats the video card of a computer as a server, with the actual application making rendering requests to it. This model is further solidified with the OpenGL Shading Language, with the user writing small programs that live in video memory, and are requested from the main program through the graphics driver. Functions such as email exchange, web access, and database access are built on the client/server model. Users accessing banking services from their computer use a web browser client to send a request to a web server at a bank. That web server runs a program which may in turn, forward the request to its own database client program, which sends a request to the bank's database server (which runs on another computer) to retrieve the account information. The balance and transaction records are returned to the bank database client, which in turn serves it back to the user's web browser client, displaying the results to the user. The client—server model has become one of the central aspects of network computing. Many business applications being written today use the client—server model, as do the Internet's main application protocols, such as HTTP, SMTP, Telnet, and DNS. The interaction between client and server is often described using sequence diagrams. The Unified Modeling Language has support for sequence diagrams. Specific types of clients include web browsers, email clients, and online chat clients. Specific types of servers include web servers, FTP (file transfer protocol) servers, application servers, database servers, name servers, mail servers, file servers, print servers, and terminal servers. Most web services are also types of servers.

Debit Cards

The item or good is transferred as normal, but the purchaser uses a debit card instead of money to pay. A debit card contains an electronic record of the purchaser's account with a bank. Using this card, the seller can send an electronic signal to the buyer's bank for the amount of the purchase, and that amount of money is debited from the customer's account and credited to the account of the seller. This is possible even if the buyer or seller uses different financial institutions. Currently, fees to both the buyer and seller for the use of debit cards are fairly low because the banks want to encourage the use of debit cards. The seller must have a card reader set up in order for such purchases to be made. Debit cards allow a buyer to have access to all the funds in his account without having to carry the money around. It is more difficult to steal such funds than cash, but it is still done.

Credit Cards

A credit card is a payment card issued to users as a system of payment. It allows the card holder to pay for goods and services based on the holder's promise to pay for them. The issuer of the card creates a revolving account and grants a line of credit to the consumer (or the user) from which the user can borrow money for payment to a merchant or as a cash advance to the user. A credit card is different from a charge card: a charge card requires the balance to be paid in full each month. In contrast, credit cards allow the consumers a continuing balance of debt, subject to interest being charged. A credit card also differs from a cash card, which can be used like currency by the owner of the card. The size of most credit cards is 85.60×53.98 mm (33/8×21/8 in), conforming to the ISO/IEC 7810 ID-1 standard. Credit cards have an embossed bank card number complying with the ISO/IEC 7812 numbering standard. A credit card issued by a financial company gives the card holder an option to borrow funds, usually at a point of sale. Credit cards charge interest and are primarily used for short-term financing. Interest usually begins one month after a purchase is made and borrowing limits are pre-set according to the individual's credit rating. Almost every store allows for payment of goods and services through credit cards.

How Credit Cards Work

Credit cards are issued by a credit-card issuer, such as a bank or credit union, after an account has been approved by the credit provider, after which card holders can use it to make purchases at merchants accepting that card. Merchants often advertise the credit cards (or other equivalent ways to transact a financial payment) they accept by displaying acceptance marks. When a purchase is made, the credit card user agrees to pay the card issuer. The card holder indicates consent to pay by signing a receipt with a record of the card details and indicating the amount to be paid or by entering a personal identification number (PIN). In addition, many merchants now accept verbal authorizations via telephone and electronic authorization using the Internet, known as a card-not-present transaction (CNP). Electronic verification systems allow merchants to verify in a few seconds that the card is valid and the credit card customer has sufficient credit to cover the purchase, allowing the verification to happen at time of purchase. The verification is performed using a credit card payment terminal or point-of-sale (POS) system with a communications link to the merchant's acquiring bank. Data from the card is obtained from a magnetic stripe or chip on the card; the latter system is called Chip and PIN in the United Kingdom, Ireland, a majority of Europe, Canada and many other places. For card-not-present transactions where the card is not shown (e.g., e-commerce, mail order, and telephone sales), merchants additionally verify that the customer is in physical possession of the card and is the authorized user by asking for additional information such as the security code printed on the back of the card, date of expiry, and billing address. Each month, the credit card user is sent a statement indicating the purchases undertaken with the card, any outstanding fees, and the total amount owed. After receiving the statement, the card holder may dispute any charges that he or she thinks are incorrect. The card holder must pay a defined minimum portion of the amount owed by a due date, or may choose to pay a higher amount up to the entire amount owed, which may be greater than the amount billed. The credit issuer charges interest on the unpaid balance if the billed amount is not paid in full. Many banks also offer the option of electronic statements, either in lieu of or in addition to physical statements, which can be viewed at any time by the card holder via the issuer's online banking website. Notification of the availability of a new statement is generally sent to the card holder's email address. If the card issuer has chosen to allow it, the card holder may have other options for payment besides a physical check, such as an electronic transfer of funds from a checking account. Depending on the issuer, the card holder may also be able to make multiple payments during a single statement period, possibly enabling him or her to utilize the credit limit on the card several times over.

Parties Involved with Credit Cards

Card holder: The holder of the card used to make a purchase; the consumer.

Card-issuing bank: The financial institution or other organization that issued the credit card to the card holder. This bank bills the consumer for repayment and bears the risk that the card is used fraudulently. American Express and Discover were previously the only card-issuing banks for their respective brands, but as of 2007, this is no longer the case. Cards issued by banks to card holders in a different country are known as offshore credit cards.

Merchant: The individual or business accepting credit card payments for products or services sold to the card holder.

Acquiring bank: The financial institution accepting payment for the products or services on behalf of the merchant. An acquiring bank (or acquirer) is the bank or financial institution that processes credit and or debit card payments for products or services for a merchant. The term acquirer indicates that the bank accepts or acquires credit card payment from the card-issuing banks within an association. The best-known (credit) card associations are Visa, MasterCard, American Express, and Discover. The acquiring bank accepts the risk that the merchant may remain solvent over time, and thus has an incentive to take a keen interest in the merchant's products and business practices. Crucial to maintaining an ongoing positive balance is the limiting of reversals of funds. Consumers may trigger the reversal of funds in three ways: (a) a card refund is the return of funds to the consumer, voluntarily initiated by the merchant, (b) a card reversal is where the merchant cancels a transaction after it has been authorized, but before settlement (as if the transaction has never taken place), and (c) a card charge back is a dispute between the merchant and the card holder over the validity of the transaction. The card holder requests the return of funds to the consumer through the issuing bank for a number of reasons including: goods not received, goods not as advertised or faulty or when the card holder denies all knowledge of the transaction. Card associations consider a participating merchant to be a risk if more than 1% of payments received result in a charge back. Visa and MasterCard levy fines against acquiring banks that retain merchants with high charge-back frequency. To defray the cost of any fines received, the acquiring banks are inclined (but not required) to pass such fines on to the merchant. Due to the high amount of risk that the acquiring banks are subject to, as well as their key position in the payment chain, the security of electronic payments is a great concern for these institutions. For this reason, they have been involved in the development of electronic point-of-sale security standards, such as PCI-DSS (Payment Card Industry Data Security Standard) and the emerging SPVA (Secure POS Vendor Alliance) standards. The Payment Card Industry Data Security Standard (PCI DSS) is a proprietary information security standard for organizations that handle card holder information for the major debit, credit, prepaid, e-purse, ATM, and POS cards. Defined by the Payment Card Industry Security Standards Council, the standard was created to increase controls around card holder data to reduce credit card fraud via its exposure. Validation of compliance is done annually by an external Qualified Security Assessor (QSA) that creates a Report on Compliance (ROC) for organizations handling large volumes of transactions, or by self-assessment questionnaire (SAQ) for companies handling smaller volumes.

Independent sales organization: Resellers (to merchants) of the services of the acquiring bank.

Merchant account: This could refer to the acquiring bank or the independent sales organization, but in general is the organization that the merchant deals with.

Credit Card association: An association of card-issuing banks such as Discover, Visa, MasterCard, American Express, etc. that set transaction terms for merchants, card-issuing banks, and acquiring banks.

Transaction network: The system that implements the mechanics of the electronic transactions. May be operated by an independent company, and one company may operate multiple networks.

Affinity partner: Some institutions lend their names to an issuer to attract customers who have a strong relationship with that institution, and are paid a fee or a percentage of the balance for each card issued using their name. Examples of typical affinity partners are sports teams, universities, charities, professional organizations, and major retailers.

Insurance providers: Insurers underwriting various insurance protections offered as credit card perks, for example, Car Rental Insurance, Purchase Security, Hotel Burglary Insurance, Travel Medical Protection etc.

The flow of information and money between these parties—always through the card associations—is known as the interchange.

Credit Card Transaction Steps

AUTHORIZATION: The card holder presents the card as payment to the merchant and the merchant submits the transaction to the acquirer (the acquiring bank). The acquirer verifies the credit card number, the transaction type, and the amount with the issuer (Card-issuing bank) and reserves that amount of the card holder's credit limit for the merchant. An authorization may generate an approval code, which the merchant stores with the transaction. Authorization hold (also card authorization, preauthorization, or preauth) is the practice within the banking industry of authorizing electronic transactions done with a debit card or credit card and holding this balance as unavailable either until the merchant clears the transaction (also called settlement), or the hold “falls off.” In the case of debit cards, authorization holds can fall off the account (thus rendering the balance available again) anywhere from 1-5 days after the transaction date depending on the bank's policy; in the case of credit cards, holds may last as long as 30 days, depending on the issuing bank. Signature-based (non-PIN-based) credit and debit card transactions are a two-step process, consisting of an authorization and a settlement. When a merchant swipes a customer's credit card, the credit card terminal connects to the merchant's acquirer, or credit card processor, which verifies that the customer's account is valid and that sufficient funds are available to cover the transaction's cost. At this step, the funds are “held” and deducted from the customer's credit limit (or bank balance, in the case of a debit card) but are not yet transferred to the merchant. At the end of the day, the merchant instructs the credit card machine to submit the finalized transactions to the acquirer in a “batch transfer,” which begins the settlement process, where the funds are transferred from the customer's accounts to the merchant's accounts. Contrary to popular belief, this process is not instantaneous: the transaction may not appear on the customer's statement or online account activity for one to two days, and it can take up to three days for funds to be deposited in the merchant's account. For example, if an individual has a credit limit of $100 and uses a credit card to make a purchase at a retail store for $30, then his available credit may immediately decrease to $70. This is because the merchant has obtained an authorization from the individual's bank by swiping the card through its credit card terminal. If the billing statement was sent out at that point, the actual charges would still be $0, because the merchant has not actually collected the funds in question. The actual charge is not put through until the merchant submits their batch of transactions, and the banking system transfers the funds. A debit card works slightly differently. Similar to the previous example, if one has a balance of $100 in the bank and used a debit card to make a purchase at a retail store for $30, then his available balance may immediately decrease to $70 as a hold on the $30 is enacted. This is because the merchant has obtained an authorization from the individual's bank by swiping the card through its credit card terminal. However, the actual balance with the bank is still $100, because the merchant has not actually collected the funds in question. However, unless this authorization hold expires without being finalized the user cannot access that part of their account. The actual balance may not be reduced until the merchant submits their batch of transactions, and the banking system transfers the funds.

BATCHING: Authorized transactions are stored in batches, which are sent to the acquirer. Batches are typically submitted once per day at the end of the business day. If a transaction is not submitted in the batch, the authorization may stay valid for a period determined by the issuer, after which the held amount may be returned to the card holder's available credit (see authorization hold). Some transactions may be submitted in the batch without prior authorizations; these are either transactions falling under the merchant's floor limit or ones where the authorization was unsuccessful, but the merchant still attempts to force the transaction through the system. Such may be the case when the card holder is not present but owes the merchant additional money, such as extending a hotel stay or car rental.

CLEARING AND SETTLEMENT: The acquirer sends the batch transactions through the credit card association, which debits the issuers for payment and credits the acquirer. Essentially, the issuer pays the acquirer for the transaction.

FUNDING: Once the acquirer has been paid, the acquirer pays the merchant. The merchant receives the amount totaling the funds (for example) in the batch minus either the “discount rate” or the “qualification-based rate”, which are tiers of fees the merchant pays the acquirer for processing the transactions.

CHARGEBACKS: A chargeback is an event in which money in a merchant account is held due to a dispute relating to the transaction. Chargebacks are typically initiated by the card holder. In the event of a charge-back, the issuer returns the transaction to the acquirer for resolution. The acquirer then forwards the chargeback to the merchant, who must either accept the chargeback or contest it.

Mobile Payments (M-Payments)

Money rendered for a product or service through a portable electronic device such as a cell phone, smart phone, or PDA (Personal Display Assistant). Mobile payment technology can also be used to send money to friends or family members. Mobile payments first became popular in Asia and Europe before becoming more common in the United States and Canada. They can be sent (most popularly) by text message, by passing a smart phone screen displaying a special barcode under a store's barcode scanner or by using a phone to take a photo of a check and sending it. The cost of the purchase may be added to the consumer's phone bill or paid by credit or debit card. By texting a particular code given by the radio program to an assigned number, the listener is able to make a donation of a pre-set amount. That amount is added to the listener's phone bill. M-payment (mobile payment) is a point-of-sale payment made through a mobile device, such as a cellular telephone, a smart phone, or a personal digital assistant (PDA). Using m-payment, a person with a wireless device could pay for items in a store or settle a restaurant bill without interacting with any staff member. Therefore, for example, if a restaurant patron wanted to pay quickly and leave the restaurant on time to get to an appointment, the bill could be paid directly from the table—without waiting for a server to bring the check. The patron would simply connect to the cash register with a wireless device, punch in the table number and bank personal identification number (PIN), and authorize payment. According to Orange Mobile Payment (a Danish company), the entire transaction should take no more than 10 seconds. The earliest m-payment trials were based on the wide area network (WAN) used for cellular phones. That meant, however, that users had to pay cell phone charges to make a payment, and also had to punch in long sequences of digits each time. Other technologies tested enable less cumbersome procedures. Palm (TRADEMARK) and Verifone (TRADEMARK) may use infrared (IR) data transmission for their initial trials. Among the other technologies being used are Bluetooth, WiFi (wireless local area network based on IEEE 802.11 standards), and RFID (Radio Frequency Identification), a short-range transmission system. Public key infrastructure (PKI) encryption—considered to be necessary for secure m-commerce in general—is currently being incorporated into digital wireless networks and into an increasing number of wireless devices, a trend that is likely to increase consumer confidence in m-payment's security. M-payment is already being used in some parts of the world, including Europe and Asia. One small complication hindering wide-spread acceptance of m-payment is the distinction that credit-card companies make between transactions where the card is physically present at the point of sale and those where it is absent—for example, when a credit card is used for transactions over the telephone or your computer's Internet connection. For payments in what are considered “card not present” situations, credit-card companies charge the merchant a higher transaction fee. Whether m-payment would qualify as a “card present” situation or not has yet been determined; that decision may depend on the degree of confidence credit-card companies have in the security of m-payment.

Credit Cards and Mobile Payments

A simple mobile web payment system can also include a credit card payment flow allowing a consumer to enter their card details to make purchases. This process is familiar but any entry of the details on a mobile phone is known to reduce the success rate (conversion) of payments. In addition, if the payment vendor can automatically and securely identify customers, then card details can be recalled for future purchases turning credit card payments into a click-to-buy giving higher conversion rates for additional purchases.

Point-of-Sale System

A point-of-sale (POS) system or device is a machine configured to facilitate a transaction in exchange for goods or services (a commodity). The point of sale often refers to the physical electronic cash register or dedicated POS hardware used for checkout. The POS may be a location where the sale is conducted, money changes hands and a receipt is given, which may occur on a smart phone, tablet, laptop, or mobile POS device when the right hardware and POS software is combined with the mobile device. The POS may be customized by retail industry as different industries have different needs. For example, a grocery or candy store may need a scale at the point of sale, while bars and restaurants may need to customize the item sold when a customer has a special meal or drink request. The point of sale may also include advanced functionalities to cater to different verticals, such as inventory, financials, warehousing, and so on, all built into the POS software. Prior to the modern POS, all of these functions were done independently and required the manual re-keying of information, which resulted in many errors.

FIG. 1 depicts the schematic representation of the example of the apparatus 100. The apparatus 100 may be called a payment-processing apparatus or a payment-card processing system. The apparatus 100 is operatively connected (directly or indirectly or intermittently or continuously) to a network 50. The apparatus 100 may process records in a batch mode or in a real-time mode (i.e., a non-batch mode). The apparatus 100 may be configured to execute or to process the transactions in a batch transfer. The non-batch mode may be executed in real time (on line, via a network) or non-real time. To implement and operate the apparatus 100, the person of skill in the art (or the team of persons skilled in the art) may be skilled in the art of computer programming, perhaps using the PERL computer programming language, may have skill and knowledge pertaining to servers, security techniques, server networking, server administration, and may also have an advanced degree in computing science, and perhaps an advanced degree in electrical engineering, and computer-programming skills related to computer networking techniques, as well as methods related to encryption technology and anti-virus protection techniques as well. The apparatus 100 may be configured to (and is not limited to) facilitate secured financial transactions (facilitate secure electronic commerce).

A point-of-sale device 10 and a second point-of-sale device 20 are operatively connected (directly or indirectly, directly, intermittently or continuously) to the network 50. By way of example, the point-of-sale device 10 may be used in an airplane, a train, or other mobile vehicle. The point-of-sale device 10 may be used in a stationary application as well. The point-of-sale device 10 may include self-service devices, assisted-service devices, mobile devices, and stationary devices. The point-of-sale device 10 may be treated as an example of a server.

For the case where the retail environment includes an airplane in which the flight attendant swipes a credit card in a hand-held mobile POS device and dispenses food items. The POS device may include (for example) a magnetic stripe reader device and/or a contactless and/or chip reader, etc. (that is, some sort of mechanism configured to read the credit card information). The point-of-sale device 10 collects the transaction details in flight (during flight of the airplane), and encrypts (at least in part) the information of each of the individual transaction (such as, the credit card number and/or other data contained in the magnetic stripe). According to an option (in addition to encrypting the credit card number), the point-of-sale device 10 may be further configured to encrypt the batch of financial transaction as a whole if desired using a POS cryptographic process so that all of the information stored in the point-of-sale device 10 is secured in such a way so as to remain confidential. The flight attendant provides a commodity (food item, beverage, magazine, etc.) to the customer in a manner such that the flight attendant does not know whether the customer's credit card is valid and, thus, may be honored. Using the point-of-sale device 10 may still be better than the alternative of having the flight attendant collect cash, so that the flight attendant has less work associated with counting cash and filling in paperwork, and may provide more time for serving customers in flight thus improving service to customers. Another example of the point-of-sale device 10 includes an in-flight entertainment (IFE) system. Manufacturers of IFE systems are Panasonic Avionics Corporation (TRADEMARK), Thales Group (TRADEMARK), Rockwell Collins (TRADEMARK) and LiveTV (TRADEMARK). The in-flight entertainment content onboard airlines may be managed by content service providers (audio content, video content, games, internet connection, phone service, etc.). Such systems are mounted to the back of a seat. The IFE system (an example of the point-of-sale device 10) can be configured to allow the customer to order food items or other commodities, and facilitate payment transactions for the ordered commodity, and after which the flight attendant or onboard server delivers the ordered commodity (duty-free items, etc.) to the customer; in this way, the flight attendant is no longer responsible for facilitating the transaction for the commodity other than to deliver the commodity to the customer. The customer may enter in the credit card information to the IFE system, perhaps by a magnetic stripe reader, etc. As well, the apparatus 100 may be configured to facilitate payments of royalties to the property owners of the copyrighted content (video, audio, etc.) once the content is viewed by a consumer.

The apparatus 100 may be configured to provide a copyright server configured to verify that copyrighted content was viewed. As well, the copyright server can provide or facilitate financial payment of the royalty owed to the owner of the copyrighted material or content that was viewed (while the airline or other company provided access to the copyrighted material to the consumer).

An authorization-provider server 902 is operatively connected to the network 50. The authorization-provider server 902 is configured to, in use, authorize whether a credit card may be used in association with a financial transaction involving the credit card. The authorization-provider server 902 may decline (deny) acceptance of the credit card for a particular transaction.

An acquirer server 904 is operatively connected to the network 50. The acquirer server 904 is configured to, in use, execute the financial transaction involving the credit card in such a way that the merchant involved in the financial transaction may receive payment.

A client server 906 is operatively connected to the network 50. The client server 906 is configured to, in use, interact with the apparatus 100 in order to facilitate the execution of the financial transaction. For example, the client may be an airline company or an agent acting on behalf of the client.

FIG. 2 depicts the schematic representation of the example of the components (such as the servers) of the apparatus 100. The apparatus 100 includes (by way of example and is not limited to): a point-of-sale server 102, a database server 104, a transaction-processing server 106, a settlement-and-reporting server 108, a blacklist server 110, a duplicate-check server 112, a database 114, and the client portal 116. The components of the apparatus 100 may be directly connected together (continuously or non-continuously). The components of the apparatus 100 may also be indirectly connected together (continuously or non-continuously) via the network 50. It may be appreciated that the point-of-sale server 102, the database server 104, the transaction-processing server 106, the settlement-and-reporting server 108, the blacklist server 110, the duplicate-check server 112, the database 114, and the client portal 116 may all be operated by separate business entities or may be all operated by one business entity. The servers of the apparatus 100 are configured to use an apparatus-cryptographic protocol. The apparatus-cryptographic protocol may include a single cryptographic protocol shared by the servers of the apparatus 100. Alternatively, the apparatus-cryptographic protocol may include at least two or more cryptographic protocols that are used by (or between) the servers of the apparatus 100 (this option may provide additional security measures). The apparatus-cryptographic protocol is used in order to secure the information (records) handled by the apparatus 100, and to keep the records processed by the apparatus 100 isolated from the point-of-sale device 10, the authorization-provider server 902, the acquirer server 904, the client server 906 and the client portal 116. The business entities that may operate the point-of-sale device 10, the authorization-provider server 902, the acquirer server 904, the client server 906 may be different from the business entity or business entities that operate the apparatus 100. The apparatus-cryptographic protocol is used to securely isolate the sensitive contents (information) processed by the apparatus 100 from other business entities that are not associated with the business entity operating the apparatus 100.

For the case where the point-of-sale device 10 (of FIG. 1) is located in an airplane, the point-of-sale device 10 collects (receives) details of various financial transactions (using credit cards, but not limited to credit cards). Other forms of payment may be accepted if so desired (and once so configured to do just so), such as debit cards, mobile payments (via cell phones), etc. The details may be collected into a batch (batch of records or batch of recorded financial transactions). The batch of records is encoded using a public key (encryption technique); the batch is then transmitted, via a network, to the point-of-sale server 102. Perhaps after the flight is ended, and the airplane is parked at a gate (of an airport), the point-of-sale device 10 may then communicate with the network in such a way that the encrypted batch record may be transmitted from the point-of-sale device 10 over to the point-of-sale server 102. The point-of-sale server 102 decrypts the batch of records received from the point-of-sale device 10 using a private key (encryption technique) associated with the public key. Once the data is extracted from the batch received from the point-of-sale device 10, the point-of-sale server 102 then encrypts the batch (collection of financial transactions) using a key that is different from the key associated with the point-of-sale device 10 (for the case where all of the transactions were encrypted as a batch). In this way, security is maintained in the apparatus 100 by using an apparatus-cryptographic process.

Of course, it will be appreciated that: (A) in accordance with a first option, the apparatus-cryptographic protocol is different from the point-of-sale cryptographic protocol, and (B) in accordance with a second option, the apparatus-cryptographic protocol is the same as the point-of-sale cryptographic protocol (if so desired). In accordance with another option, each server involved in the apparatus 100 operates with a server-specific cryptographic protocol (if so desired).

The point-of-sale server 102 transfers the batch to the database server 104. The database server 104 places the encrypted batch in the database 114. The transaction-processing server 106 then retrieves the encrypted batch from the database 114 via the database server 104. The transaction-processing server 106 then determines which transactions are valid by communicating the transaction details with the authorization-provider server 902 of FIG. 1 (all communications are performed using cryptographic techniques). For the case where the authorization-provider server 902 provides a report indicating which transactions are valid and which transactions are not valid (to the transaction-processing server 106), the transaction-processing server 106 saves this report to the database 114 via the database server 104. The cryptographic techniques used by the transaction-processing server 106 and the authorization-provider server 902 are different from each other. The settlement-and-reporting server 108 then obtains the status report provided by the authorization-provider server 902 from the database 114. The settlement-and-reporting server 108 then sends a request (for those transactions that are indicated as being valid) to the acquirer server 904 in order to execute payments. The acquirer server 904 then provides a payment report back to the settlement-and-reporting server 108. The settlement-and-reporting server 108 saves that payment report to the database 114 via the database server 104. The cryptographic techniques used by the settlement-and-reporting server 108 and the acquirer server 904 are different from each other. The settlement-and-reporting server 108 then generates a client report based on the payment report located in the database 114. The server transmits the client report to the client server 906. The cryptographic techniques used by the settlement-and-reporting server 108 and the client server 906 are different from each other.

In accordance with an option, the apparatus 100 further includes a client portal 116 is a mechanism (such as, a web portal) configured to facilitate (by using graphical user interfaces) client access to the apparatus 100 by the client. FIGS. 9A to 9BB depicts examples of the user interfaces of the client portal 116.

The following are options for the client portal 116, as follows:

In accordance with an option, the client portal 116 is configured to facilitate client user-login tasks. For example, the client portal 116 is configured to display (provide), to the user via a user-out device (a screen, etc.), a Forgot Password field. The Forgot Password field is configured to allow the user to reset their password by answering security questions setup at the time of their initial login.

In accordance with an option, the client portal 116 is configured to facilitate user-administration tasks. For example, the client portal 116 is configured to display (provide), to the user, Administration screens. The Administration screen are configured to allow the user (customers) to setup new users, assign privileges, and configure the client portal 116 to meet their business needs.

In accordance with an option, the client portal 116 is configured to facilitate Virtual Terminal tasks. For example, the client portal 116 is configured to receive, from the user via a user-input device (a keyboard, etc.), transactions to be processed. In response, the client portal 116 is configured to provide the transactions (to be processed) to the transaction-processing server 106. In response to receiving the transactions to be processed from the client portal 116, the transaction-processing server 106 is configured to process the transactions by using credit card numbers and/or by using tokens where the credit card information (credit card numbers, etc.) is stored in a secure credit card vault of the apparatus 100. The transaction-processing server 106 (or other server) may be configured to provide receipts of processed transactions (print hard copy and/or send via e-mail). The client portal 116 is configured to configure Fields to be displayed on a Transaction Entry screen and the Fields used in the receipt (via the Administration screens).

In accordance with an option, the client portal 116 is configured to facilitate a Search task. The client portal 116 is configured to display (provide), to the user, Search Fields on a Transaction Search screen. The client portal 116 is configured to configure the Search Fields on a Transaction Search via the Administration screens. The client portal 116 is configured to display, at least in part, an invoice header and details for the case where the details are included with the transactions.

In accordance with an option, the client portal 116 is configured to facilitate a Reporting task. For example, the client portal 116 is configured to facilitate download of a reconciliation report (statements) to the user.

In accordance with an option, the client portal 116 is configured to facilitate display (viewing), to the user, of the reconciliation report. For example, the client portal 116 is configured to facilitate display (viewing) of activity associated with the reconciliation report, of information filtering to the reconciliation report, and/or of focused searching of the reconciliation report, of generation of customized reports of the reconciliation report, and/or of downloading of custom reports of the reconciliation report.

In accordance with an option, the client portal 116 is configured to facilitate Token Management tasks. For example, the client portal 116 is configured to create and/or update Tokens where card information is stored in a secure credit card vault of the apparatus 100. The client portal 116 is configured to set-up a schedule for recurring payments.

A field of a user interface is defined as a space allocated for a particular item of information; usually, a field is the smallest unit of information that may be accessed. The field has a field attribute associated with it. For example, some fields are numeric whereas others are textual, etc. A field has a field name. A collection of fields is called a record.

FIG. 3A depicts the schematic representation of the example of the point-of-sale server 102 of the apparatus 100. The point-of-sale server 102 is configured to interface (directly or indirectly) with the point-of-sale device 10. The point-of-sale server 102 is configured to receive an encrypted transaction record 202 that is transmitted from the point-of-sale device 10 to the point-of-sale server 102. The point-of-sale server 102 is configured to decrypt the encrypted transaction record 202 in accordance with the POS cryptographic process associated with the point-of-sale device 10 in such a way so as to extract the=financial content from the encrypted transaction record 202. The point-of-sale server 102 is also configured to encrypt the extract financial content in accordance with the apparatus-cryptographic process associated with the apparatus 100 in such a way so as to encrypt the financial content so as to form a re-encrypted transaction record 302. The point-of-sale server 102 is also configured to interface (directly or indirectly) with the database server 104. The database server 104 is configured to interface with the database 114. The point-of-sale server 102 is also configured to output the re-encrypted transaction record 302 to the database server 104. The database server 104 in turn transmits the re-encrypted transaction record 302 to the database 114 for storage until needed in future. By way of example, the database 114 is also depicted as storing a re-encrypted transaction record 304 and a re-encrypted transaction record 306. The re-encrypted transaction record 302 may have at least one or more financial transactions. The point-of-sale device 10 may provide the encrypted transaction record 202 that has a plurality of financial transaction summaries.

With reference to FIG. 3A, the apparatus 100 is configured for processing a transaction record. The point-of-sale server 102 is configured to cooperatively communicate with a point-of-sale device 10 in such a way so as to input an encrypted transaction record 202 from the point-of-sale device 10. The encrypted transaction record 202 indicates a buyer agreeing to provide a payment in exchange for receiving a commodity, such as a product, and/or a service. The encrypted transaction record 202 is formed by using a point-of-sale cryptographic protocol associated with the point-of-sale device 10. The point-of-sale server 102 is also configured to decrypt the encrypted transaction record 202 using the using a point-of-sale cryptographic protocol in such a way so as to extract the transaction content from the encrypted transaction record 202 received from the point-of-sale device 10. The point-of-sale server 102 is also configured to encrypt the transaction content extracted from the encrypted transaction record 202 by using an apparatus-cryptographic protocol in such a way so as to form a re-encrypted transaction record 302. The apparatus-cryptographic protocol is different from the point-of-sale cryptographic protocol. The point-of-sale server 102 is also configured to output the re-encrypted transaction record 302 in such a way so that the re-encrypted transaction record 302 remains secure while waiting to be further processed. The database server 104 is configured to cooperatively communicate with a database 114 and with the point-of-sale server 102 in such a way so that the database server 104 inputs the re-encrypted transaction record 302 from the point-of-sale server 102, and outputs the re-encrypted transaction record 302 to the database 114.

FIG. 3B depicts the schematic representation of another example of the point-of-sale server 102 of the apparatus 100. The point-of-sale device 10 transmits encrypted transaction record 202, over the network 50, to the point-of-sale server 102. The encrypted transaction record 202 is encrypted at the transport level when transmitted over the network 50. The point-of-sale server 102 receives (inputs) the encrypted transaction record 202. The encrypted transaction record 202 includes information pertaining to at least one or more financial transactions. Each financial transaction includes an encrypted component 250, and also includes an unencrypted component 252. The encrypted component 250 includes confidential information, such as the credit-card, information pertaining to the financial transaction. The unencrypted component 252 includes non-confidential information, such as the value or amount of money, pertaining to the financial transaction. The point-of-sale server 102 is configured to validate the content of the encrypted transaction record 202 by decrypting the encrypted component 250 (in order to view the confidential content 254 of the encrypted component 250. The point-of-sale server 102 is also configured to determine whether the confidential content 254 appears to be valid information (that is, does the confidential content 254 appear to pertain to a credit card number, etc.) That is, the point-of-sale server 102 tests and/or validates the content of the confidential content 254. Once validation is completed, the confidential content 254 is deleted (in a secure way).

For the case where the point-of-sale server 102 determines that the confidential content 254 (content decrypted or extracted) from each instance of the encrypted component 250 is not valid, the point-of-sale server 102 does not permit the encrypted transaction record 202 to proceed toward authorization and settlement. In other words, the entire instance of the encrypted transaction record 202 may be rejected. The point-of-sale server 102 then sends (outputs) a message back the point-of-sale device 10, for display to the user of the point-of-sale device 10 that the point-of-sale device 10 is potentially defective because there was an error processing a particular batch of transactions, and to send in the point-of-sale device 10 for evaluation and repair.

For the case where the point-of-sale server 102 determines that the content decrypted from at least one instance of the encrypted component 250 is valid, the point-of-sale server 102 permits the entire instance of the encrypted transaction record 202 to proceed towards authorization and settlement; that is, the point-of-sale server 102 encrypts the content of the encrypted transaction record 202 using the apparatus-cryptographic process so as to form the re-encrypted transaction record 302. The database server 104 receives the re-encrypted transaction record 302 from the point-of-sale server 102, and then stored the re-encrypted transaction record 302 to the database 114, so that the re-encrypted transaction record 302 waits for further processing. The re-encrypted transaction record 302 contains components in which some components are (in effect) encrypted at least once, and other components are encrypted at least twice. In the re-encrypted transaction record 302, the encrypted component 250 is encrypted (in effect) at least twice while the unencrypted component 252 is encrypted at least once.

The duplicate-check server 112 is configured to check whether the encrypted transaction record 202 may be an instance of a duplicate batch; a duplicate batch is a batch that was previously processed. A batch contains information pertaining to at least one financial transaction. This situation may occur as a result of a point-of-sale device 10 inadvertently failing to clear its memory once the batch was transmitted to the point-of-sale server 102. The point-of-sale server 102 may refer to the information stored in the database 114 to make this determination. For this case, once the duplicate-check server 112 determines that the encrypted transaction record 202 is a duplicate batch, the point-of-sale server 102 then sends (outputs) a message back the point-of-sale device 10, for display to the user of the point-of-sale device 10 that the point-of-sale device 10 is potentially defective because there was an error processing a particular batch of transactions, and to send in the point-of-sale device 10 for evaluation and repair. Duplicate batch errors can be just logged by the POS device and used as a trigger to purge the batch; duplicate batches can occur due to legitimate connectivity issues.

In addition, the duplicate-check server 112 is configured to check whether information pertaining to each financial transaction in the encrypted transaction record 202 may be an instance of a duplicate financial transaction; a duplicate financial transaction is a financial transaction that was previously processed. The point-of-sale server 102 parses out each financial transaction from the encrypted transaction record 202. This situation may occur as a result of a point-of-sale device 10 inadvertently failing to clear its memory once the batch was transmitted to the point-of-sale server 102, and in addition the file name of the batch was changed but the financial transactions contained in the batch remain the same. The point-of-sale server 102 may refer to the information stored in the database 114 to make this determination. This may be understandable given that there may be for example 10,000 instances of the point-of-sale device 10 deployed, and that old (previously transmitted batches) may be inadvertently transmitted back to the point-of-sale server 102. Duplicate transactions within a batch are included in a daily report, as the point-of-sale device 10 no longer has a connection open with the point-of-sale server 102.

In addition, the duplicate-check server 112 is configured to check whether the information pertaining to each financial transaction in the encrypted transaction record 202 may be older than a predetermined time limit. For example, if the financial transactions of a given batch is older than six months, then the point-of-sale server 102 may reject the batch, and the point-of-sale server 102 then sends (outputs) a message back the point-of-sale device 10, for display to the user of the point-of-sale device 10 that there was an error processing a particular batch of transactions. The point-of-sale device 10 may be sent in for evaluation and repair or the error may just be logged by the POS application.

FIG. 4A depicts the schematic representation of the example of the transaction-processing server 106 of the apparatus 100. The transaction-processing server 106 may be used with a duplicate-check server 112. The database 114 is configured to receive and to store the re-encrypted transaction record 302, an encrypted authorization report 401, and an encrypted un-authorization report 404. The encrypted un-authorization report 404 indicates which transactions are declined (that is, transactions that are not authorized for complete processing or execution of transaction to exchange money). The transaction-processing server 106 is configured to input the contents of the re-encrypted transaction record 302. The transaction-processing server 106 is configured to decrypt the re-encrypted transaction record 302 using the apparatus-cryptographic process associated with the apparatus 100. Then, the transaction-processing server 106 is configured to encrypt the extracted contents of the re-encrypted transaction record 302 using the cryptographic process associated with the authorization-provider server 902, and then to generate an encrypted authorization request 303 based on the contents of the re-encrypted transaction record 302. The encrypted authorization request 303 is transmitted to the authorization-provider server 902. The authorization-provider server 902 is configured to transmit, to the transaction-processing server 106, an encrypted authorization report 401. The transaction-processing server 106 is further configured to provide, to the database server 104, an encrypted-duplicate report 504. The duplicate-check server 112 is configured to provide an indication to the transaction-processing server 106 as to whether a financial transaction was previously authorized by the authorization-provider server 902.

Referring to FIG. 4A, the transaction-processing server 106 is configured to cooperatively communicate with the database server 104 in such a way so as to input the re-encrypted transaction record 302 from the database server 104. The transaction-processing server 106 is further configured to decrypt the re-encrypted transaction record 302 by using the apparatus-cryptographic protocol in such a way so as to extract the transaction content from the re-encrypted transaction record 302. The transaction-processing server 106 is further configured to encrypt the transaction content extracted from the re-encrypted transaction record 302 using an authorization-provider cryptographic protocol so as to form an encrypted authorization request 303. The authorization-provider cryptographic protocol is associated with an authorization-provider server 902. The authorization-provider cryptographic protocol is different from the apparatus-cryptographic protocol. The transaction-processing server 106 is further configured to cooperatively communicate with the authorization-provider server 902 in such a way so as to: (A) output the encrypted authorization request 303 to the authorization-provider server 902, and (B) input, from the authorization-provider server 902, an encrypted authorization report 401. The encrypted authorization report 401 is formed by using the authorization-provider cryptographic protocol. The encrypted authorization report 401 has an indication configured to indicate whether the transaction content is any one of authorized and non-authorized. The transaction-processing server 106 is further configured to decrypt the encrypted authorization report 401 in accordance with the authorization-provider cryptographic protocol in such a way so that authorization content is extracted from the encrypted authorization report 401. The transaction-processing server 106 is further configured to encrypt the encrypted authorization report 401 in accordance with the apparatus-cryptographic protocol in such a way so as to form any one of an encrypted authorization report 401 and an encrypted un-authorization report 404. The transaction-processing server 106 is further configured to cooperatively communicate with the database server 104 in such a way so as to output any one of the encrypted authorization report 401 and the encrypted un-authorization report 404 to the database 114. Any one of the encrypted authorization report 401 and the encrypted un-authorization report 404 remain secured while waiting to be further processed.

Referring to FIG. 4A, the duplicate-check server 112 is configured to cooperatively communicate with the database server 104 so as to output (write) an encrypted-duplicate report 504. The duplicate-check server 112 is also configured to cooperatively communicate with the transaction-processing server 106 in such a way so that the duplicate-check server 112 provides the indication to the transaction-processing server 106 of which transactions are duplicates previously processed and should not be reprocessed by the authorization-provider server 902. In this way, the transaction-processing server 106 does not provide the duplicates to the authorization-provider server 902.

FIG. 4B depicts the schematic representation of the example of the transaction-processing server 106 of the apparatus 100 in accordance with a variation. FIG. 4B depicts a case in which the transaction was previously declined (unauthorized) for whatever reason by the authorization-provider server 902. Some time has passed since then, and now it is desired to recheck whether the authorization-provider server 902 may provide authorization for a transaction that was previously declined (presuming that this time the authorization-provider server 902 may authorize the transaction for payment by the acquirer server 904). The database 114 is configured to store the encrypted un-authorization report 404 and the encrypted authorization report 401. The transaction-processing server 106 is configured to generate an authorization request 305 based on the reports obtained from the database 114 via the database server 104. The authorization request 305 is sent to the authorization-provider server 902. The authorization-provider server 902 sends an encrypted payment request 403 to the transaction-processing server 106.

Referring to FIG. 4B, the transaction-processing server 106 is further configured to cooperatively communicate with the database server 104 so as to read the encrypted un-authorization report 404. The transaction-processing server 106 is further configured to cooperatively communicate with the authorization-provider server 902 in such a way so that the transaction-processing server 106 resubmits the content of the encrypted un-authorization report 404 to the authorization-provider server 902 so as to recheck previously submitted transaction information.

FIG. 5 depicts the schematic representation of the example of the settlement-and-reporting server 108 of the apparatus 100. The settlement-and-reporting server 108 executes what may be called the settlement process. It is preferred to execute a duplicate check prior to the settlement-and-reporting server 108 proceeding with its functions. At the close of the day for a client, the settlement-and-reporting server 108 collects all transactions and settles the transactions.

The database 114 is configured to store the encrypted authorization report 401, the encrypted acquirer report 501, and an encrypted-duplicate report 504. The settlement-and-reporting server 108 is configured to receive the reports or content from the database 114, and is configured to generate an encrypted payment request 403 using the acquirer-server cryptographic process associated with the acquirer server 904. The acquirer server 904 provides an encrypted acquirer report 501 back to the settlement-and-reporting server 108. The settlement-and-reporting server 108 decrypts the encrypted acquirer report 501 using the acquirer-server cryptographic process associated with the acquirer server 904. The settlement-and-reporting server 108 generates and then provides an encrypted-duplicate report 504 to the database 114 via the database server 104. The duplicate-check server 112 may be used to assist the settlement-and-reporting server 108; it may be appreciated that the functions of the duplicate-check server 112 may be implemented in the settlement-and-reporting server 108.

Referring back to FIG. 5, the settlement-and-reporting server 108 is configured to cooperatively communicate with the database server 104 in such a way so as to input an encrypted authorization report 401 from the database server 104. The settlement-and-reporting server 108 is also configured to decrypt the encrypted authorization report 401 in such a way so as to extract the transaction content from the encrypted authorization report 401. The settlement-and-reporting server 108 is also configured to encrypt the transaction content extracted from the encrypted authorization report 401 so as to form an encrypted payment request 403 using an encryption technique that is different from the encryption technique associated with the acquirer server 904. The settlement-and-reporting server 108 is also configured to cooperatively communicate with the acquirer server 904 in such a way so as to output the encrypted payment request 403 to the acquirer server 904. The encrypted payment request 403 has the transaction content extracted from the encrypted authorization report 401. The settlement-and-reporting server 108 is also configured to cooperatively communicate with the acquirer server 904 in such a way so as to input an encrypted acquirer report 501 from the acquirer server 904. The encrypted acquirer report 501 has an indication configured to indicate whether the transaction content indicates any one of a paid transaction and a not-paid transaction. The settlement-and-reporting server 108 is also configured to decrypt the encrypted acquirer report 501 using a decryption technique associated with the acquirer server 904. The settlement-and-reporting server 108 is also configured to encrypt the encrypted acquirer report 501 in such a way so as to form an encrypted acquirer report 501 by using the encryption process being different from the process of encryption associated with the acquirer server 904. The settlement-and-reporting server 108 is also configured to cooperatively communicate with the database server 104 in such a way so as to output the encrypted acquirer report 501 to the database 114 in such a way that the encrypted acquirer report 501 remains secured while waiting to be further processed.

According to an option, the duplicate-check server 112 may be used. In that case, the duplicate-check server 112 is configured to cooperatively communicate with the database server 104 so as to write (output) an encrypted-duplicate report 504. The duplicate-check server 112 is also configured to cooperatively communicate with a transaction-processing server 106 in such a way so that the duplicate-check server 112 provides the indication to the transaction-processing server 106 of which transactions are duplicates (i.e., previously processed) and should not be reprocessed by the acquirer server 904. In this way, the transaction-processing server 106 does not provide the duplicates to the acquirer server 904.

FIG. 6 depicts the schematic representation of the example of the settlement-and-reporting server 108 of the apparatus 100 in accordance with a variation. The database 114 stores the encrypted acquirer report 501, the encrypted un-authorization report 404, the client-report database 602, and the encrypted-duplicate report 504. The settlement-and-reporting server 108 is configured to receive content from the database 114 in an encrypted form. The settlement-and-reporting server 108 is also configured to generate an encrypted client report 603 based on the content found in the database 114. The settlement-and-reporting server 108 is also configured to encrypt the encrypted client report 603 based on the cryptographic process associated with the client server 906. According to an option, the settlement-and-reporting server 108 is configured to input, at least in part, the encrypted-duplicate report 504, and to output the contents of the encrypted-duplicate report 504 to the client server 906 via the encrypted client report 603 (if so desired).

Referring back to FIG. 6, the settlement-and-reporting server 108 is configured to cooperatively communicate with the database server 104 in such a way so as to input any one of an encrypted acquirer report 501, an encrypted un-authorization report 404, and an encrypted-duplicate report 504 from the database server 104. The settlement-and-reporting server 108 is also configured to decrypt any one of the encrypted acquirer report 501, the encrypted un-authorization report 404, and the encrypted-duplicate report 504 in such a way so as to extract content from any one of the encrypted acquirer report 501, the encrypted un-authorization report 404, and the encrypted-duplicate report 504. The settlement-and-reporting server 108 is also configured to encrypt the content extracted from any one of the encrypted acquirer report 501, the encrypted un-authorization report 404, and the encrypted-duplicate report 504 so as to form an encrypted client report 603 in accordance with the encryption process associated with the acquirer server 904. The settlement-and-reporting server 108 is also configured to cooperatively communicate with the client server 906 in such a way so as to output the encrypted client report 603 that has the content extracted from any one of the encrypted acquirer report 501, the encrypted un-authorization report 404, and the encrypted-duplicate report 504 to the client server 906.

FIG. 7 depicts the schematic representation of the example of the blacklist server 110 of the apparatus 100.

The acquirer server 904 transmits an acquirer-blacklist report 710 to the database server 104. The acquirer-blacklist report 710 includes a list of credit card numbers that the acquirer entity considers no longer valid (for whatever reason). The client server 906 transmits a client-blacklist report 712 to the database server 104. The client-blacklist report 712 includes a list of credit card numbers that the client entity considers no longer valid (for whatever reason). The database server 104 is configured to: (A) receive the acquirer-blacklist report 710 and the client-blacklist report 712, (B) decrypt the acquirer-blacklist report 710 in accordance with the acquirer-cryptographic process in order to extract content therefrom, (C) decrypt the client-blacklist report 712 in accordance with the client-cryptographic process in order to extract content therefrom. The contents of the acquirer-blacklist report 710 and the client-blacklist report 712 are stored in the database 114 in a secured manner (in accordance with the apparatus-cryptographic process), to be acted upon later by the blacklist server 110. Once the blacklist server 110 is ready, the blacklist server 110 generates a blacklist report 701 based on the contents derived from the acquirer-blacklist report 710 and from the client-blacklist report 712.

In accordance with an option, the blacklist server 110 is configured, at a customer level, to include or exclude (change) specific ranges of credit card numbers based on the issuing country in order to reduce the size of the blacklist report 701. The blacklist server 110 is configured, at a customer level, to generate a base version and/or an update version of the blacklist report 701 in order to limit the amount of data to be transmitted to the point-of-sale device 10 (if so desired).

In accordance with an option, the blacklist server 110 is configured to select (include) specific geographic regions (such as one or more countries, etc.). The blacklist server 110 is configured to deselect (exclude) specific geographic regions (such as one or more countries, etc.). The blacklist server 110 is configured to select and deselect specific geographic regions (such as one or more countries, etc.). The above configurations of the blacklist server 110 may be required to meet the needs of the user (a customer) of the blacklist server 110. For example, an issuer based in the United States may desire to have issuer account ranges to be excluded for most European based customers due to a large volume of card numbers.

In accordance with an option, the blacklist server 110 is configured to set-up and to generate an initial base file, and create update files, on a scheduled basis (such as on a weekly basis). The base file and updates of the base file are used for users (customers) of the blacklist server 110 for the case where a full blacklist load (upload) would not be practical for certain cases (situations). The cases may include: (A) POS devices configured to use a wireless data connection, and/or (B) the blacklist is too large to be loaded on a regular basis, via a network connection, to each instance of the POS device.

The blacklist server 110 is configured to transmit the blacklist report 701 to the point-of-sale server 102, or transmit the blacklist report 701 back to the database 114 (for use later). The point-of-sale server 102 then receives the blacklist report 701 from the database server 104. The point-of-sale server 102 encrypts the blacklist report 701 in accordance with the POS cryptographic process. The point-of-sale server 102 then transmits the blacklist report 701 to the point-of-sale device 10. The operator of the point-of-sale device 10 then is in a better situation to deny financial transaction service for the case where the credit card number matches with an entry found in the blacklist report 701 as identified by the point-of-sale device 10.

According to an option, the client portal 116 may be configured to provide (output) a portal blacklist report 714 that is inputted to the database server 104 as an alternative to (or in addition to) having the client server 906 provide the client-blacklist report 712.

In accordance with an option, the acquirer-blacklist report 710, the client-blacklist report 712 and the portal blacklist report 714 may be inputted to the database server 104, and the database server 104 is further configured to store (output) the acquirer-blacklist report 710, the client-blacklist report 712 and the portal blacklist report 714 in the database 114 (not depicted in FIG. 7) for future reference. Alternatively, the acquirer-blacklist report 710, the client-blacklist report 712 and the portal blacklist report 714 may be inputted to the blacklist server 110, and the blacklist server 110 is further configured to prepare the blacklist report 701, which is then outputted to the database server 104 and/or outputted to the point-of-sale server 102.

Referring back to FIG. 7, the blacklist server 110 is configured to cooperatively communicate with the database server 104 so as to generate a blacklist report 701. The blacklist server 110 is also configured to provide the blacklist report 701 to the point-of-sale server 102. The point-of-sale server 102 is further configured to encrypt the blacklist report 701 so as to produce an encrypted list 702 in accordance with an encryption requirement associated with the point-of-sale device 10. The point-of-sale server 102 is further configured to provide the encrypted list 702 to the point-of-sale device 10.

FIG. 8A depicts the schematic representation of the example of the settlement-and-reporting server 108 of the apparatus 100 in accordance with a variation. It may be appreciated that the functionality of the settlement-and-reporting server 108 described in connection with FIG. 8A may be implemented in another server if so desired (perhaps in order to simplify the operation of the settlement-and-reporting server 108).

The client server 906 is configured to transmit (to the settlement-and-reporting server 108) an encrypted refund-request report 801 (that was encrypted in accordance with the client-server cryptographic protocol).

The settlement-and-reporting server 108 is configured to receive the encrypted refund-request report 801 from the client server 906. The settlement-and-reporting server 108 is further configured to decrypt the encrypted refund-request report 801 in accordance with the client-server cryptographic protocol. If so desired, the settlement-and-reporting server 108 is further configured to store the decrypted contents of the encrypted refund-request report 801 into the encrypted refund record 802 (but to do so in encrypted form by using the apparatus-cryptographic protocol).

The settlement-and-reporting server 108 generates an encrypted refund request 807 (using the acquirer-server cryptographic protocol). The settlement-and-reporting server 108 then transmits the encrypted refund request 807 to the acquirer server 904. The acquirer server 904 extracts the contents of the encrypted refund request 807 (using the acquirer-server cryptographic protocol). The acquirer server 904 processes the contents extracted from the encrypted refund request 807. The acquirer server 904 then generates an encrypted refund response 809 (using the acquirer-server cryptographic protocol). The acquirer server 904 then transmits the encrypted refund response 809 to the settlement-and-reporting server 108. The settlement-and-reporting server 108 then extracts the content from the encrypted refund response 809 (using the acquirer-server cryptographic protocol). The settlement-and-reporting server 108 then generates an encrypted refund report 811 (using the client-server cryptographic protocol), and transmits the encrypted refund report 811 to the client server 906, based on the results and content of the feedback received by the settlement-and-reporting server 108 from the acquirer server 904.

Referring to FIG. 8A, the settlement-and-reporting server 108 is configured to input an encrypted refund-request report 801 from the client server 906. The encrypted refund-request report 801 is encrypted in accordance with the client cryptographic process. The settlement-and-reporting server 108 is further configured to output an encrypted refund request 807 to the acquirer server 904. The encrypted refund request 807 is encrypted in accordance with the acquirer-server cryptographic process. The settlement-and-reporting server 108 is further configured to input an encrypted response from the acquirer server 904. The encrypted response is encrypted in accordance with the acquirer-server crypto graphic process.

FIG. 8B depicts the schematic representation of the example of the settlement-and-reporting server 108 of the apparatus 100 in accordance with another variation. The refunding of transactions may be performed via the client portal 116 or by the client server 906.

The database server 104 receives the encrypted refund-request report 801 either from the client server 906 or from the client portal 116. The database server 104 stores the encrypted refund-request report 801 to the database 114 for future reference. Once the refund request is processed, the result from executing the encrypted refund-request report 801 is contained in the encrypted refund report 811; the database server 104 sends the encrypted refund report 811 either to the client server 906 or to the client portal 116. For the case where the client server 906 provides the encrypted refund-request report 801 to the database server 104, the client server 906 provides an identifier that identifies a selected financial transaction (to be refunded) along with the credit card number and the expiry date of the credit card number. For the case where the client portal 116 provides the encrypted refund-request report 801 to the database server 104, the client server 906 provides an identifier that identifies a selected financial transaction (to be refunded) and the database server 104 then identifies the credit card number and the expiry date of the credit card number for the client. It will be appreciated that the alternative arrangement may be configured if so desired.

The transaction-processing server 106 receives the encrypted refund-request report 801 and then validates and/or authenticates the encrypted refund-request report 801. Validates the merchant identification number matches with that number contained in the database 114, and whether the identification number is matched up with an expected internet address (for security reasons). In other words, the database server 104 determines whether the encrypted refund-request report 801 satisfies a set of a security test (validation) rules. If the encrypted refund-request report 801 fails the test, then the transaction-processing server 106 sends back a service denied message. The transaction-processing server 106 provides a gatekeeper function so as to maintain integrity of the contents of the database 114. The gatekeeping function of the transaction-processing server 106 may be used for any transaction request processed by the apparatus 100—that is, any transaction that any other server of the apparatus 100 may be passed through the transaction-processing server 106 in order to validate or test the integrity of the transaction request before the transaction request is executed.

The duplicate-check server 112 checks and determines whether the encrypted refund-request report 801 received by the database server 104 was previously executed; that is, the duplicate-check server 112 may look up in the encrypted refund record 802 to determine whether the encrypted refund-request report 801 was previously received and/or previously executed. For the case where the duplicate-check server 112 determines that the encrypted refund-request report 801 was previously executed, the duplicate-check server 112 sends back an error message back to either the client server 906 or to the client portal 116. For the case where the duplicate-check server 112 determines that the encrypted refund-request report 801 was not previously sent or previously processed, then the duplicate-check server 112, the duplicate-check server 112 sends a message over to the settlement-and-reporting server 108 and the message asks the settlement-and-reporting server 108 to complete the refund request.

The settlement-and-reporting server 108 receives a message from the duplicate-check server 112 to execute the encrypted refund-request report 801. The settlement-and-reporting server 108 then responds by generating and then encrypting an encrypted refund request 807 (encrypted using the acquirer-cryptographic process), and then transmitting the encrypted refund request 807 to the acquirer server 904. The acquirer server 904 receives, decrypts the encrypted refund request 807 (using the acquirer-cryptographic process), and then executes the contents of the encrypted refund request 807. Once the encrypted refund request 807 is executed, the acquirer server 904 generates and encrypts an encrypted refund response 809 (using the acquirer-cryptographic process) and transmits the encrypted refund response 809 to the settlement-and-reporting server 108. The settlement-and-reporting server 108 then decrypts the encrypted refund response 809 (using the acquirer-cryptographic process); then the settlement-and-reporting server 108 encrypts the contents extracted from the encrypted refund response 809 to form an encrypted report (using the apparatus-cryptographic process) that then is stored to the database 114 (for future reference) in the encrypted refund record 802 for example. In accordance with a variation, the encrypted refund response 809 may be stored in the encrypted acquirer report 501 if so desired. It will be appreciated that the actions of the settlement-and-reporting server 108 can be initiated based on time of day if so desired versus based on receiving a request from any particular server.

Once the results are received form the acquirer server 904, the database server 104 prepares an encrypted refund report 811 based on the contents of the encrypted refund response 809. If the encrypted refund report 811 is to be transmitted to the client server 906, the database server 104 encrypts the encrypted refund report 811 (using the client-cryptographic process) and transmits the encrypted refund report 811 to the client server 906.

FIGS. 9A to 9BB depict the schematic examples of user-screen displays (graphical-user interfaces) of the client portal 116. Generally speaking, the apparatus 100 includes (in accordance with an option) the client portal 116 configured to: (A) present at least one secured user interface in response to receiving a valid user request to view at least one secured user interface, and (B) provide user assistance being configured to facilitate at least one secure financial transaction. The client portal 116 provides the (secured) user interfaces to a valid user request (that is, the log in for a valid user is accepted). The client portal 116 may provide access to the various servers of the apparatus 100 and their associated functions as may be required. The examples of the (secured) user interfaces are depicted in FIGS. 9A to 9 BB.

FIG. 9A depicts a schematic representation of an example of a login interface. The user starts a web browser and enters a URL (Uniform Resource Locator) in the location field located or positioned at the top of the login interface. The user then enters (via a keyboard) an assigned company identifier (number), a user identifier (number), and a password, and then the user clicks on the button labeled login. If a temporary password has been assigned or the user's password has expired, then the user may be required to change their password (reference is made to the password management interface).

FIG. 9B depicts a schematic representation of an example of a main menu interface. Once the user has successfully logged into the apparatus 100, then the main menu screen (interface) may be displayed to the user. The menu options are listed on the left-hand side of the screen in the main menu panel. Menu panels and options displayed may vary based on assigned user privileges.

FIG. 9C depicts a schematic representation of an example of a transaction search interface. The user defines their search criteria by selecting check boxes and entering field values, and then the user may click on the search button. All transaction details may be retrieved if the search button is clicked without specifying any criteria. The start date and the end date may be used to specify the range of transaction dates to be included in the search. “Status” specifies whether the transactions have been approved, declined by the issuer, or rejected by the operator of the apparatus 100 due to a validation error. The following is possible transaction type descriptions: (A) sale—purchase to be authorized and settled if approved, (B) return—merchandise return/refund to be settled, (C) force post—purchase, which has already been approved, e.g. offline or via voice authorization, (D) void—used to cancel a sale, forced post or completion transaction, (E) return void—used to cancel a return transaction, (F) authorized only—used to validate a card; only permitted for specific industries and types of processing, (G) pre-authorized and completion—used for separate authorization and settlement processing cycles: pre-authorized may be used to approve an order with “completion transaction” being processed once goods/services have been delivered. The reference number field may be used to search for a specific transaction. The “return code” may be used to search for declined and rejected transactions with a four-digit response/reason code. The “batch identifier” is a unique value assigned to a batch of settlement transactions. The “batch identifier” is entered as a number for a credit card transaction search. The token is a unique value that can be used for transaction processing in place of a credit card number.

FIG. 9D depicts a schematic representation of an example of a transaction-search results interface. The first page of transactions, which meet the search criteria entered on the transaction-search interface, is displayed. Additional transactions may be viewed by clicking on the page numbers in the navigation bar at the top of the screen. The action column may contain the refund and/or the blacklist links based on the user's privileges and associated rules. The result column may contain the transaction status followed by: (1) an authorization code for approved transactions, (2) a return code for declined and/or rejected transactions. Reference is made to the interfaces described below for details on the expand button, the refund and blacklist actions, and the report download. Clicking on the redefine search link may return the user to the transaction search screen interface, if the search criteria need to be refined or corrected (by the user).

FIG. 9E depicts a schematic representation of an example of a transaction search with expanded data results interface. Additional transaction details can be displayed by clicking on the expand button on the right hand side of the associated row. The POS input column may specify the capture/entry mode for transactions processed via a POS system/device, ‘stripe read’, ‘contactless’, or ‘voice referral’, etc. Source column can specify the processing method used: ‘real-time’ for integrated online systems, ‘batch’ for transactions submitted in files, or ‘web’ for transactions manually entered by users. Once a row has been expanded, the user can click on the close button to hide the additional transaction details.

FIG. 9F depicts a schematic representation of an example of a transaction search —blacklist add interface. If the blacklist action is selected in a row on the transaction search results, then the masked card number and the transaction reference number are displayed. The card number is added to the blacklist by clicking on the add button.

FIG. 9G depicts a schematic representation of an example of a transaction search —blacklist confirmation interface. A message is displayed showing the masked card number that has been added to the blacklist

FIG. 9H depicts a schematic representation of an example of a processing refunds interface. A refund transaction can be processed by clicking on the refund button located to the left side of the associated row on the transaction search results interface. The user may enter the refund amount to be processed and then the user may click on the refund button. Rules may be associated with refund processing, such as: (1) a refund cannot be processed if the original transaction is older than 180 days, (2) a refund amount must be less than 110% of the original transaction amount, and (3) only one refund can be processed per original transaction.

FIG. 9I depicts a schematic representation of an example of a refund results interface. Once the refund has been processed, then a message may be displayed stating, “Your refund request has been successfully submitted.”

FIG. 9J depicts a schematic representation of an example of a refund screen where refund has previously been processed interface.

FIG. 9K depicts a schematic representation of an example of a downloading a report interface. The user may click on the download file link located at the bottom of the interface in order to download (for example) a Comma Separated Values (CSV) report containing the transactions returned by the search initiated by the user.

FIG. 9L depicts a schematic representation of an example of a blacklist management interface. The blacklist management interface (screen) can be used to: add credit card numbers, delete credit card numbers, and search for credit card numbers in the blacklist. The user may select an action and key in the card number to be added, deleted, or searched for in the blacklist An error message may be displayed if the card number does not pass validation rules. All card numbers displayed on the blacklist management interface may be masked to show the first six and last four digits (for example). Privileges assigned to the user identifier may determine which actions can be used.

FIG. 9M depicts a schematic representation of an example of an add card to the blacklist interface. If the action selected is the add action, and the card number passes validation, then a message may be displayed stating, “Card 999999******9999 has been added.”

FIG. 9N depicts a schematic representation of an example of a remove card from the blacklist—authorized user interface. If the action selected is the remove action, and the card number is found in the blacklist, then a message may be displayed stating, “Card 999999******9999 has been removed.”

FIG. 9O depicts a schematic representation of an example of a remove card from the blacklist—unauthorized user interface. If the Action selected is the remove action, and the user is not authorized to delete card numbers from the blacklist, then an error message may be displayed stating, “You are not authorized to remove the card.”

FIG. 9P depicts a schematic representation of an example of a search for a card on the blacklist—authorized user interface. If the action selected is the search action, and the card number is found, then a message may be displayed stating, “Card 999999******9999 found in the blacklist” If the card number was not found, then a message may be displayed stating, “Card 999999******9999 not found in the blacklist”

FIG. 9Q depicts a schematic representation of an example of a search for a card on the blacklist—unauthorized user interface. If the action selected is the search action, and the user is not authorized to search for card numbers in the blacklist then an error message may be displayed stating, “You are not authorized to search card.”

FIG. 9R depicts a schematic representation of an example of a black list approval interface. The blacklist approval interface can be accessed by users with administrative privileges to approve the card numbers to be added to the blacklist Card numbers included in the approval list may have been added by: (1) manually entering the card number using the blacklist management interface: these transactions may be displayed in the approval list with the card number masked to show first six digits and/or the last four digits, (2) selecting the blacklist action on the transaction search results interface. These transactions may be displayed by type ‘add from transaction’ and the card number masked to show only the last four digits. The user clicks on the approve button in the action column in order to add the card number to the blacklist

FIG. 9S depicts a schematic representation of an example of a blacklist approval—confirmation interface. The user click on the OK button in the confirmation dialog box in order to proceed with the addition of the card number to the blacklist Status of the card number may be left unchanged if the cancel button is clicked.

FIG. 9T depicts a schematic representation of an example of a blacklist approval—confirmation approved interface. The action column may be updated to “Approved” after the card number approval has been confirmed.

FIG. 9U depicts a schematic representation of an example of a blacklist approval—delete card interface. The user clicks on the delete button in order to remove a card number from the list.

FIG. 9V depicts a schematic representation of an example of a blacklist approval—delete card confirmation interface. The user clicks on the OK button in the confirmation dialog box in order to proceed with the removal of the card number from the list. Status of the card number may be left unchanged if the Cancel button is clicked.

FIG. 9W depicts a schematic representation of an example of a blacklist approval—card deletion approved interface. The action column may be updated to “deleted” after the card number removal has been confirmed.

FIG. 9X depicts a schematic representation of an example of a password management interface. The password management interface allows a user to update their password. This interface may be displayed automatically after user login if the password has expired or a temporary password was assigned to the user.

FIG. 9Y depicts a schematic representation of an example of a successful password update interface. This interface may be displayed confirming that the password update was completed if the user correctly enters their current and new password values.

FIG. 9Z depicts a schematic representation of an example of an unsuccessful password update—new passwords do not match interface. This error message may be displayed if the new password values do not match.

FIG. 9AA depicts a schematic representation of an example of an unsuccessful password update—current password is incorrect interface. This error message may be displayed if the current password value is incorrect.

FIG. 9BB depicts a schematic representation of an example of a logging out interface. The user clicks on the log out link that may end the user session. The user may log in again at a later time by clicking on the log in link or by opening a new browser window.

FIGS. 10A and 10B depict the schematic representations of other embodiments of the apparatus 100. The apparatus 100 includes (and is not limited to) a source server 990, an intermediate server 992, and a sink server 994. It may be appreciated that the source server 990, the intermediate server 992, and the sink server 994 may be provided separately. That is, different business entities may use/operate each of the source server 990, the intermediate server 992, and the sink server 994.

The source server 990 is configured to input, at least in part, an unencrypted record 950. The source server 990 is also configured to encrypt, at least in part, the unencrypted record 950 in accordance with a source-server cryptographic protocol being associated with the source server 990 in such a way so as to form a source-server encrypted record 952. The source server 990 is also configured to output, at least in part, the source-server encrypted record 952 in such a way so that the source-server encrypted record 952 remains secure while waiting to be further processed.

The intermediate server 992 is configured to input, at least in part, the source-server encrypted record 952 outputted, at least in part, from the source server 990. The intermediate server 992 is also configured to decrypt, at least in part, the source-server encrypted record 952 in accordance with the source-server cryptographic protocol in such a way so as to form the unencrypted record 950. The intermediate server 992 is also configured to encrypt, at least in part, the unencrypted record 950 in accordance with an intermediate-server cryptographic protocol associated with the intermediate server 992 in such a way so as to form an intermediate-server encrypted record 954. The intermediate-server encrypted record 954 remains secure while waiting to be further processed. The intermediate server 992 is also configured to decrypt, at least in part, the intermediate-server encrypted record 954 in accordance with the intermediate-server cryptographic protocol in such a way so as to form the unencrypted record 950. The intermediate server 992 is also configured to encrypt, at least in part, the unencrypted record 950 in accordance with a sink-server cryptographic protocol associated with a sink server 994 in such a way so as to form a sink-server encrypted record 956. The sink-server encrypted record 956 remains secure while waiting to be further processed. The intermediate server 992 is also configured to output, at least in part, the sink-server encrypted record 956 in such a way so that the sink-server encrypted record 956 remains secure while waiting to be further processed.

The sink server 994 is configured to input, at least in part, the sink-server encrypted record 956 outputted from the intermediate server 992. The sink server 994 is also configured to decrypt, at least in part, the sink-server encrypted record 956 in accordance with the sink-server cryptographic protocol in such a way so as to form the unencrypted record 950. The sink server 994 is also configured to process the unencrypted record 950.

Referring to FIG. 10B, the sink server 994 is further configured to process, at least in part, the unencrypted record 950 in such a way so as to form a unencrypted processed record 958. The sink server 994 is further configured to encrypt, at least in part, the unencrypted processed record 958 in accordance with the sink-server cryptographic protocol in such a way so as to form a sink-server encrypted processed record 960. The sink server 994 is further configured to output, at least in part, the sink-server encrypted processed record 960 in such a way so that the sink-server encrypted processed record 960 remains secure while waiting to be further processed.

The sink server 994 is further configured to output, at least in part, the sink-server encrypted processed record 960 to the intermediate server 992. The intermediate server 992 is further configured to input, at least in part, the sink-server encrypted processed record 960 being outputted from the sink server 994. The intermediate server 992 is further configured to decrypt, at least in part, the sink-server encrypted processed record 960 in accordance with the sink-server cryptographic protocol in such a way so as to form the unencrypted processed record 958. The intermediate server 992 is further configured to encrypt, at least in part, the unencrypted processed record 958 in accordance with the intermediate-server cryptographic protocol in such a way so as to form an intermediate-server encrypted processed record 962. The intermediate-server encrypted processed record 962 remains secure while waiting to be further processed.

The intermediate server 992 is further configured to decrypt, at least in part, the intermediate-server encrypted processed record 962 in accordance with the intermediate-server cryptographic protocol in such a way so as to form the unencrypted processed record 958. The intermediate server 992 is further configured to encrypt, at least in part, the unencrypted processed record 958 in accordance with the source-server cryptographic protocol in such a way so as to form a source-server encrypted processed record 964, and the source-server encrypted processed record 964 remaining secure while waiting to be further processed. The intermediate server 992 is further configured to output, at least in part, the source-server encrypted processed record 964 in such a way so that the source-server encrypted processed record 964 remains secure while waiting to be further processed.

The source server 990 is further configured to input, at least in part, the source-server encrypted processed record 964 being outputted by the intermediate server 992. The source server 990 is further configured to decrypt, at least in part, the source-server encrypted processed record 964 in accordance with the source-server cryptographic protocol in such a way so as to form, at least in part, the unencrypted processed record 958. The source server 990 is further configured to process, at least in part, the unencrypted processed record 958.

There is provided a method for operating the apparatus 100 including the intermediate server 992. The method includes an operation (I) including inputting, at least in part, a source-server encrypted record 952 being outputted, at least in part, from a source server 990, the source server 990 being configured to: (a) input, at least in part, an unencrypted record 950, (b) encrypt, at least in part, the unencrypted record 950 in accordance with a source-server cryptographic protocol being associated with the source server 990 in such a way so as to form the source-server encrypted record 952, (c) output, at least in part, the source-server encrypted record 952 in such a way so that the source-server encrypted record 952 remains secure while waiting to be further processed, (d) output, at least in part, the source-server encrypted record 952 to the intermediate server 992. The method further includes an operation (II) including decrypting, at least in part, the source-server encrypted record 952 in accordance with the source-server cryptographic protocol in such a way so as to form the unencrypted record 950. The method further includes an operation (III) including encrypting, at least in part, the unencrypted record 950 in accordance with an intermediate-server cryptographic protocol being associated with the intermediate server 992 in such a way so as to form an intermediate-server encrypted record 954, and the intermediate-server encrypted record 954 remaining secure while waiting to be further processed. The method further includes an operation (IV) including decrypting, at least in part, the intermediate-server encrypted record 954 in accordance with the intermediate-server cryptographic protocol in such a way so as to form the unencrypted record 950. The method further includes an operation (V) including encrypting, at least in part, the unencrypted record 950 in accordance with a sink-server cryptographic protocol being associated with a sink server 994 in such a way so as to form a sink-server encrypted record 956, and the sink-server encrypted record 956 remaining secure while waiting to be further processed. The method further includes an operation (VI) including outputting, at least in part, the sink-server encrypted record 956 in such a way so that the sink-server encrypted record 956 remains secure while waiting to be further processed. The method further includes an operation (VII) including outputting, at least in part, the sink-server encrypted record 956 to the sink server 994, the sink server 994 being configured to: (a) input, at least in part, the sink-server encrypted record 956 being outputted from the intermediate server 992, (b) decrypt, at least in part, the sink-server encrypted record 956 in accordance with the sink-server cryptographic protocol in such a way so as to form the unencrypted record 950, and (c) process the unencrypted record 950.

There is provided a method for operating the apparatus 100 including the source server 990. The method includes an operation (I) including inputting, at least in part, an unencrypted record 950. The method further includes an operation (II) including encrypting, at least in part, the unencrypted record 950 in accordance with a source-server cryptographic protocol being associated with the source server 990 in such a way so as to form a source-server encrypted record 952. The method further includes an operation (III) including outputting, at least in part, the source-server encrypted record 952 in such a way so that the source-server encrypted record 952 remains secure while waiting to be further processed. The method further includes an operation (IV) including outputting, at least in part, the source-server encrypted record 952 to an intermediate server 992, the intermediate server 992 being configured to: (A) input, at least in part, the source-server encrypted record 952 being outputted, at least in part, from the source server 990, (B) decrypt, at least in part, the source-server encrypted record 952 in accordance with the source-server cryptographic protocol in such a way so as to form the unencrypted record 950, (C) encrypt, at least in part, the unencrypted record 950 in accordance with an intermediate-server cryptographic protocol being associated with the intermediate server 992 in such a way so as to form an intermediate-server encrypted record 954, and the intermediate-server encrypted record 954 remaining secure while waiting to be further processed, (D) decrypt, at least in part, the intermediate-server encrypted record 954 in accordance with the intermediate-server cryptographic protocol in such a way so as to form the unencrypted record 950, (E) encrypt, at least in part, the unencrypted record 950 in accordance with a sink-server cryptographic protocol being associated with a sink server 994 in such a way so as to form a sink-server encrypted record 956, and the sink-server encrypted record 956 remaining secure while waiting to be further processed, (F) output, at least in part, the sink-server encrypted record 956 in such a way so that the sink-server encrypted record 956 remains secure while waiting to be further processed, and (G) output, at least in part, the sink-server encrypted record 956 to the sink server 994, the sink server 994 being configured to: (a) input, at least in part, the sink-server encrypted record 956 being outputted from the intermediate server 992, (b) decrypt, at least in part, the sink-server encrypted record 956 in accordance with the sink-server cryptographic protocol in such a way so as to form the unencrypted record 950, and (c) process the unencrypted record 950.

There is provided a method for operating the apparatus 100 including the sink server 994. The method includes an operation (I) including inputting, at least in part, a sink-server encrypted record 956 being outputted from an intermediate server 992. The intermediate server 992 is configured to (A) input, at least in part, a source-server encrypted record 952 being outputted, at least in part, from a source server 990. The source server 990 is configured to: (a) input, at least in part, an unencrypted record 950, (b) encrypt, at least in part, the unencrypted record 950 in accordance with a source-server cryptographic protocol being associated with the source server 990 in such a way so as to form the source-server encrypted record 952, and (c) output, at least in part, the source-server encrypted record 952 in such a way so that the source-server encrypted record 952 remains secure while waiting to be further processed, (d) output the source-server encrypted record 952 to the intermediate server 992. The intermediate server 992 is also configured to (B) decrypt, at least in part, the source-server encrypted record 952 in accordance with the source-server cryptographic protocol in such a way so as to form the unencrypted record 950. The intermediate server 992 is also configured to (C) encrypt, at least in part, the unencrypted record 950 in accordance with an intermediate-server cryptographic protocol being associated with the intermediate server 992 in such a way so as to form an intermediate-server encrypted record 954, and the intermediate-server encrypted record 954 remaining secure while waiting to be further processed. The intermediate server 992 is also configured to (D) decrypt, at least in part, the intermediate-server encrypted record 954 in accordance with the intermediate-server cryptographic protocol in such a way so as to form the unencrypted record 950. The intermediate server 992 is configured to (F) encrypt, at least in part, the unencrypted record 950 in accordance with a sink-server cryptographic protocol being associated with the sink server 994 in such a way so as to form the sink-server encrypted record 956, and the sink-server encrypted record 956 remaining secure while waiting to be further processed. The intermediate server 992 is configured to (G) output, at least in part, the sink-server encrypted record 956 in such a way so that the sink-server encrypted record 956 remains secure while waiting to be further processed. The intermediate server 992 is configured to (H) output, at least in part, the sink-server encrypted record 956 to the sink server 994. The method further includes an operation (II) including decrypting, at least in part, the sink-server encrypted record 956 in accordance with the sink-server cryptographic protocol in such a way so as to form the unencrypted record 950. The method further includes an operation (III) including processing the unencrypted record 950.

Additional Configurations

The financial transaction processing system (that is, the apparatus 100) may be configured to integrate with existing client financial systems and point-of-sale devices using messages over SSL (Secure Sockets Layer) connections. Secure Sockets Layer is a protocol for transmitting private documents via the Internet. SSL uses a cryptographic system that uses two keys to encrypt data—a public key known to everyone and a private or secret key known only to the recipient of the message. Many web browsers and many Web sites use the SSL protocol to obtain confidential user information, such as credit card numbers. By convention, URLs that require an SSL connection start with https: instead of http. A web browser can be used to encrypt sensitive data used to communicate with the financial transaction-processing system used by the client or merchant. Integration of credit card processing with existing systems can be achieved using the network APIs and tools available for programming languages. Transaction messages supported by the interface includes strings of “name=value” pairs, which can be sent using HTTP over SSL.

The apparatus 100 may be configured to support a wide range of transaction types as well as standard fraud prevention tools.

According to an option, the transactions processed by the apparatus 100 is configured to use tokens in place of the credit card number (or other identify associated with the financial transaction) and expiry date, etc. This allows the client to retain all sensitive card data stored by the apparatus 100, and thus improves security and simplifies security compliance.

According to another option, the apparatus 100 includes card and merchant velocity, duplicate checking, response retransmission, and unwelcome card checking (contra checking).

The client portal 116 of FIG. 2 to the apparatus 100 may be Web-based, and is configured to permit back office functions. Such functions may include (for example): searching for transactions, facilitating refunds as may be required, generating reports (“ad hoc” reports), and allowing users to reconcile the day's transactions against a client database or client accounting records.

Credit Card Processing

The credit card charging process includes three stages: authorization, settlement, and deposit.

Authorization is where the apparatus 100 asks the card issuer to tell the apparatus 100 if there is enough open-to-buy credit limit available on the card to make the purchase. A successful authorization lowers the card's open-to-buy limit, but not the card's available credit. This open-to-buy reduction may be restored if there is no subsequent deposit or a reversal is issued for that authorization. The time it takes for the open-to-buy to be automatically restored is usually around five days, but can be longer depending on the card issuer.

Settlement is the process where the transactions that may cause funds to move are batched up for inclusion in the day's deposit. This is also known as a batch close. Depending on the merchant setup, this can be time-based (automatic), or it can be initiated by the merchant at the point-of-sale system.

Deposit is where the apparatus 100 gathers the transaction batches marked for deposit and sends them to the merchant's bank. Once at the bank, the funds are placed into the merchant's account. The charged credit cards' available credit is also affected at this point. The apparatus 100 can deposit all settled transactions nightly.

Processing Financial Transactions

Transaction Delivery Methods: the apparatus 100 may be configured to support real-time transaction delivery using SSL. The client can connect to the apparatus 100 using SSL and send the transaction information (records) without HTTP headers, or an HTTPS GET can be used in order to send the transaction and receive the response in an HTTP response format. The HTTPS GET method is useful if the client software is capable of performing HTTPS page retrievals, and this may be used as a method for processing transactions with the apparatus 100. The HTTPS transaction may be accomplished with a regular web browser by entering the transaction in the URL field. The response is then delivered back to the browser as a document of MIME type “text/plain,” which may allow the response to be shown in the browser. Using a browser is a good method for testing connectivity before the client starts building the client interface. Note that regardless of whether the client uses the HTTPS GET method or the raw SSL method, the response may be the same, and may contain “Content-type:” and “Content-length:” MIME tags.

Transaction Requests: transactions are delivered using field names and values. Transaction requests are built by concatenating a series of fields and their values, separated by ampersands (&). If an ampersand is required for a field value, then two ampersands (“&&”) must be sent in order to distinguish between the field and field separators.

Transaction Responses: responses may include a string of field names and their associated values, separated by ampersands. HTTP headers may be received before the response message.

Transaction Types: the apparatus 100 supports a suite of transaction types including the following: Sale, Void, Force Post, Return, Return Void, Auth Only, Pre-Authorization, and Completion.

Sample Transaction: the Sample below shows the transaction request and response for a real-time credit card Sale transaction.

Two Examples of Transaction Requests

Example 1:
TERMID=TESTMERC&CARD=5123456789012345&EXP=0407&AMT=4350&REF=43&TYPE=S

Example 2: via https://lt3a.caledoncard.com/TERMID=TESTMERC&CARD=5123456789012345&EXP=0407&AMT=4350&REF=43&TYPE=S

Two Examples of Transaction Responses:

Example 1: HTTP/1.0 200 OK Content-type: text/plain Content-length: 47

Example 2: TEXT=045560 $43.50&AUTH=045560&CODE=0000

Tokenization

Tokenization is the process of exchanging sensitive credit card numbers and expiry dates for a label (called a token) which “stands in” for the credit card data at (or in) the apparatus 100. A benefit of tokenization is that the merchant no longer stores their own credit card data: they may store a “token” instead. The apparatus 100 may be configured to store the actual credit card data, and may be configured to retrieve the information in order to charge or refund the card; in this way, the credit card number (or other equivalent financial transaction number) is not required by the merchant. The card data is stored in a secure credit card vault of the apparatus 100, which is an encrypted, protected database designed to be PCI (Payment Card Industry) compliant and as secure as possible.

The Payment Card Industry (PCI) Data Security Standard (PCI DSS) is a proprietary information security standard for organizations that handle card holder information for the major debit, credit, prepaid, e-purse, ATM, and POS cards. Defined by the Payment Card Industry Security Standards Council, the standard was created to increase controls around card holder data to reduce credit card fraud via its exposure. Validation of compliance is done annually—by an external Qualified Security Assessor (QSA) that creates a Report on Compliance (ROC) for organizations handling large volumes of transactions, or by Self-Assessment Questionnaire (SAQ) for companies handling smaller volumes.

Tokenization offers several benefits for the merchant. Here are some advantages: (A) in case of a merchant data security breach or information leak, no card numbers can be stolen, (B) the merchant does not have to deal with encryption and key management, and periodic PCI mandated key changes are also avoided, (C) recurring payments are simplified due to the fact that account numbers can be used as tokens in place of credit card data, (D) payment applications can process transactions such as completions and returns without card numbers, greatly simplifying PA-DSS requirements, (E) third party developers can work on merchants' e-commerce applications without the possibility of them gaining access to sensitive credit card data, (F) the risk to your company's reputation is greatly diminished in the event of a merchant data security breach, (G) the merchant may be able to make use of future developments in the tokenization solutions of the apparatus 100, including tokenization of other sensitive data, and (H) PCI compliance is made easier and less costly for the merchant using tokenization since the card storage zone may be implemented in the apparatus 100.

Apparatus 100 Configured to Execute Tokenization

Associating tokens with cards: When a merchant has collected credit card information and wishes to exchange it for a token, the merchant may send a transaction to the apparatus 100 containing the credit card number, the expiry date, and the token (label) that the merchant would like to use to refer to that credit card number. The apparatus 100 encrypts this data and stores the encrypted data in the secure token vault of the apparatus 100. This token may now be available to the client for charging of the customer's credit card. At the apparatus 100, each token is associated with a particular company or merchant.

Charging cards using tokens: Once a token is in the secure credit card vault of the apparatus 100, the token can be used to charge the associated card. At this point, transactions sent to the authorization gateway of the apparatus 100 are such that a card number and expiry date are no longer required to be sent by the merchant. A token is sent in their place. The token can be used for all types of transactions, including sales, returns, voids, pre-authorizations, and completions. Storage of the token at the merchant site is much safer than storing the real card data, since the token can only be used to initiate charges between the merchant and the stored card number.

Modifying token data: From time to time, certain data associated with a token may need to be updated. A customer's card may expire, or they may want to change the card number on file. The apparatus 100 provides a transaction to make either of these modifications. The token name and the new credit card information are sent to the apparatus 100, and the apparatus 100 may update the information in the vault. Tokens can also be deactivated and reactivated in the same manner.

Example of Tokenization Use: The following is an example of the use of tokenization for payment processing:

A merchant operates a telephone company. In order to keep things simple, the customer's account number in the billing system is the same as their phone number. Bob Smith has the phone number 416-555-1212, so this is his account number in the company's computer system. When Bob signs up for service with the phone company and says he would like to pay by credit card, the company's billing system sends the apparatus 100 a transaction requesting that Bob's credit card information be “tokenized.” The tokenization transaction to the apparatus 100 contains the credit card number and the expiry date, as well as Bob's account number “416-555-1212.” The apparatus 100 sends a reply back to the telephone company's billing system confirming that the apparatus 100 now has the customer's payment information. At this point, the phone company's system can discard the credit card data (if they wish). The token “416-555-1212” may now be sufficient information to charge Bob Smith's card. A few months later, Bob's card is about to expire. Updating the expiry date on file at the apparatus 100 may be done by sending the token with a new expiry date. The merchant does not need to collect the credit card number again.

In view of the above (and with reference to FIG. 11), there is provided an example of the apparatus 100 that includes a token server 850 configured to: (A) securely interface with a secured vault, (B) store an identifier associated with a credit card in the secured vault, (C) receive, from a merchant, a token representing the identifier associated with the credit card, (D) receive, from the merchant, a financial transaction associated with the token, (E) retrieve the credit card from the secured vault, the credit card number being associated with the token received from the merchant, and (F) execute the financial transaction in response to receiving the financial transaction and retrieving the credit card from the secured vault. It may be appreciated that any of the servers of FIG. 2 may be configured to implement the token technology described above. As well, the token server 850 may be integrated with, or used with, the servers depicted in FIG. 2.

Enhanced Data Submission

When a credit card is charged, the card holder's statement contains only a basic set of limited information. For the most part, the statement tells the card holder the name of the merchant, the location, or phone number, and the total amount billed. For most card holders, this arrangement is acceptable. Since this is the most basic level of detail, this may be called Level 1. With the rise of business-to-business purchase card and commercial card transactions, more detail was required (′Purchase Cards' and ‘Commercial Cards’ may hereafter be referred to as ‘commercial cards’).

Level 2 provides additional information about the order, including tax, shipping, and duty charges.

Level 3 provides information about each invoice line item sold within the order, including a description, tax status, and special discounts.

In order to submit Level 2 and Level 3 information for inclusion on commercial card statements, Level 2 data are submitted at the same time as Level 1 data. Level 3 data, the line-item details, are sent in separate transactions, and are related back to the Level 2 data by a Unique Identifier (UID) which the apparatus 100 may deliver in the transaction response from commercial card authorizations (only commercial cards may receive this UID).

Level 3 details are submitted using transaction type ‘L’, and line item details are delivered one line item per transaction. The line items for a particular order must be sent with the UID assigned to that order. There can be up to 999 line items for an order, but some deposit institutions may only accept 99 items or have other limits for the number of line items.

Transaction Flow: The flow of transactions for commercial card detail delivery looks like the following:

(1a) Send Level 1+2 information in the same transaction message;

(2) Receive authorization response and UID;

(2a) Send Level 3 line item with UID;

(2b) Receive confirmation response (‘DETAILS DELIVERED’);

(2c) Send Level 3 line item with UID;

(2e) Receive confirmation response (‘DETAILS DELIVERED’);

(2f) Send Level 3 line item with UID;

(2g) Receive confirmation response (‘DETAILS DELIVERED’);

(3) Send next Level 1+2 transaction;

(4) Receive authorization and UID;

(4a) Send Level 3 line item with UID;

(4b) Receive confirmation response (‘DETAILS DELIVERED’);

(4c) Send Level 3 line item with UID;

(4d) Receive confirmation response (‘DETAILS DELIVERED’); and

(5) etc.

The UID may be sent all the way through to the card issuer's billing system, where it is used to match the Level 1 data with the Level 2 and Level 3 data. The UID must be sent in order for Level 3 to work.

UIDs are unique in that they are never duplicated throughout the whole banking network. Since they are of a finite size, UIDs are only returned on transactions that can use them. The merchant or client may receive a UID under the following circumstances: (A) the transaction is a Sale, Force Post, Return, or Completion, (B) the terminal ID is set up for Level 2 and Level 3 processing, (C) the transaction was successful (approved), (D) the card is a commercial Visa, MasterCard, American Express card or a Sears, Bay, or Zellers card.

If the terminal ID is set up for Level 2 delivery, UIDs are returned regardless of whether Level 2 data is sent.

Transaction Flow—Airline Data: Airline data (AIR) is submitted in the same transaction message as the Level 1 and Level 2 data. No UID is required to send airline data. Airline data can be sent on commercial cards as well as all American Express cards.

In view of the above (and with reference to FIG. 11), in accordance with an option, the apparatus 100 includes an enhanced data-processing server 852 configured to provide additional information about a financial transaction, including any one of tax, shipping, and duty charges.

In view of the above (and with reference to FIG. 11), in accordance with another option, the apparatus 100 includes an enhanced data-processing server 852 configured to provide additional information about a financial transaction, including any one of each invoice line item sold within an order, a description, tax status, and special discounts.

In view of the above (and with reference to FIG. 11), in accordance with yet another option, the apparatus 100 includes an enhanced data-processing server 852 configured to provide additional information about a financial transaction, including airline itinerary information, including any one of passenger name, ticket number, routing information, and carrier. It may be appreciated that the functionality of the enhanced data-processing server 852 may be included in any server depicted in FIG. 2.

Address Verification Service (AVS)

Address Verification Service (AVS) allows card holder address information to be included with a credit card transaction for comparison with the address that the card issuer has on file. AVS is currently available for Visa, MasterCard, and American Express. Address information is submitted for verification by including the AVS field in a credit card request message using the following format: (A) Maximum length of 29 characters, including letters, numbers, and hyphen (-), (B) Address information can include street address or post office (P.O.) box number, and zip/postal code, (C) Street address can include street number and street name or only street number, (D) If the zip/postal code is included, then it must be placed in the last 5-9 characters of the AVS field, (E) Numbered street names cannot be spelled out, e.g.: Third Street must be submitted as 3RDSTREET, (F) If a P.O. Box is being submitted, then a hyphen (-) must be placed between the P.O. Box and the zip code/postal code, e.g.: POBOX1234-M9M9M9, POBOX1234-99999s

AVS Examples: Using address of 27 Mill St East, Toronto, ON, J8Z 3N5:

AVS=27MILLJ8Z3N5

AVS=27J8Z3N5

AVS=J8Z3N5

In view of the above (and with reference to FIG. 11), it will be appreciated in accordance with an option, the apparatus 100 includes an address-verification server 854 configured to provide any one of card holder address information with a credit card transaction for comparison with the address that the card issuer has on file. It may be appreciated that any of the servers of FIG. 2 may be configured to implement the address-verification server 854 described above. As well, the address-verification server 854 may be integrated with, or used with, the servers depicted in FIG. 2.

Optional Configurations of Apparatus 100

The apparatus 100 may be further configured to execute: (A) duplicate checking

(Batch File Name, Transaction Level), (B) automatic retry for authorization failures, (C) activity and decline monitoring overnight settlement and reporting daily settlement reconciliation, (D) decline retry reprocessing (number of days and retry attempts are configurable), (E) blacklist management (credit card numbers can be added to blacklist by merchant, and the blacklist file may be up-loaded to POS devices), (F) purchase card level 2 and/or level 3 details (purchase and/or invoice details passed to commercial card holders), (G) airline and/or itinerary details (passenger/itinerary details passed to commercial and card holders), (H) tokenization (unique token is used in place of a credit card number—or equivalent—for repeat purchases and recurring payments).

The apparatus 100 provides or accomplishes a practical application. The apparatus 100 produces a useful, concrete and tangible result in such a way that financial transactions are processed in a secured way. The above description identifies what the programmed computer (server) does when it performs the processes dictated by the software, i.e. identifies the functionality of the programmed computer. The above description identifies how the computer is to be configured to provide that functionality, i.e. identify what elements constitute the programmed computer and identify how those elements are configured and interrelate to provide the specified functionality. The above description identifies the relationship of the programmed computer to other subject matter outside the computer (apparatus 100) i.e. explanation of how the computer (servers) is to be integrated with other elements that are a part of the apparatus 100 such as machines, devices and materials, and explains how the computer (server) is to be used in a process. The above description identifies that software constitutes a part of a way to carry out the apparatus 100, and the description identifies and provides the functions of the software. It will be appreciated that charts or source code listings are not a requirement for adequately disclosing the functions of the software. The functions of the software program were readily apparent from the specification and one skilled in the art could generate the necessary software program to implement the disclosed functions. The apparatus 100 provides produces a useful, concrete and tangible result. The subject matter of the claims provides a practical application. Limitations appearing in the specification but not recited in the claims are not read into the claim. Each claim limitation is expressly, implicitly, or inherently supported in the originally filed disclosure, and each claim includes all elements, which are described as essential or critical. The claim language is to be given its broadest reasonable interpretation.

Additional Description

The following clauses are offered as further description of the examples of the apparatus. Any one or more of the following clauses may be combinable with any another one or more of the following clauses and/or with any subsection or a portion or portions of any other clause and/or combination and permutation of clauses. Any one of the following clauses may stand on its own merit without having to be combined with another of the clauses or with any portion of any other clause, etc. Clause (1): an apparatus (either taken alone, or with an apparatus of any clause mentioned in this paragraph, or any portion of any clause mentioned in this paragraph), including: a point-of-sale server being configured to: cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol; decrypt the encrypted transaction record using the point-of-sale cryptographic protocol in such a way so as to extract a transaction content from the encrypted transaction record received from the point-of-sale device; encrypt the transaction content being extracted from the encrypted transaction record by using an apparatus-cryptographic protocol in such a way so as to form a re-encrypted transaction record, the apparatus-cryptographic protocol being different from the point-of-sale cryptographic protocol; and output the re-encrypted transaction record in such a way so that the re-encrypted transaction record remains secure while waiting to be further processed. Clause (2): an apparatus (either taken alone, or with an apparatus of any clause mentioned in this paragraph, or any portion of any clause mentioned in this paragraph), including: a database server being configured to cooperatively communicate with a database and with the point-of-sale server in such a way so that the database server inputs the re-encrypted transaction record from the point-of-sale server, and outputs the re-encrypted transaction record to the database. Clause (3): an apparatus (either taken alone, or with an apparatus of any clause mentioned in this paragraph, or any portion of any clause mentioned in this paragraph), including: a transaction-processing server being configured to: cooperatively communicate with the database server in such a way so as to input the re-encrypted transaction record from the database server; decrypt the re-encrypted transaction record by using the apparatus-cryptographic protocol in such a way so as to extract the transaction content from the re-encrypted transaction record; encrypt the transaction content extracted from the re-encrypted transaction record using an authorization-provider cryptographic protocol so as to form an encrypted authorization request, the authorization-provider cryptographic protocol being associated with an authorization-provider server, and being different from the apparatus-cryptographic protocol; cooperatively communicate with the authorization-provider server in such a way so as to: output the encrypted authorization request to the authorization-provider server; and input, from the authorization-provider server, an encrypted authorization report being formed by using the authorization-provider cryptographic protocol, the encrypted authorization report having an indication configured to indicate whether the transaction content is any one of authorized and non-authorized; decrypt the encrypted authorization report in accordance with the authorization-provider cryptographic protocol in such a way so that authorization content is extracted from the encrypted authorization report; encrypt the encrypted authorization report in accordance with the apparatus-cryptographic protocol in such a way so as to form any one of the encrypted authorization report and an encrypted un-authorization report; and cooperatively communicate with the database server in such a way so as to output any one of the encrypted authorization report and the encrypted un-authorization report to the database, any one of the encrypted authorization report and the encrypted un-authorization report remain secured while waiting to be further processed. Clause (4): an apparatus (either taken alone, or with an apparatus of any clause mentioned in this paragraph, or any portion of any clause mentioned in this paragraph), including: a duplicate-check server being configured to: cooperatively communicate with the database server so as to write an encrypted-duplicate report; and cooperatively communicate with the transaction-processing server in such a way so that the duplicate-check server provides the indication to the transaction-processing server of which transactions are duplicates previously processed and should not be reprocessed by the authorization-provider server, so that the transaction-processing server does not provide the duplicates to the authorization-provider server. Clause (5): an apparatus (either taken alone, or with an apparatus of any clause mentioned in this paragraph, or any portion of any clause mentioned in this paragraph), including: a transaction-processing server configured to: cooperatively communicate with the database server so as to read the encrypted un-authorization report; and cooperatively communicate with the authorization-provider server in such a way so that the transaction-processing server resubmits the content of the encrypted un-authorization report to the authorization-provider server so as to recheck previously submitted transaction information. Clause (6): an apparatus (either taken alone, or with an apparatus of any clause mentioned in this paragraph, or any portion of any clause mentioned in this paragraph), including: a settlement-and-reporting server being configured to: cooperatively communicate with the database server in such a way so as to input an encrypted authorization report from the database server; decrypt the encrypted authorization report in such a way so as to extract the transaction content from the encrypted authorization report; encrypt the transaction content extracted from the encrypted authorization report so as to form an encrypted payment request using an encryption technique that is different from the encryption technique associated with an acquirer server; cooperatively communicate with the acquirer server in such a way so as to: output the encrypted payment request having the transaction content extracted from the encrypted authorization report to the acquirer server; and input an encrypted acquirer report from the acquirer server having an indication configured to indicate whether the transaction content indicates are any one of a paid transactions and a not-paid transaction; decrypt the encrypted acquirer report using a decryption technique associated with the acquirer server; encrypt the encrypted acquirer report in such a way so as to form the encrypted acquirer report by using an encryption process being different than a process of encryption associated with the acquirer server; and cooperatively communicate with the database server in such a way so as to output the encrypted acquirer report to the database in such a way that the encrypted acquirer report remains secured while waiting to be further processed. Clause (7): an apparatus (either taken alone, or with an apparatus of any clause mentioned in this paragraph, or any portion of any clause mentioned in this paragraph), including: a duplicate-check server being configured to: cooperatively communicate with the database server so as to write an encrypted-duplicate report; and cooperatively communicate with a transaction-processing server in such a way so that the duplicate-check server provides the indication to the transaction-processing server of which transactions are duplicates previously processed and should not be reprocessed by the acquirer server, so that the transaction-processing server does not provide the duplicates to the acquirer server. Clause (8): an apparatus (either taken alone, or with an apparatus of any clause mentioned in this paragraph, or any portion of any clause mentioned in this paragraph), including: a settlement-and-reporting server being configured to: cooperatively communicate with the database server in such a way so as to input any one of an encrypted acquirer report, an encrypted un-authorization report, and an encrypted-duplicate report from the database server; decrypt the any one of the encrypted acquirer report, the encrypted un-authorization report, and the encrypted-duplicate report in such a way so as to extract a content from any one of the encrypted acquirer report, the encrypted un-authorization report, and the encrypted-duplicate report; encrypt the content extracted from the any one of the encrypted acquirer report, the encrypted un-authorization report, and the encrypted-duplicate report so as to form an encrypted client report in accordance with an encryption process associated with an acquirer server; cooperatively communicate with a client server in such a way so as to output the encrypted client report having the content extracted from any one of the encrypted acquirer report, the encrypted un-authorization report, and the encrypted-duplicate report to the client server. Clause (9): an apparatus (either taken alone, or with an apparatus of any clause mentioned in this paragraph, or any portion of any clause mentioned in this paragraph), including: a blacklist server being configured to: generate a blacklist report; and provide the blacklist report to the point-of-sale server. Clause (10): an apparatus (either taken alone, or with an apparatus of any clause mentioned in this paragraph, or any portion of any clause mentioned in this paragraph), including: a settlement-and-reporting server being configured to: input an encrypted refund-request report from a client server, the encrypted refund-request report being encrypted in accordance with a client cryptographic process; decrypt the encrypted refund-request report in accordance with the client cryptographic process; output an encrypted refund request to an acquirer server, the encrypted refund request being encrypted in accordance with an acquirer-server cryptographic process; and input an encrypted acquirer response from the acquirer server, an encrypted response being encrypted in accordance with the acquirer-server cryptographic process. Clause (11): an apparatus (either taken alone, or with an apparatus of any clause mentioned in this paragraph, or any portion of any clause mentioned in this paragraph), including: a database server being configured to cooperatively communicate with a database and with a point-of-sale server in such a way so that the database server inputs a re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form the re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed. Clause (12): an apparatus (either taken alone, or with an apparatus of any clause mentioned in this paragraph, or any portion of any clause mentioned in this paragraph), including: a database being configured to cooperatively communicate with a database server in such a way so that the database server inputs a re-encrypted transaction record from a point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form the re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed. Clause (13): an apparatus (either taken alone, or with an apparatus of any clause mentioned in this paragraph, or any portion of any clause mentioned in this paragraph), including: a transaction-processing server being configured to: cooperatively communicate with a database server in such a way so as to input a re-encrypted transaction record from the database server, the database server being configured to cooperatively communicate with a database and with a point-of-sale server in such a way so that the database server inputs the re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form the re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed; decrypt the re-encrypted transaction record by using the apparatus-cryptographic protocol in such a way so as to extract the transaction content from the re-encrypted transaction record; encrypt the transaction content extracted from the re-encrypted transaction record using an authorization-provider cryptographic protocol so as to form an encrypted authorization request, the authorization-provider cryptographic protocol being associated with an authorization-provider server, and being different from the apparatus-cryptographic protocol; cooperatively communicate with the authorization-provider server in such a way so as to: output the encrypted authorization request to the authorization-provider server; and input, from the authorization-provider server, an encrypted authorization report being formed by using the authorization-provider cryptographic protocol, the encrypted authorization report having an indication configured to indicate whether the transaction content is any one of authorized and non-authorized; decrypt the encrypted authorization report in accordance with the authorization-provider cryptographic protocol in such a way so that authorization content is extracted from the encrypted authorization report; encrypt the encrypted authorization report in accordance with the apparatus-cryptographic protocol in such a way so as to form any one of the encrypted authorization report and an encrypted un-authorization report; and cooperatively communicate with the database server in such a way so as to output any one of the encrypted authorization report and the encrypted un-authorization report to the database, any one of the encrypted authorization report and the encrypted un-authorization report remain secured while waiting to be further processed. Clause (14): an apparatus (either taken alone, or with an apparatus of any clause mentioned in this paragraph, or any portion of any clause mentioned in this paragraph), including: a settlement-and-reporting server being configured to: cooperatively communicate with a database server in such a way so as to input an encrypted authorization report from the database server, the database server being configured to cooperatively communicate with a database and with a point-of-sale server in such a way so that the database server inputs a re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form the re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed; decrypt the encrypted authorization report in such a way so as to extract the transaction content from the encrypted authorization report; encrypt the transaction content extracted from the encrypted authorization report; so as to form an encrypted payment request; using an encryption technique that is different from the encryption technique associated with an acquirer server; cooperatively communicate with the acquirer server in such a way so as to: output the encrypted payment request having the transaction content extracted from the encrypted authorization report to the acquirer server; and input an encrypted acquirer report from the acquirer server having an indication configured to indicate whether the transaction content indicates are any one of a paid transactions and a not-paid transaction; decrypt the encrypted acquirer report using a decryption technique associated with the acquirer server; encrypt the encrypted acquirer report in such a way so as to form the encrypted acquirer report by using an encryption process being different than a process of encryption associated with the acquirer server; and cooperatively communicate with the database server in such a way so as to output the encrypted acquirer report to the database in such a way that the encrypted acquirer report remains secured while waiting to be further processed. Clause (15): an apparatus (either taken alone, or with an apparatus of any clause mentioned in this paragraph, or any portion of any clause mentioned in this paragraph), including: an apparatus, including: an intermediate server being configured to: input, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, (c) output, at least in part, the source-server encrypted record in such a way so that the source-server encrypted record remains secure while waiting to be further processed, (d) output, at least in part, the source-server encrypted record to the intermediate server; decrypt, at least in part, the source-server encrypted record in accordance with the source-server cryptographic protocol in such a way so as to form the unencrypted record; encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed; decrypt, at least in part, the intermediate-server encrypted record in accordance with the intermediate-server cryptographic protocol in such a way so as to form the unencrypted record; encrypt, at least in part, the unencrypted record in accordance with a sink-server cryptographic protocol being associated with a sink server in such a way so as to form a sink-server encrypted record, and the sink-server encrypted record remaining secure while waiting to be further processed; output, at least in part, the sink-server encrypted record in such a way so that the sink-server encrypted record remains secure while waiting to be further processed; and output, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record. Clause (16): an apparatus (either taken alone, or with an apparatus of any clause mentioned in this paragraph, or any portion of any clause mentioned in this paragraph), including: a sink server configured to: process, at least in part, the unencrypted record in such a way so as to form an unencrypted processed record; encrypt, at least in part, the unencrypted processed record in accordance with the sink-server cryptographic protocol in such a way so as to form a sink-server encrypted processed record; and output, at least in part, the sink-server encrypted processed record in such a way so that the sink-server encrypted processed record remains secure while waiting to be further processed. Clause (17): an apparatus (either taken alone, or with an apparatus of any clause mentioned in this paragraph, or any portion of any clause mentioned in this paragraph), including: a sink server configured to: output, at least in part, the sink-server encrypted processed record to the intermediate server; and the intermediate server is further configured to: input, at least in part, the sink-server encrypted processed record being outputted from the sink server; decrypt, at least in part, the sink-server encrypted processed record in accordance with the sink-server cryptographic protocol in such a way so as to form the unencrypted processed record; and encrypt, at least in part, the unencrypted processed record in accordance with the intermediate-server cryptographic protocol in such a way so as to form an intermediate-server encrypted processed record, and the intermediate-server encrypted processed record remaining secure while waiting to be further processed. Clause (18): an apparatus (either taken alone, or with an apparatus of any clause mentioned in this paragraph, or any portion of any clause mentioned in this paragraph), including: an intermediate server configured to: decrypt, at least in part, the intermediate-server encrypted processed record in accordance with the intermediate-server cryptographic protocol in such a way so as to form the unencrypted processed record; encrypt, at least in part, the unencrypted processed record in accordance with the source-server cryptographic protocol in such a way so as to form a source-server encrypted processed record, and the source-server encrypted processed record remaining secure while waiting to be further processed; and output, at least in part, the source-server encrypted processed record in such a way so that the source-server encrypted processed record remains secure while waiting to be further processed. Clause (19): an apparatus (either taken alone, or with an apparatus of any clause mentioned in this paragraph, or any portion of any clause mentioned in this paragraph), including: a source server configured to: input, at least in part, the source-server encrypted processed record being outputted by the intermediate server; decrypt, at least in part, the source-server encrypted processed record in accordance with the source-server cryptographic protocol in such a way so as to form, at least in part, the unencrypted processed record; and process, at least in part, the unencrypted processed record. Clause (20): an apparatus (either taken alone, or with an apparatus of any clause mentioned in this paragraph, or any portion of any clause mentioned in this paragraph), including: a source server being configured to: input, at least in part, an unencrypted record; encrypt, at least in part, the unencrypted record in accordance with a source-server cryptographic protocol being associated with the source server in such a way so as to form a source-server encrypted record; output, at least in part, the source-server encrypted record in such a way so that the source-server encrypted record remains secure while waiting to be further processed; and output, at least in part, the source-server encrypted record to an intermediate server, the intermediate server being configured to: (A) input, at least in part, the source-server encrypted record being outputted, at least in part, from the source server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (E) encrypt, at least in part, the unencrypted record in accordance with a sink-server cryptographic protocol being associated with a sink server in such a way so as to form a sink-server encrypted record, and the sink-server encrypted record remaining secure while waiting to be further processed, (F) output, at least in part, the sink-server encrypted record in such a way so that the sink-server encrypted record remains secure while waiting to be further processed; and (G) output, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record. Clause (21): an apparatus (either taken alone, or with an apparatus of any clause mentioned in this paragraph, or any portion of any clause mentioned in this paragraph), including: a sink server being configured to: input, at least in part, a sink-server encrypted record being outputted from an intermediate server, the intermediate server being configured to: (A) input, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, and (c) output, at least in part, the source-server encrypted record in such a way so that the source-server encrypted record remains secure while waiting to be further processed, (d) output the source-server encrypted record to the intermediate server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (F) encrypt, at least in part, the unencrypted record in accordance with a sink-server cryptographic protocol being associated with the sink server in such a way so as to form the sink-server encrypted record, and the sink-server encrypted record remaining secure while waiting to be further processed, (G) output, at least in part, the sink-server encrypted record in such a way so that the sink-server encrypted record remains secure while waiting to be further processed; and (H) output, at least in part, the sink-server encrypted record to the sink server; decrypt, at least in part, the sink-server encrypted record in accordance with the sink-server cryptographic protocol in such a way so as to form the unencrypted record; and process the unencrypted record. Clause (22): a method (either taken alone, or with a method of any clause mentioned in this paragraph, or any portion of any clause mentioned in this paragraph), the method for operating an apparatus including an intermediate server, the method including: inputting, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, (c) output, at least in part, the source-server encrypted record in such a way so that the source-server encrypted record remains secure while waiting to be further processed, (d) output, at least in part, the source-server encrypted record to the intermediate server; decrypting, at least in part, the source-server encrypted record in accordance with the source-server cryptographic protocol in such a way so as to form the unencrypted record; encrypting, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed; decrypting, at least in part, the intermediate-server encrypted record in accordance with the intermediate-server cryptographic protocol in such a way so as to form the unencrypted record; encrypting, at least in part, the unencrypted record in accordance with a sink-server cryptographic protocol being associated with a sink server in such a way so as to form a sink-server encrypted record, and the sink-server encrypted record remaining secure while waiting to be further processed; outputting, at least in part, the sink-server encrypted record in such a way so that the sink-server encrypted record remains secure while waiting to be further processed; and outputting, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record. Clause (23): a method (either taken alone, or with a method of any clause mentioned in this paragraph, or any portion of any clause mentioned in this paragraph), the method for operating an apparatus including a source server, the method including: inputting, at least in part, an unencrypted record; encrypting, at least in part, the unencrypted record in accordance with a source-server cryptographic protocol being associated with the source server in such a way so as to form a source-server encrypted record; outputting, at least in part, the source-server encrypted record in such a way so that the source-server encrypted record remains secure while waiting to be further processed; and outputting, at least in part, the source-server encrypted record to an intermediate server, the intermediate server being configured to: (A) input, at least in part, the source-server encrypted record being outputted, at least in part, from the source server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (E) encrypt, at least in part, the unencrypted record in accordance with a sink-server cryptographic protocol being associated with a sink server in such a way so as to form a sink-server encrypted record, and the sink-server encrypted record remaining secure while waiting to be further processed, (F) output, at least in part, the sink-server encrypted record in such a way so that the sink-server encrypted record remains secure while waiting to be further processed; and (G) output, at least in part, the sink-server encrypted record to the sink server, the sink server being configured to: (a) input, at least in part, the sink-server encrypted record being outputted from the intermediate server, (b) decrypt, at least in part, the sink-server encrypted record in accordance with the sink-server cryptographic protocol in such a way so as to form the unencrypted record, and (c) process the unencrypted record. Clause (24): a method (either taken alone, or with a method of any clause mentioned in this paragraph, or any portion of any clause mentioned in this paragraph), the method for operating an apparatus including a sink server, the method including: inputting, at least in part, a sink-server encrypted record being outputted from an intermediate server, the intermediate server being configured to: (A) input, at least in part, a source-server encrypted record being outputted, at least in part, from a source server, the source server being configured to: (a) input, at least in part, an unencrypted record, (b) encrypt, at least in part, the unencrypted record in accordance with a source-server cryptographic protocol being associated with the source server in such a way so as to form the source-server encrypted record, and (c) output, at least in part, the source-server encrypted record in such a way so that the source-server encrypted record remains secure while waiting to be further processed, (d) output the source-server encrypted record to the intermediate server, (B) decrypt, at least in part, the source-server encrypted record in accordance with the source-server cryptographic protocol in such a way so as to form the unencrypted record, (C) encrypt, at least in part, the unencrypted record in accordance with an intermediate-server cryptographic protocol being associated with the intermediate server in such a way so as to form an intermediate-server encrypted record, and the intermediate-server encrypted record remaining secure while waiting to be further processed, (D) decrypt, at least in part, the intermediate-server encrypted record in accordance with the intermediate-server cryptographic protocol in such a way so as to form the unencrypted record, (F) encrypt, at least in part, the unencrypted record in accordance with a sink-server cryptographic protocol being associated with the sink server in such a way so as to form the sink-server encrypted record, and the sink-server encrypted record remaining secure while waiting to be further processed, (G) output, at least in part, the sink-server encrypted record in such a way so that the sink-server encrypted record remains secure while waiting to be further processed; and (H) output, at least in part, the sink-server encrypted record to the sink server; decrypting, at least in part, the sink-server encrypted record in accordance with the sink-server cryptographic protocol in such a way so as to form the unencrypted record; and processing the unencrypted record. Clause (25): an apparatus (either taken alone, or with an apparatus of any clause mentioned in this paragraph, or any portion of any clause mentioned in this paragraph), including: a token server being configured to: securely interface with a secured vault; store an identifier associated with a credit card in the secured vault; receive, from a merchant, a token representing the identifier associated with the credit card; receive, from the merchant, a financial transaction associated with the token; retrieve the credit card from the secured vault, a credit card number being associated with the token received from the merchant; and execute the financial transaction in response to receiving the financial transaction and retrieving the credit card from the secured vault. Clause (26): an apparatus (either taken alone, or with an apparatus of any clause mentioned in this paragraph, or any portion of any clause mentioned in this paragraph), including: an enhanced data-processing server being configured to provide additional information about a financial transaction, including any one of tax, shipping, and duty charges. Clause (27): an apparatus (either taken alone, or with an apparatus of any clause mentioned in this paragraph, or any portion of any clause mentioned in this paragraph), including: an enhanced data-processing server being configured to provide additional information about a financial transaction, including any one of each invoice line item sold within an order, a description, tax status, and special discounts. Clause (28): an apparatus (either taken alone, or with an apparatus of any clause mentioned in this paragraph, or any portion of any clause mentioned in this paragraph), including: an enhanced data-processing server being configured to provide additional information about a financial transaction, including airline itinerary information, including any one of passenger name, ticket number, routing information, and carrier. Clause (29): an apparatus (either taken alone, or with an apparatus of any clause mentioned in this paragraph, or any portion of any clause mentioned in this paragraph), including: an address-verification server being configured to provide any one of card holder address information with a credit card transaction for comparison with an address that a card issuer has on file. Clause (30): an apparatus for facilitating secure a financial transaction, the apparatus (either taken alone, or with an apparatus of any clause mentioned in this paragraph, or any portion of any clause mentioned in this paragraph), including: a point-of-sale server being configured to: cooperatively communicate with a point-of-sale device in such a way so as to input a transaction record from the point-of-sale device, the transaction record indicating a buyer agreeing to provide a payment in exchange for receiving a commodity; decrypt, at least in part, the encrypted transaction record in such a way so as to extract a transaction content in such a way so as to validate whether the transaction record from the point-of-sale device; encrypt the transaction record from the point-of-sale device by using an apparatus-cryptographic protocol in such a way so as to form an encrypted transaction record; and output the encrypted transaction record in such a way so that the encrypted transaction record remains secure while waiting to be further processed. Clause (31): an apparatus for facilitating secure a financial transaction, the apparatus (either taken alone, or with an apparatus of any clause mentioned in this paragraph, or any portion of any clause mentioned in this paragraph), including: a database server being configured to cooperatively communicate with a database and with a point-of-sale server in such a way so that the database server inputs an encrypted transaction record from the point-of-sale server, and outputs the encrypted transaction record to the database. Clause (32): an apparatus for facilitating secure a financial transaction, the apparatus (either taken alone, or with an apparatus of any clause mentioned in this paragraph, or any portion of any clause mentioned in this paragraph), including: a transaction-processing server being configured to: decrypt an encrypted transaction record in such a way so as to extract transaction content from the encrypted transaction record; encrypt the transaction content extracted from the encrypted transaction record using an authorization-provider cryptographic protocol so as to form an encrypted authorization request, the authorization-provider cryptographic protocol being associated with an authorization-provider server; and cooperatively communicate with the authorization-provider server in such a way so as to output the encrypted authorization request to the authorization-provider server. Clause (33): an apparatus for facilitating secure a financial transaction, the apparatus (either taken alone, or with an apparatus of any clause mentioned in this paragraph, or any portion of any clause mentioned in this paragraph), including: a duplicate-check server being configured to: cooperatively communicate with the database server so as to write an encrypted-duplicate report; and cooperatively communicate with a transaction-processing server in such a way so that the duplicate-check server provides the indication to the transaction-processing server of which transactions are duplicates previously processed and should not be reprocessed by the authorization-provider server, so that the transaction-processing server does not provide the duplicates to the authorization-provider server. Clause (34): an apparatus for facilitating secure a financial transaction, the apparatus (either taken alone, or with an apparatus of any clause mentioned in this paragraph, or any portion of any clause mentioned in this paragraph), including: a settlement-and-reporting server being configured to: input an encrypted authorization report; decrypt the encrypted authorization report in such a way so as to extract the transaction content from the encrypted authorization report; encrypt the transaction content extracted from the encrypted authorization report so as to form an encrypted payment request using an encryption technique that is different from the encryption technique associated with an acquirer server; cooperatively communicate with the acquirer server in such a way so as to output the encrypted payment request having the transaction content extracted from the encrypted authorization report to the acquirer server. Clause (35): an apparatus for facilitating secure a financial transaction, the apparatus (either taken alone, or with an apparatus of any clause mentioned in this paragraph, or any portion of any clause mentioned in this paragraph), including: a duplicate-check server being configured to: cooperatively communicate with a transaction-processing server in such a way so that the duplicate-check server provides an indication to the transaction-processing server of which transactions are duplicates previously processed and should not be reprocessed by an acquirer server, so that the transaction-processing server does not provide the duplicates to the acquirer server. Clause (36): an apparatus for facilitating secure a financial transaction, the apparatus (either taken alone, or with an apparatus of any clause mentioned in this paragraph, or any portion of any clause mentioned in this paragraph), including: a settlement-and-reporting server being configured to: input any one of an encrypted acquirer report, an encrypted un-authorization report, and an encrypted-duplicate report from the database server; decrypt the any one of the encrypted acquirer report, the encrypted un-authorization report, and the encrypted-duplicate report in such a way so as to extract a content from any one of the encrypted acquirer report, the encrypted un-authorization report, and the encrypted-duplicate report; encrypt the content extracted from the any one of the encrypted acquirer report, the encrypted un-authorization report, and the encrypted-duplicate report so as to form an encrypted client report in accordance with an encryption process associated with an acquirer server; and cooperatively communicate with a client server in such a way so as to output the encrypted client report having the content extracted from any one of the encrypted acquirer report, the encrypted un-authorization report, and the encrypted-duplicate report to the client server. Clause (37): an apparatus for facilitating secure a financial transaction, the apparatus (either taken alone, or with an apparatus of any clause mentioned in this paragraph, or any portion of any clause mentioned in this paragraph), including: a settlement-and-reporting server being configured to: input an encrypted refund-request report from a client server, the encrypted refund-request report being encrypted in accordance with a client cryptographic process; decrypt the encrypted refund-request report in accordance with the client cryptographic process; output an encrypted refund request to an acquirer server, the encrypted refund request being encrypted in accordance with an acquirer-server cryptographic process; and input an encrypted acquirer response from the acquirer server, an encrypted response being encrypted in accordance with the acquirer-server cryptographic process. Clause (38): an apparatus (either taken alone, or with an apparatus of any clause mentioned in this paragraph, or any portion of any clause mentioned in this paragraph), including: a client portal configured to: present at least one secured user interface in response to receiving a valid user request to view the at least one secured user interface; and provide user assistance being configured to facilitate at least one secure financial transaction. Clause (39): an apparatus (either taken alone, or with an apparatus of any clause mentioned in this paragraph, or any portion of any clause mentioned in this paragraph), including: a client portal configured to: input an encrypted refund-request report from a client server, the encrypted refund-request report being encrypted in accordance with a client cryptographic process; decrypt the encrypted refund-request report in accordance with the client cryptographic process; output an encrypted refund request to an acquirer server, the encrypted refund request being encrypted in accordance with an acquirer-server cryptographic process; and input an encrypted acquirer response from the acquirer server, an encrypted response being encrypted in accordance with the acquirer-server cryptographic process. Clause (40): an apparatus (either taken alone, or with an apparatus of any clause mentioned in this paragraph, or any portion of any clause mentioned in this paragraph), wherein the transactions are processed in a batch transfer.

It may be appreciated that the assemblies and modules described above may be connected with each other as may be required to perform desired functions and tasks that are within the scope of persons of skill in the art to make such combinations and permutations without having to describe each of them in explicit terms. There is no particular assembly, components, or software code that is superior to any of the equivalents available to the art. There is no particular mode of practicing the disclosed subject matter that is superior to others, so long as the functions may be performed.

It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1.-40. (canceled)

41. An apparatus, comprising:
a database server being configured to cooperatively communicate with a database and with a point-of-sale server in such a way so that the database server inputs a re-encrypted transaction record from the point-of-sale server, and outputs the re-encrypted transaction record to the database, the point-of-sale server being configured to: (A) cooperatively communicate with a point-of-sale device in such a way so as to input an encrypted transaction record from the point-of-sale device, the encrypted transaction record indicating a buyer agreeing to provide a payment in exchange for receiving a commodity, the encrypted transaction record being formed by using a point-of-sale cryptographic protocol, (B) decrypt the encrypted transaction record using the point-of-sale cryptographic protocol in such a way so as to extract a transaction content from the encrypted transaction record received from the point-of-sale device; (C) encrypt the transaction content being extracted from the encrypted transaction record by using an apparatus-cryptographic protocol in such a way so as to form the re-encrypted transaction record, the apparatus-cryptographic protocol being different from the point-of-sale cryptographic protocol, and (D) output the re-encrypted transaction record in such a way so that the re-encrypted transaction record remains secure while waiting to be further processed.

42. The apparatus of claim 41, further comprising:
a transaction-processing server being configured to:
cooperatively communicate with the database server in such a way so as to input the re-encrypted transaction record from the database server;
decrypt the re-encrypted transaction record by using the apparatus-cryptographic protocol in such a way so as to extract the transaction content from the re-encrypted transaction record;
encrypt the transaction content extracted from the re-encrypted transaction record using an authorization-provider cryptographic protocol so as to form an encrypted authorization request, the authorization-provider cryptographic protocol being associated with an authorization-provider server, and being different from the apparatus-cryptographic protocol;
cooperatively communicate with the authorization-provider server in such a way so as to:
output the encrypted authorization request to the authorization-provider server; and
input, from the authorization-provider server, an encrypted authorization report being formed by using the authorization-provider cryptographic protocol, the encrypted authorization report having an indication configured to indicate whether the transaction content is any one of authorized and non-authorized;
decrypt the encrypted authorization report in accordance with the authorization-provider cryptographic protocol in such a way so that authorization content is extracted from the encrypted authorization report;
encrypt the encrypted authorization report in accordance with the apparatus-cryptographic protocol in such a way so as to form any one of the encrypted authorization report and an encrypted un-authorization report; and
cooperatively communicate with the database server in such a way so as to output any one of the encrypted authorization report and the encrypted un-authorization report to the database, any one of the encrypted authorization report and the encrypted un-authorization report remain secured while waiting to be further processed.

43. The apparatus of claim 42, further comprising:
a duplicate-check server being configured to:
cooperatively communicate with the database server so as to write an encrypted-duplicate report; and
cooperatively communicate with the transaction-processing server in such a way so that the duplicate-check server provides the indication to the transaction-processing server of which transactions are duplicates previously processed and should not be reprocessed by the authorization-provider server, so that the transaction-processing server does not provide the duplicates to the authorization-provider server.

44. The apparatus of claim 42, wherein:
the transaction-processing server is further configured to:
cooperatively communicate with the database server so as to read the encrypted un-authorization report; and
cooperatively communicate with the authorization-provider server in such a way so that the transaction-processing server resubmits the content of the encrypted un-authorization report to the authorization-provider server so as to recheck previously submitted transaction information.

45. The apparatus of claim 42, further comprising:
a settlement-and-reporting server being configured to:
input an encrypted refund-request report from a client server, the encrypted refund-request report being encrypted in accordance with a client cryptographic process;
decrypt the encrypted refund-request report in accordance with the client cryptographic process;
output an encrypted refund request to an acquirer server, the encrypted refund request being encrypted in accordance with an acquirer-server cryptographic process; and
input an encrypted acquirer response from the acquirer server, an encrypted response being encrypted in accordance with the acquirer-server cryptographic process.

46. The apparatus of claim 45, further comprising:
a settlement-and-reporting server being configured to:
cooperatively communicate with the database server in such a way so as to input an encrypted authorization report from the database server;
decrypt the encrypted authorization report in such a way so as to extract the transaction content from the encrypted authorization report;
encrypt the transaction content extracted from the encrypted authorization report so as to form an encrypted payment request using an encryption technique that is different from the encryption technique associated with an acquirer server;
cooperatively communicate with the acquirer server in such a way so as to:
output the encrypted payment request having the transaction content extracted from the encrypted authorization report to the acquirer server; and
input an encrypted acquirer report from the acquirer server having an indication configured to indicate whether the transaction content indicates are any one of a paid transactions and a not-paid transaction;
decrypt the encrypted acquirer report using a decryption technique associated with the acquirer server;
encrypt the encrypted acquirer report in such a way so as to form the encrypted acquirer report by using an encryption process being different than a process of encryption associated with the acquirer server; and
cooperatively communicate with the database server in such a way so as to output the encrypted acquirer report to the database in such a way that the encrypted acquirer report remains secured while waiting to be further processed.

47. The apparatus of claim 46, further comprising:
a duplicate-check server being configured to:
cooperatively communicate with the database server so as to write an encrypted-duplicate report; and
cooperatively communicate with a transaction-processing server in such a way so that the duplicate-check server provides the indication to the transaction-processing server of which transactions are duplicates previously processed and should not be reprocessed by the acquirer server, so that the transaction-processing server does not provide the duplicates to the acquirer server.

48. The apparatus of claim 41, further comprising:
a settlement-and-reporting server being configured to:
cooperatively communicate with the database server in such a way so as to input any one of an encrypted acquirer report, an encrypted un-authorization report, and an encrypted-duplicate report from the database server;
decrypt the any one of the encrypted acquirer report, the encrypted un-authorization report, and the encrypted-duplicate report in such a way so as to extract a content from any one of the encrypted acquirer report, the encrypted un-authorization report, and the encrypted-duplicate report;
encrypt the content extracted from the any one of the encrypted acquirer report, the encrypted un-authorization report, and the encrypted-duplicate report so as to form an encrypted client report in accordance with an encryption process associated with an acquirer server;
cooperatively communicate with a client server in such a way so as to output the encrypted client report having the content extracted from any one of the encrypted acquirer report, the encrypted un-authorization report, and the encrypted-duplicate report to the client server.

49. The apparatus of claim 42, further comprising:
a blacklist server being configured to:
generate a blacklist report; and
provide the blacklist report to the point-of-sale server.

50. The apparatus of claim 49, the blacklist server being configured to:
transmit an acquirer-blacklist report to the database server,
the acquirer-blacklist report including a list of credit card numbers that the acquirer entity considers no longer valid.

51. The apparatus of claim 49, the client server being configured to:
transmit a client-blacklist report to the database server,
the client-blacklist report including a list of credit card numbers that the client entity considers no longer valid.

52. The apparatus of claim 49, the database server being configured to: (A) receive the acquirer-blacklist report and the client-blacklist report, decrypt the acquirer-blacklist report in accordance with the acquirer-cryptographic process in order to extract content therefrom, (C) decrypt the client-blacklist report in accordance with the client-cryptographic process in order to extract content therefrom.

53. The apparatus of claim 49, the blacklist server being configured to:
generate a blacklist report based on the contents derived from the acquirer-blacklist report and from the client-blacklist report, and to
transmit the blacklist report to the point-of-sale server, or to the database.
